(19) United States
(12) Patent Application Publication
(10) Pub. No.: US 2011/0236603 A1
(43) Pub. Date: Sep. 29, 2011

(54) CELLULOSE ACYLATE FILM, RETARDER, POLARIZING PLATE, AND LIQUID CRYSTAL DISPLAY DEVICES

(75) Inventors: Hiroyuki HAGIO, Ashigarakami-gun (JP); Aiko YOSHIDA, Ashigarakami-gun (JP); Nobutaka FUKAGAWA, Ashigarakami-gun (JP)

(73) Assignee: FUJIFILM CORPORATION, Tokyo (JP)

(21) Appl. No.: 13/073,558

(22) Filed: Mar. 28, 2011

(30) Foreign Application Priority Data
Mar. 29, 2010 (JP) 2010-075570

(51) Int. Cl. G02B 5/30; C09K 3/00; F21V 9/14; C09K 19/36

(52) U.S. Cl. 428/1.31; 252/182.12; 252/585; 252/299.7

(57) ABSTRACT

A cellulose acylate film comprising at least one cellulose acylate, at least one sterol derivative represented by formula (1), and at least one saccharide derivative and/or at least one oligomer plasticizer is disclosed. R¹, R² and R³ represents a hydrogen atom, a hydroxyl group or a substituent represented by -L-R*, provided that at least one of them represents the substituent represented by -L-R*; L represents a single bond or a divalent connecting group selected from the group consisting of —O—, —CO—, —CONR⁶—, —CH₂— and a combination thereof, R* represents a substituted or unsubstituted aromatic ring group, heterocyclic group or alkyl group; R⁴ represents a carboxyl group or —CHR⁷—CH(CH₃)₂; R⁵ represents a hydrogen atom or a methyl group.

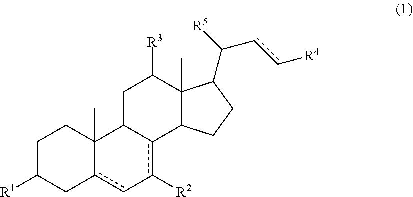

### CROSS-REFERENCE TO RELATED APPLICATIONS

The present application claims the benefit of priority from Japanese Patent Application No. 2010-075570, filed on Mar. 29, 2010, the contents of which are herein incorporated by reference in their entirety.

### BACKGROUND OF THE INVENTION

1. Field of the Invention

The present invention relates to a cellulose acylate film useful as an optical film to be used for various purposes such as a liquid crystal display device and to a retarder, a polarizing plate and a liquid crystal display device each utilizing the subject cellulose acylate film.

2. Background Art

In a liquid crystal display device, a cellulose acylate film is widely utilized as, for example, a protective film of polarizing plate or an optically compensatory film. The cellulose acylate film which is provided for such an application is required to exhibit a desired optical characteristic depending upon a mode of the liquid crystal display device or the like.

While a cellulose acylate such as cellulose triacetate is an inexpensive and very versatile polymer material, it is hardly stretchable so that it is difficult to obtain a film having large retardation in-plane Re by using the cellulose acylate as a raw material. For the purpose of controlling an optical characteristic of the cellulose acylate film or other purposes, it has hitherto been proposed to add a prescribed additive (see, for example, WO2007/125764A1 and JP-A-2007-3679).

Now, requirements of display characteristics relative to liquid crystal display devices are increasing more and more. There may be the case where films used for optical compensation of liquid crystal display devices are required to have an Re falling within a prescribed range and also required to exhibit ideal wavelength dispersibility thereof, specifically, reversed dispersibility regarding the Re. In particular, an optically biaxial polymer film exhibiting the reversed wavelength dispersibility regarding the Re is useful in liquid crystal display devices of various modes including a VA mode.

Meanwhile, there is proposed a cellulose acylate film containing a prescribed amount of an oil gelling agent (see JP-A-2002-322294). In JP-A-2002-322294, the oil gelling agent is added for the purpose of improving surface properties of the cellulose acylate film, but influences exerted by the addition of the oil gelling agent on optical characteristics of the cellulose acylate film are not described at all. Also, JP-A-2002-322294 does not describe at all whether or not the addition of the oil gelling agent exerts influences on optical characteristics of the cellulose acylate film.

### SUMMARY OF THE INVENTION

An object of the invention is to provide a cellulose acylate film exhibiting developed retardation in-plane Re which has reversed wavelength dispersion characteristics; and also to provide a retarder comprising the subject film and a polarizing plate and a liquid crystal display device each including the subject film.

The means for achieving the object are as follows.

[1] A cellulose acylate film comprising at least one cellulose acylate, at least one sterol derivative represented by formula (1), and at least one saccharide derivative and/or at least one oligomer plasticizer:

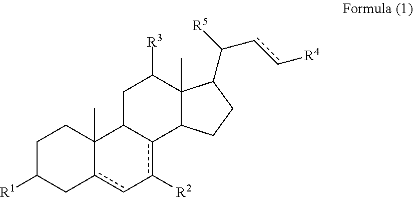

wherein

each of R¹, R² and R³ represents a hydrogen atom, a hydroxyl group or a substituent represented by -L-R*, provided that at least one of R¹, R² and R³ represents the substituent represented by -L-R*; L represents a single bond or a divalent connecting group selected from the group consisting of —O—, —CO—, —CONR⁶—, —CH₂— and a combination thereof, wherein R⁶ represents an alkyl group having from 1 to 7 carbon atoms or a hydrogen atom; R* represents a substituted or unsubstituted aromatic ring group, heterocyclic group or alkyl group, provided that in the alkyl group, one CH₂ or two or more CH₂'s which are not adjacent to each other may be substituted with an oxygen atom; R⁴ represents a carboxyl group or —CHR⁷—CH(CH₃)₂, wherein R⁷ represents an alkyl group having 1 or 2 carbon atoms or a hydrogen atom, and the carboxyl group represented by R⁴ may be substituted with -L-R*; R⁵ represents a hydrogen atom or a methyl group; and a combination of the broken line and the solid line in the formula may be any of a single bond or a double bond.

[2] The cellulose acylate film of [1], wherein the at least one sterol derivative is a cholesterol derivative, a sitosterol derivative, a stigmasterol derivative, a campesterol derivative, a brassicasterol derivative, an ergosterol derivative, a cholic acid derivative, a deoxycholic acid derivative, a chenodeoxycholic acid derivative or a lithocholic acid derivative.
[3] The cellulose acylate film of [1], wherein the at least one sterol derivative is a cholesterol derivative.
[4] The cellulose acylate film of [1] or [2], wherein the at least one sterol derivative is a compound represented by formula (1a):

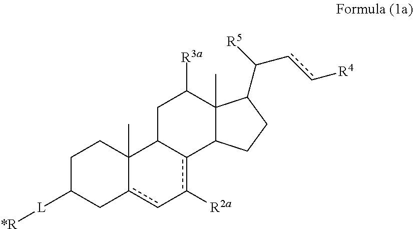

wherein

L, R*, R⁴ and R⁵ are synonymous with those in the formula (1), respectively; and each of R^{3a} and R^{2a} represents a hydrogen atom or a hydroxyl group.

[5] The cellulose acylate film of any one of [1]-[4], wherein the at least one sterol derivative is a compound represented by formula (1b):

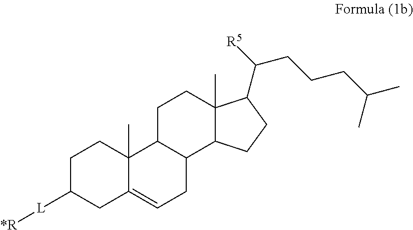

wherein

L, R* and R⁵ are synonymous with those in formula (1), respectively.

[6] The cellulose acylate film of any one of [1]-[5], wherein a molecular weight of the sterol derivative is equal to or smaller than 600.
[7] The cellulose acylate film of any one of [1]-[6], wherein the at least one sterol derivative takes a liquid crystal phase in any temperature range of from 10 degrees Celsius to 300 degrees Celsius.
[8] The cellulose acylate film of any one of [1]-[7], wherein an amount of the at least one sterol derivative is from 0.1 to 50% by mass on the basis of the total mass.
[9] The cellulose acylate film of any one of [1]-[8], satisfying following expressions (1) to (3).

Δn(550 nm)>0 (1)

1>|Δn(450 nm)/Δn(550 nm)| (2)

1<|Δn(630 nm)/Δn(550 nm)| (3)

[10] The cellulose acylate film of any one of [1]-[9], wherein the at least one cellulose acylate is a cellulose acylate in which hydrogen atoms of hydroxyl groups of the cellulose skeleton are substituted substantially only with an acetyl group, and a total degree of substitution thereof is from 2.00 to 3.00.
[11] The cellulose acylate film of any one of [1]-[10], wherein the at least one cellulose acylate is a cellulose acylate in which hydrogen atoms of hydroxyl groups of the cellulose skeleton are substituted substantially with at least two kinds selected from the group consisting of an acetyl group, a propionyl group and a butanoyl group, and a total degree of substitution thereof is from 2.00 to 3.00.
[12] The cellulose acylate film of any one of [1]-[11], which is one having been subjected to a stretching treatment and/or a contraction treatment.
[13] A retarder comprising a cellulose acylate film of any one of [1]-[12].
[14] A polarizing plate comprising at least a cellulose acylate film of any one of [1]-[13] and a polarizer.
[15] A liquid crystal display device comprising a retarder of [13] and/or a polarizing plate of [14].
[16] The liquid crystal display device of [15], employing a VA mode.

According to the invention, it is possible to provide a cellulose acylate film exhibiting developed retardation in-plane Re which has reversed wavelength dispersion characteristics; and also to provide a retarder comprising the subject film and a polarizing plate and a liquid crystal display device each including the subject film.

### DETAILED DESCRIPTION OF THE INVENTION

The invention is hereunder described in detail by referring to embodiments. In this specification, a numerical range expressed by the terms “a number to another number” means a range falling between the former number indicating a lower limit value of the range and the latter number indicating an upper limit value thereof.

### 1. Cellulose Acylate Film:

The invention relates to a cellulose acylate film containing at least one cellulose acylate, at least one sterol derivative and at least one saccharide derivative and/or at least one oligomer plasticizer. The sterol derivative represented by formula (1) acts as an agent of increasing retardation in-plane Re (Re increasing agent) and/or an agent for controlling wavelength-dispersion characteristics together with the saccharide derivative and/or the oligomer plasticizer.

### 1-(1) Sterol Derivative:

The sterol derivative which is used in the invention is preferably a compound represented by formula (1).

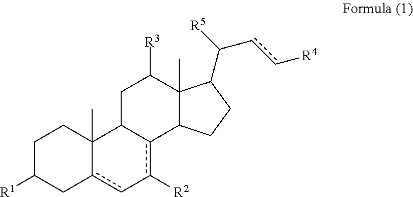

In the formula (1), each of R¹, R² and R³ represents a hydrogen atom, a hydroxyl group or a substituent represented by -L-R*, provided that at least one of R¹, R² and R³ represents the substituent represented by -L-R*; L represents a single bond or a divalent connecting group selected from the group consisting of —O—, —CO—, —CONR⁶— (R⁶ represents an alkyl group having from 1 to 7 carbon atoms or a hydrogen atom), —CH₂— and a combination thereof; R* represents a substituted or unsubstituted aromatic ring group, heterocyclic group or alkyl group (provided that in the alkyl group, one CH₂ or two or more CH₂'s which are not adjacent to each other may be substituted with an oxygen atom); R⁴ represents a carboxyl group or —CHR⁷—CH(CH₃)₂ (R⁷ represents an alkyl group having 1 or 2 carbon atoms or a hydrogen atom), and the carboxyl group represented by R⁴ may be substituted with -L-R*; R⁵ represents a hydrogen atom or a methyl group; and a combination of the broken line and the solid line in the formula (1) may be any of a single bond or a double bond.

The sterol derivative refers to a compound derived from a sterol. The sterol includes the following cholesterol, sitosterol, stigmasterol, campesterol, brassicasterol, ergosterol, cholic acid, deoxycholic acid, chenodeoxycholic acid and lithocholic acid, which are different from each other in the substitution position of the hydroxyl group, the presence or absence of the double bond, the position of the double bond, and the like.

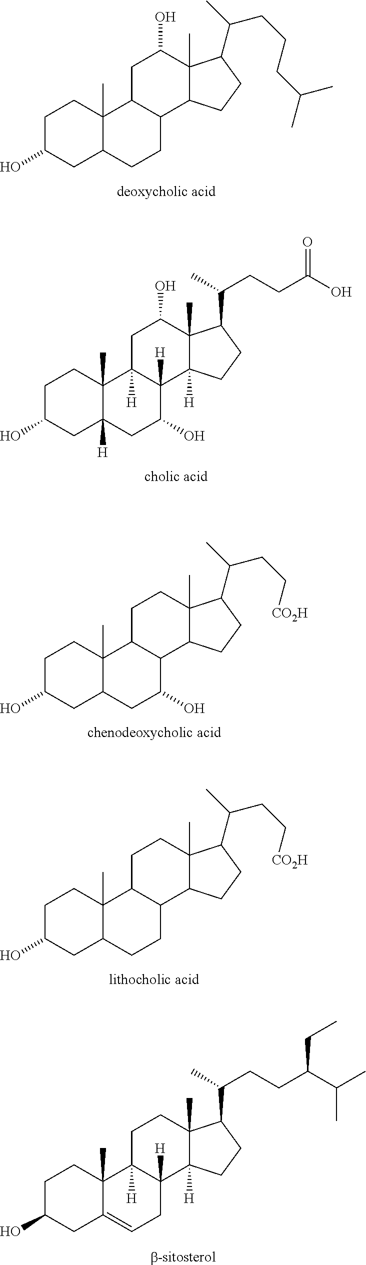

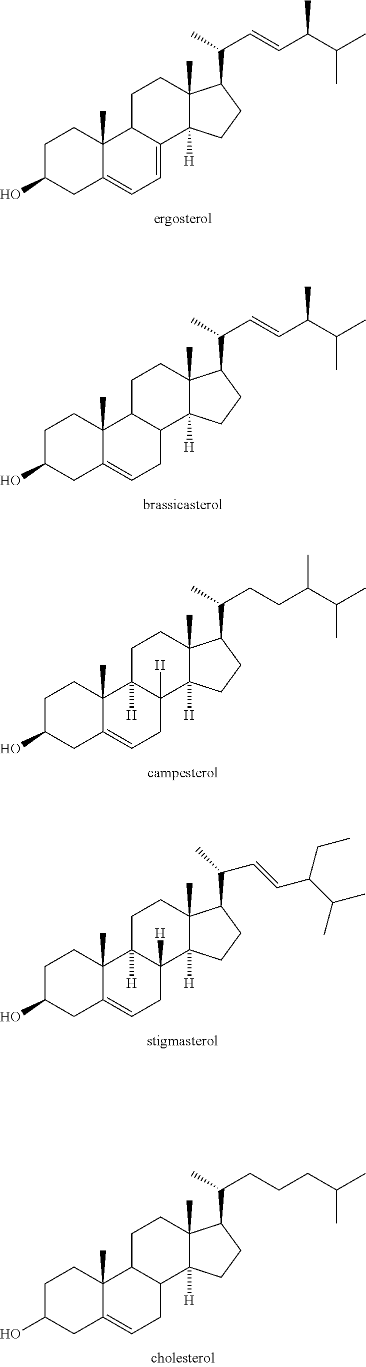

In the formula (1), each of R¹, R² and R³ represents a hydrogen atom, a hydroxyl group or a substituent represented by -L-R*, provided that at least one of R¹, R² and R³ represents the substituent represented by -L-R*.

L represents a single bond or a divalent connecting group selected from the group consisting of —O—, —CO—, —CONR⁶— (R⁶ represents an alkyl group having from 1 to 7 carbon atoms or a hydrogen atom), —CH₂— and a combination thereof.

Examples of the divalent connecting group represented by L include —O—, —CO—, —CONR⁶—, —COO—, —COO—, —OCOO—, —OCONR⁶— and —OCO—(CH₂)ₙ—CONR⁶—. Of these, —O—, —CO—, —CONR⁶—, —COO—, —COO—, —OCOO— or —OCONR⁶— is preferable; and —COO—, —COO—, —OCOO— or —OCONR⁶— is especially preferable. n is preferably from 1 to 20, more preferably from 1 to 15, and still more preferably from 1 to 10.

R* represents a substituted or unsubstituted aromatic ring group, heterocyclic group or alkyl group. Examples of the aromatic ring group represented by R* include a phenyl group, a naphthyl group and an anthracenyl group. Also, the heterocyclic group represented by R* may be aromatic or non-aromatic. A 5-membered to 7-membered ring heterocyclic group is preferable, and a 5-membered or 6-membered ring heterocyclic group is more preferable. Examples of the heterocyclic group include a pyridine ring group, a piperidine ring group, a piperazine ring group, a pyrazine ring group, a morpholine ring group, a furan ring group, a dioxane ring group, a benzimidazole ring group, an imidazole ring group, a thiophene ring group and a pyrrole ring group.

The alkyl group represented by R* is an alkyl group having preferably from 1 to 20 carbon atoms, more preferably from 1 to 15 carbon atoms, and still more preferably from 1 to 10 carbon atoms. However, in the alkyl group, one CH₂ or two or more CH₂'s which are not adjacent to each other may be substituted with an oxygen atom. For example, the alkyl group may be a polyalkyleneoxy group such as a polyethyleneoxy group and a polypropyleneoxy group.

If possible, R* may have one or more substituents. Examples of the substituent include an alkyl group, a halogen atom, a cyano group, a hydroxyl group, a nitro group, a carboxyl group, an alkoxy group, an aryloxy group, an acyloxy group, a carbamoyloxy group, an alkoxycarbonyloxy group, an aryloxycarbonyloxy group, an amino group, an acylamino group, a sulfamoylamino group, an alkyl or aryl sulfonylamino group, a mercapto group, an alkylthio group, a sulfamoyl group, a sulfo group, an alkyl or aryl sulfinyl group, an alkyl or aryl sulfonyl group and an imide group.

Of these, a carboxyl group, a cyano group, a nitro group, a hydroxyl group, an alkoxy group having from 1 to 10 carbon atoms or an alkyl group having from 1 to 10 carbon atoms is preferable.

Also, R* may be substituted with a sterol residue. That is, the sterol derivative represented by the formula (1) may be a multimer having plural sterol residues.

In the formula (1), R⁴ represents a carboxyl group or —CHR⁷—CH(CH₃)₂ (R⁷ represents an alkyl group having 1 or 2 carbon atoms or a hydrogen atom).

For example, the sterol derivative having, as a mother nucleus, a residue of deoxycholic acid, β-sitosterol, ergosterol acid, brassicasterol, campesterol, stigmasterol or cholesterol may become a sterol derivative represented by the foregoing formula (1) wherein R⁴ is —CHR⁷—CH(CH₃)₂.

Also, the sterol derivative having, as a mother nucleus, a residue of cholic acid, chenodeoxycholic acid or lithocholic acid may become a sterol derivative represented by the foregoing formula (1) wherein R⁴ is a carboxyl group.

When R⁴ represents a carboxyl group, the carboxyl group may be substituted with -L-R*. For example, R* may be —COOR*, and preferred examples of R* are the same as those described above.

In the formula (1), R⁵ represents a hydrogen atom or a methyl group, with a methyl group being preferable.

It is preferable that among R¹, R² and R³, R¹ is -L-R*. That is, a sterol derivative represented by formula (1a) is preferable.

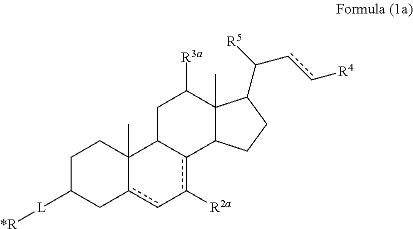

In the formula (1a), L, R*, R⁴ and R⁵ are synonymous with those in the formula (1), respectively, and preferred ranges thereof are also the same.

Each of R^{3a} and R^{2a} represents a hydrogen atom or a hydroxyl group.

As described previously, the sterol derivative may be a multimer having plural sterol residues, and examples thereof include a dimer represented by formula (1a′).

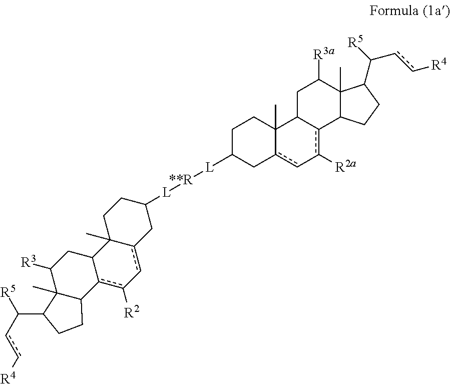

In the formula (1a′), L, R⁴ and R⁵ are synonymous with those in the formula (1), respectively, and preferred ranges thereof are also the same.

Each of R^{3a} and R^{2a} represents a hydrogen atom or a hydroxyl group.

R** represents a divalent group resulting from elimination of one hydrogen atom from the substituted or unsubstituted aromatic ring group, heterocyclic group or alkyl group represented by R* in the formula (1).

Also, of the foregoing sterol derivatives, a cholesterol derivative having cholesterol as a mother nucleus is preferable. That is, the cholesterol derivative which is represented by formula (1) wherein each of R² and R³ is a hydrogen atom, and R⁴ is —CH₂—CH(CH₃)₂ and which is also represented by each of formulae (1b) and (1b′), is preferable.

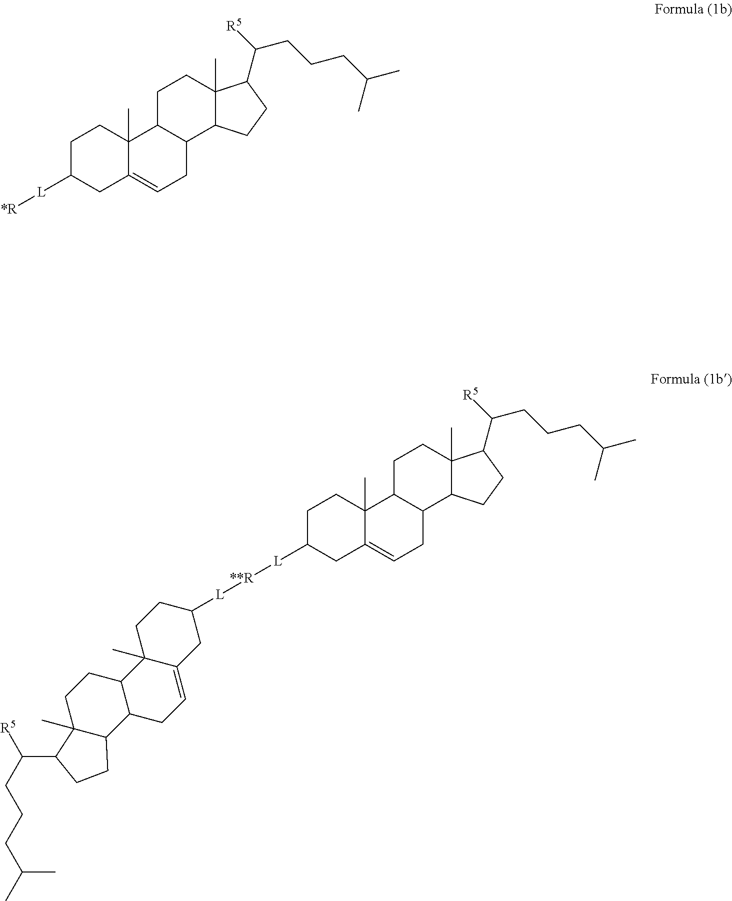

In the formulae (1b) and (1b′), L, R*, R** and R⁵ are synonymous with those in the foregoing formulae (1), (1a) and (1a′), respectively, and preferred ranges thereof are also the same.

When a molecular weight of the sterol derivative represented by the foregoing formula (1) is large, the increase of Re tends to be lowered. From this viewpoint, the molecular weight of the sterol derivative is preferably equal to or smaller than 600, and more preferably equal to or smaller than 560. For example, when the cholesterol derivative is taken as an example, since the molecular weight of cholesterol is 386.65, in an example wherein one -L-R* substituent is introduced into cholesterol, the molecular weight of the substituent is preferably from 1 to 200, and more preferably from 50 to 180.

Also, it is preferable that the sterol derivative is crystalline. In particular, when a sterol derivative which takes a liquid crystal phase in any temperature range of from 10 degrees Celsius to 300 degrees Celsius is used, the increase of Re can be more enhanced, and a film having a large Re is obtained. A liquid crystal phase temperature of the sterol derivative is preferably from 50 degrees Celsius to 250 degrees Celsius, and especially preferably from 100 degrees Celsius to 200 degrees Celsius.

Examples of the sterol derivative represented by formula (1) include, but are not limited, those shown below.

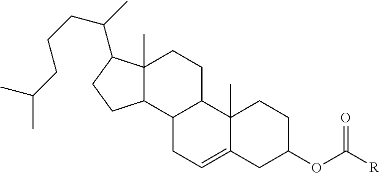

| Compound No. | R |
|---|---|
| A-C1 | CH₃ |
| A-C2 | C₂H₅ |
| A-Cn | CₙH₂ₙ₊₁ |
| | n: an integer of 1-20 |
| A-Ph | Ph |
| A-1 | COOCH₃ |
| A-2 | CH₂CH₂COOH |
| A-3 | C₆H₄-p-OMe |
| A-4 | C₆H₄-p-CN |
| A-5 | C₆H₄-p-NO₂ |
| A-6 | 4-Py |
| A-7 | 1-Naph |

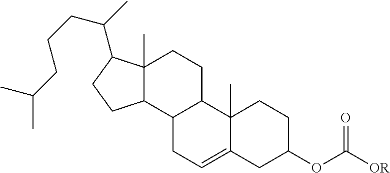

| Compound No. | R |
|---|---|
| B-Cn | CₙH₂ₙ₊₁ |
| | n: an integer of 1-20 |
| B-Ph | Ph |
| B-1 | CH₂CH₂OH |
| B-2 | CH₂CH₂OC₂H₅ |
| B-3 | C₆H₄-p-OMe |
| B-4 | CH₂CH₂CH(OCH₃)CH₃ |

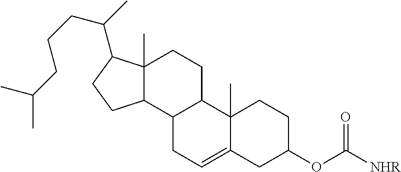

| Compound No. | R |
|---|---|
| C-Cn | CₙH₂ₙ₊₁ |
| | n: an integer of 1-20 |
| C-Ph | Ph |

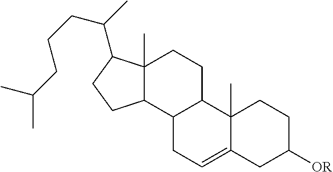

| Compound No. | R |
|---|---|
| D-Cn | CₙH₂ₙ₊₁ |
| | n: an integer of 1-20 |
| D-Ph | Ph |
| D-1 | CH₂CH₂OCH₂CH₂OH |
| D-2 | (CH₂CH₂O)ₙH n [symbol] 10 |
| D-3 | CH₂CH₂OCH₃ |
| D-4 | CH₂CH₂OPh |

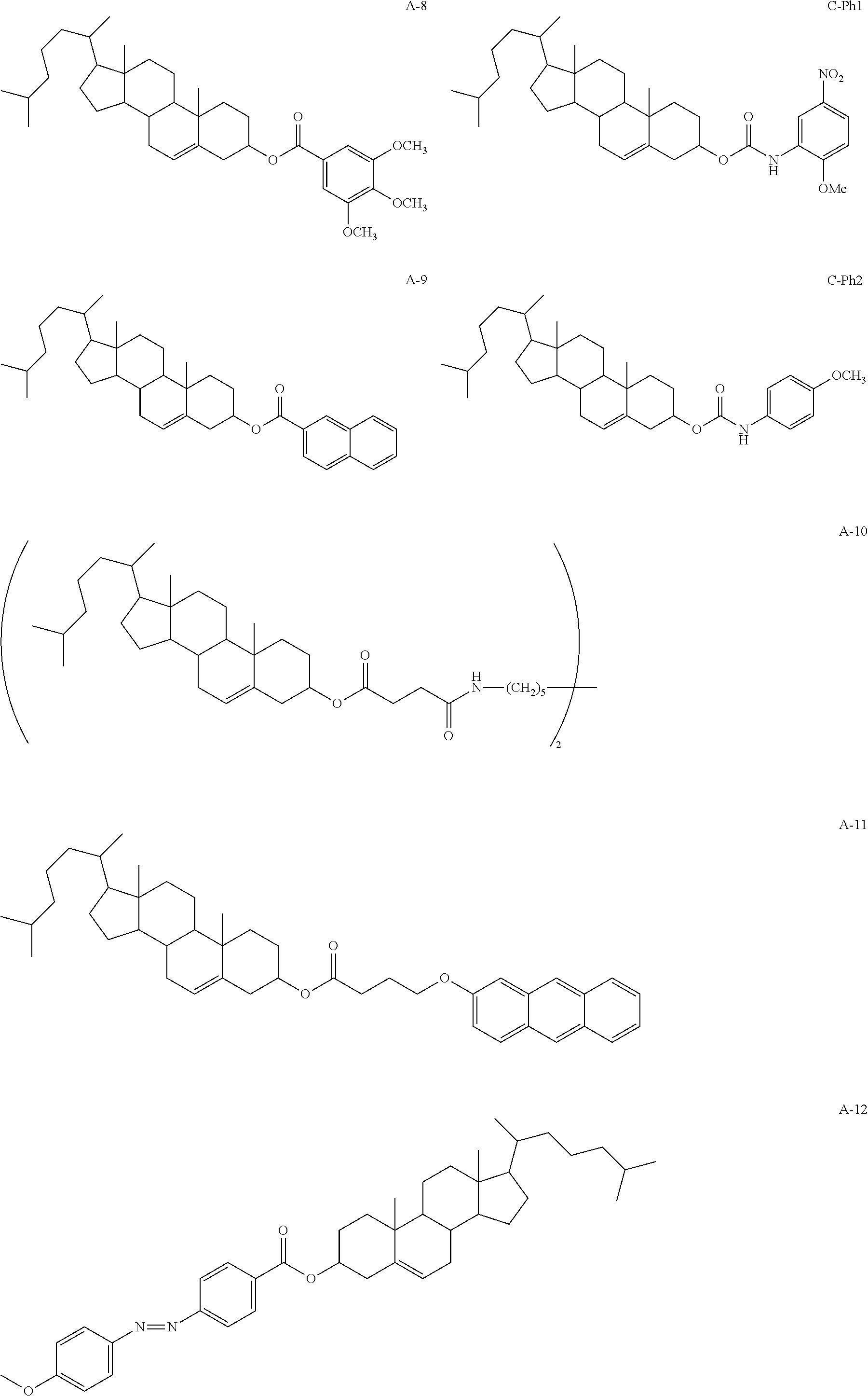

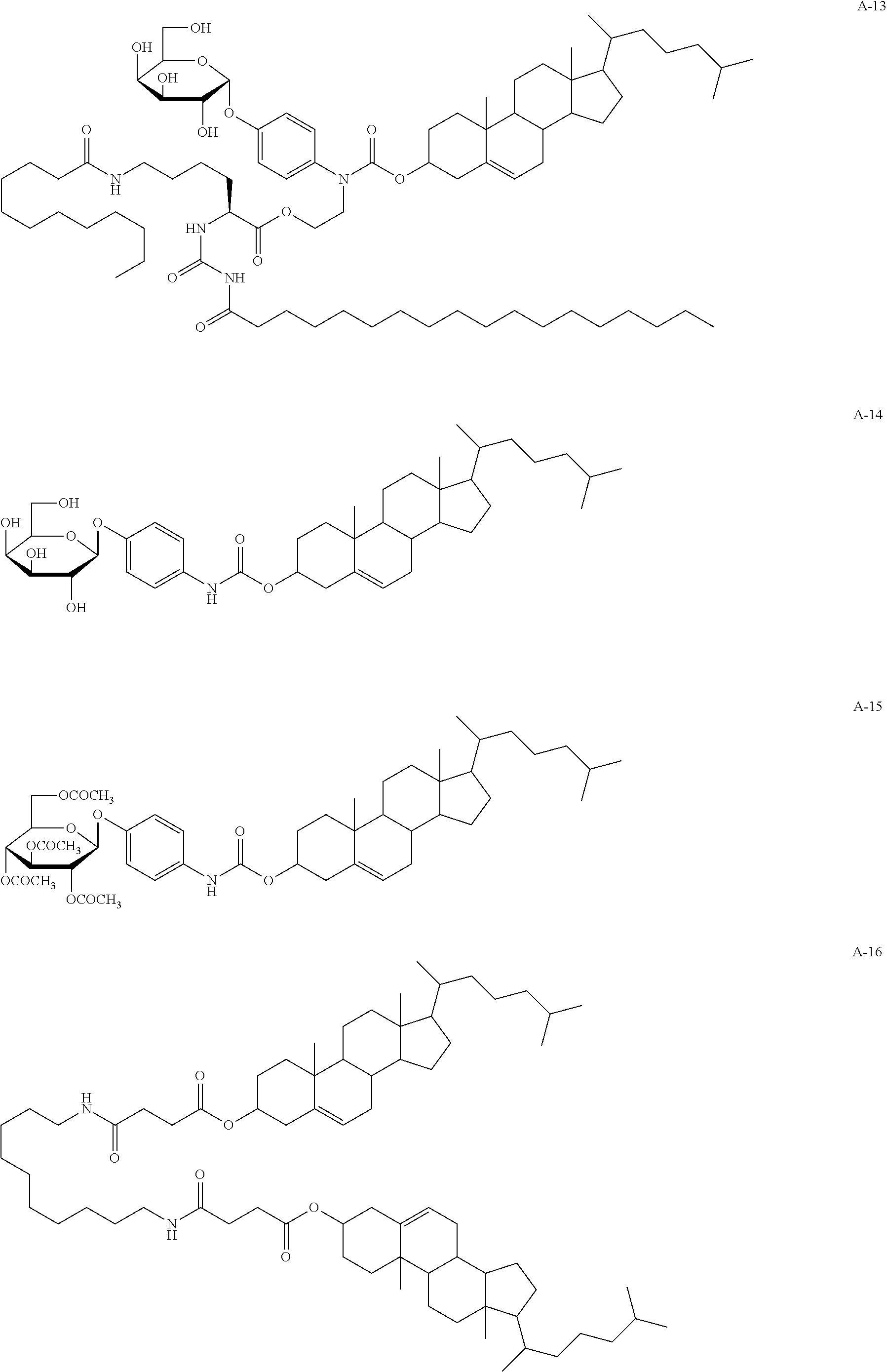

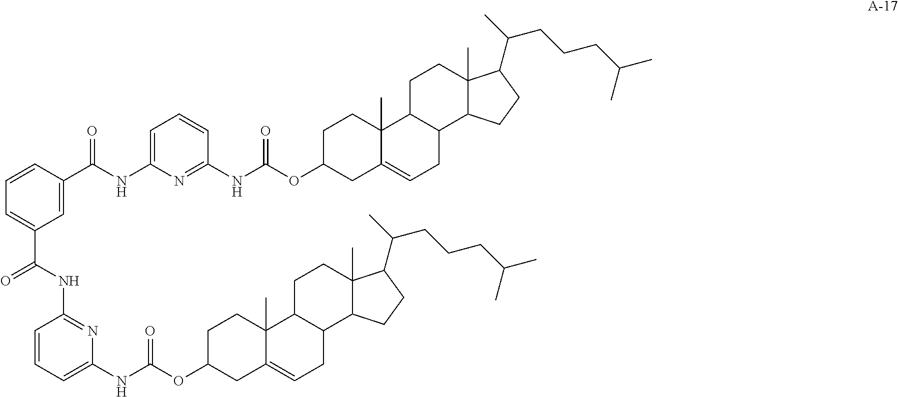

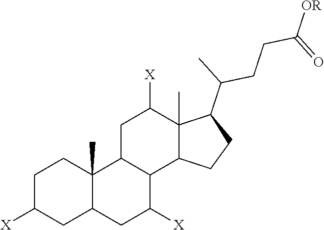

| Compound No. | X | R |
|---|---|---|
| CA-n | OH | CₙH₂ₙ₊₁ |
| | | n: an integer of 1-20 |
| CA-Ac | OCOCH3 | H |
| CA-Ac-n | OCOCH3 | CₙH₂ₙ₊₁ |
| | | n: an integer of 1-20 |

Among the sterol derivatives represented by the foregoing formula (1), commercially available compounds are included, too, and therefore, commercial available products may be utilized in the invention. Also, the sterol derivative represented by the foregoing formula (1) can also be synthesized through a combination of various organic synthesis reactions.

The cellulose acylate film of the invention contains the cellulose derivative represented by the foregoing formula (1) in an amount of preferably from 0.1 to 50% by mass, more preferably from 0.2 to 10% by mass, and still more preferably from 0.25 to 4% by mass on the basis of the total mass of the cellulose acylate film. When the content of the cellulose derivative represented by the formula (1) falls with the foregoing ranges, not only a high Re can be attained, but a problem such as occurrence of deposition of the added compound on the film surface in the film producing process can be reduced.

In this connection, in the case of producing the film of the invention by means of solution film formation, the sterol derivative represented by the foregoing formula (1) can be added in a dope of the cellulose acylate. Timing of the addition is not particularly limited.

### 1-(2) Saccharide Derivative:

The cellulose acylate film of the invention may contain at least one saccharide derivative. When the saccharide derivative is used together with the sterol derivative represented by the foregoing formula (1), the saccharide derivative acts to more enhance the function of the sterol derivative as the Re increasing agent and/or agent for controlling wavelength dispersion characteristics. The saccharide derivative also acts as a plasticizer. Examples of the saccharide derivative include compounds having a furanose structure or a pyranose structure. The compound having a furanose structure or a pyranose structure is preferably a an esterified compound obtained by esterifying all or a part of OH groups in a compound (A) having one furanose structure or pyranose structure or a compound (B) having from 2 to 12 of at least one of a furanose structure and a pyranose structure bonded thereto. These compounds may be hereinafter sometimes named generically a “saccharide ester compound”.

Examples of the compound (A) include glucose, galactose, mannose, fructose, xylose and arabinose. However, it should not be construed that the invention is limited thereto.

Examples of the compound (B) include lactose, sucrose, nystose, 1F-fructosyl nystose, stachyose, maltitol, lactitol, lactulose, cellobiose, maltose, cellotriose, maltotriose, raffinose and kestose. In addition, there are exemplified gentiobiose, gentiotriose, gentiotetraose, xylotriose and galactosyl-sucrose. However, it should not be construed that the invention is limited thereto.

Among these compound (A) and compound (B), compounds having both a furanose structure and a pyranose structure are preferable. As examples thereof, sucrose, kestose, nystose, 1F-fructosyl nystose or stachyose is preferable, and sucrose is more preferable. Also, in the compound (B), a compound having 2 or more and not more than 3 of at least one of a furanose structure and a pyranose structure bonded thereto is one of preferred embodiments.

A monocarboxylic acid which is used for esterifying all or a part of OH groups in the compound (A) or compound (B) is not particularly limited, and known aliphatic monocarboxylic acids, alicyclic monocarboxylic acid and aromatic monocarboxylic acids, and so on can be used. The carboxylic acid may be used singly or in admixture of two or more kinds thereof.

Preferred examples of the aliphatic monocarboxylic acid include saturated fatty acids such as acetic acid, propionic acid, butyric acid, isobutyric acid, valeric acid, caproic acid, enanthic acid, caprylic acid, pelargonic acid, capric acid, 2-ethyl-hexanecarboxylic acid, undecylic acid, lauric acid, tridecylic acid, myristic acid, pentadecylic acid, palmitic acid, heptadecylic acid, stearic acid, nonadecanoic acid, arachic acid, behenic acid, lignoceric acid, cerotic acid, heptacosanoic acid, montanic acid, melissic acid and lacceric acid; and unsaturated fatty acids such as undecylenic acid, oleic acid, sorbic acid, linolic acid, linoleic acid, arachidonic acid and octenoic acid.

Preferred examples of the alicyclic monocarboxylic acid include cyclopentanecarboxylic acid, cyclohexanecarboxylic acid, cyclooctanecarboxylic acid and derivatives thereof.

Preferred examples of the aromatic monocarboxylic acid include benzoic acid and other aromatic monocarboxylic acids obtained by introducing an alkyl group or an alkoxy group into a benzene ring of benzoic acid, such as toluic acid; cinnamic acid; aromatic monocarboxylic acids having 2 or more benzene rings, such as benzilic acid, biphenylcarboxylic acid, naphthalenecarboxylic acid and tetralincarboxylic acid; and derivatives thereof, more specifically, xylylic acid, hemellitic acid, mesitylenic acid, prehnitylic acid, γ-isodurylic acid, durylic acid, mesitonic acid, α-isodurylic acid, cuminic acid, α-toluic acid, hydroatropic acid, atropic acid, hydrocinnamic acid, salicylic acid, o-anisic acid, m-anisic acid, p-anisic acid, creosote acid, o-homosalicylic acid, m-homosalicylic acid, p-homosalicylic acid, o-pyrocatechuic acid, β-resorcylic acid, vanillic acid, isovanillic acid, veratric acid, o-veratric acid, gallic acid, asarylic acid, mandelic acid, homoanisic acid, homovanillic acid, homoveratric acid, o-homoveratric acid, phthalonic acid and p-coumaric acid. Of these, benzoic acid is especially preferable.

Of the esterified compounds obtained by esterifying the foregoing compound (A) or compound (B), acetylated compounds obtained by introducing an acetyl group thereinto by means of esterification are preferable.

A producing method of such an acetylated compound is described in, for example, JP-A-8-245678.

Examples of the compound obtained by bonding from 3 to 12 of at least one of a furanose structure and a pyranose structure also include esterified compounds of oligosaccharide.

Oligosaccharide is manufactured by allowing an enzyme such as amylase to act on starch, sucrose or the like, and examples of oligosaccharide include maltooligosaccharide, isomaltooligosaccharide, furactooligosaccharide, galactooligosaccharide and xylooligosaccharide.

Also, the oligosaccharide can be acetylated in the same method as in the foregoing compound (A) or compound (B).

An example of the producing method of the esterified compound is as follows.

Acetic anhydride (200 mL) was added dropwise to a solution of glucose (29.8 g, 166 mmoles) in pyridine (100 mL), and the mixture was allowed to react for 24 hours. Thereafter, the solution was concentrated by means of evaporation and then poured into water with ice. After allowing the resulting solution to stand for one hour, a solid was separated from water by means of filtration with a glass filter. The solid on the glass filter was dissolved in chloroform and subjected to liquid separation with cold water until the system became neutral. An organic phase was separated and then dried over anhydrous sodium sulfate. After removing the anhydrous sodium sulfate by means of filtration, the chloroform was removed by means of evaporation, and the residue was further dried under reduced pressure to obtain glucose pentaacetate (58.8 g, 150 mmoles, yield: 90.9%). In this connection, the foregoing monocarboxylic acid can be used in place of the acetic anhydride.

Examples of the compound, having a furanose-structure or a pyranose-structure, include, but are not limited, those shown below.

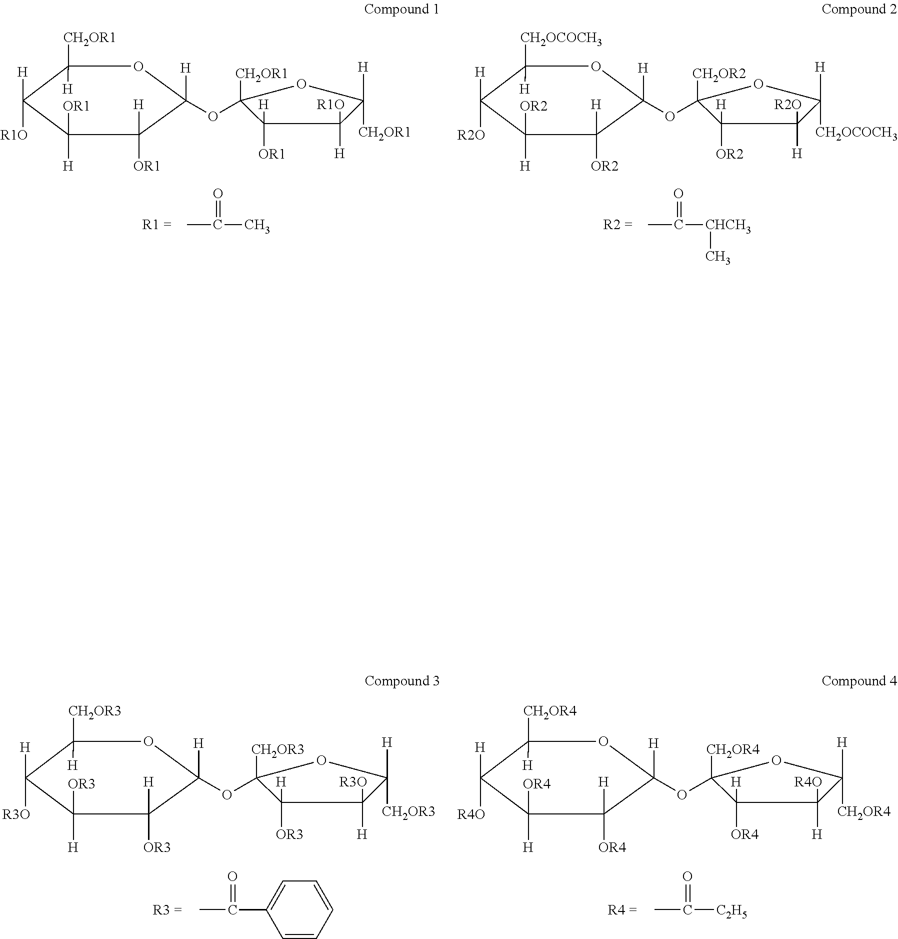

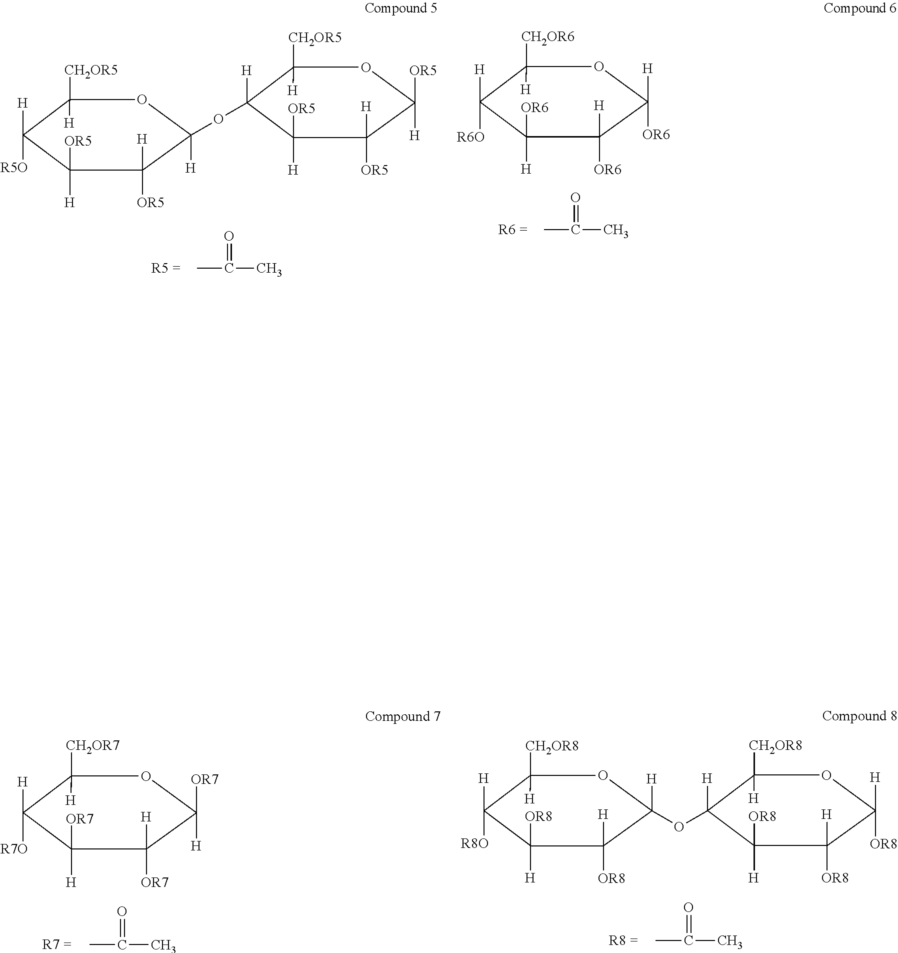

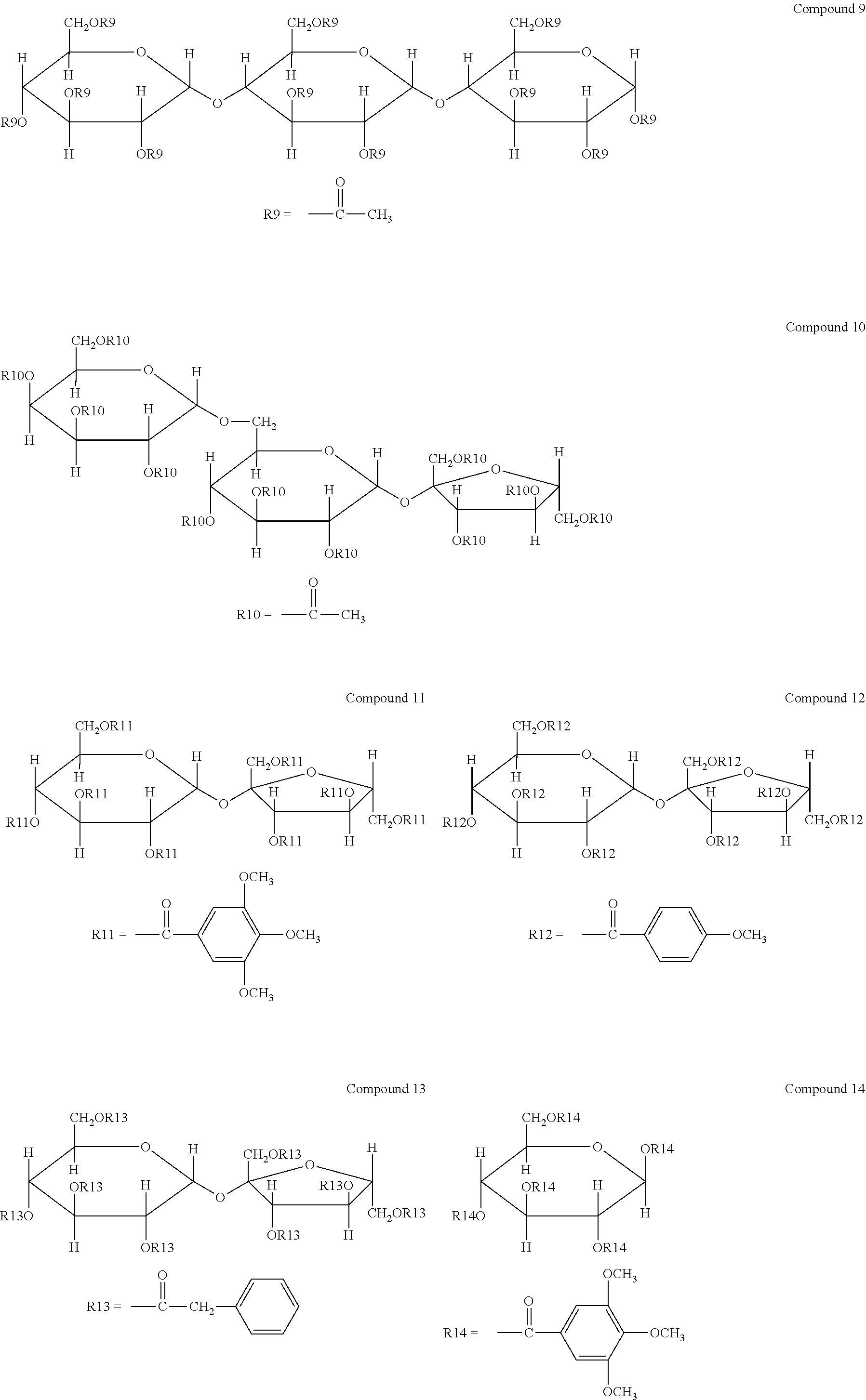

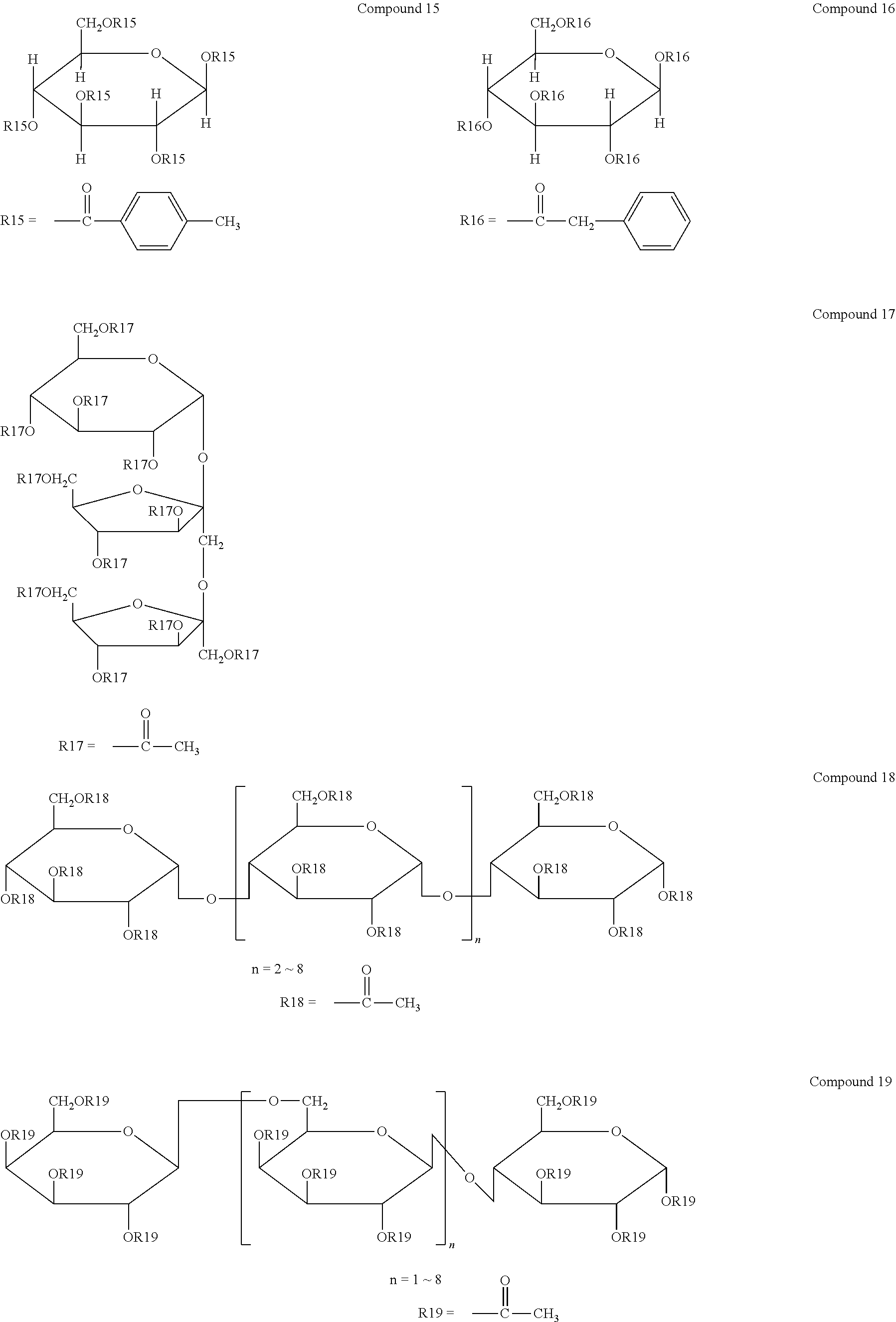

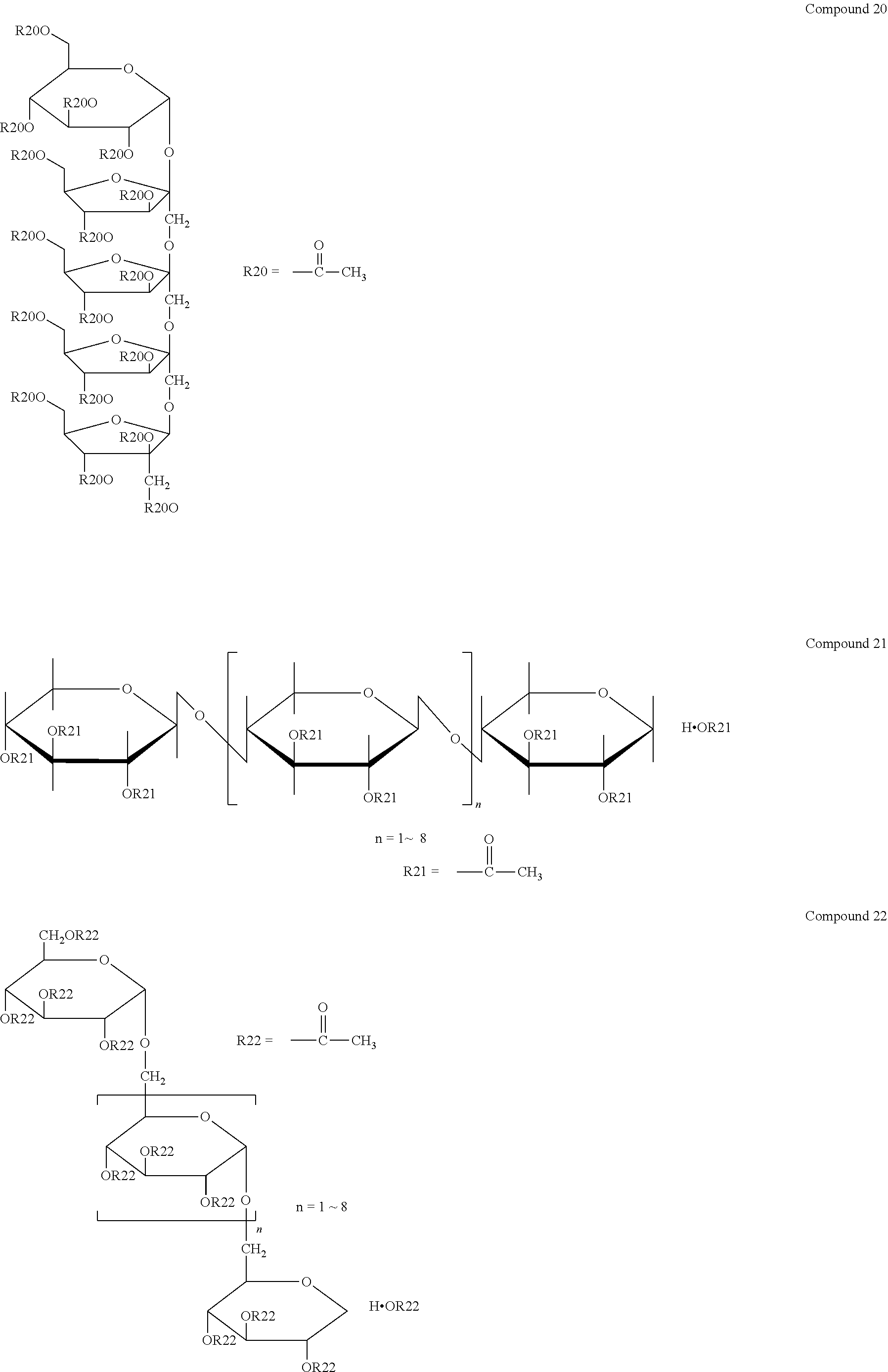

The cellulose acylate film of the invention contains at least one saccharide derivative preferably in an amount of from 1 to 30% by mass, or more preferably from 5 to 30% by mass. In this case, bleeding-out may not occur, which is preferable.

### 1-(3) Oligomer Plasticizer:

The cellulose acylate film of the invention may contain at least one plasticizer selected among oligomers. When the oligomer plasticizer is used together with the sterol derivative represented by the foregoing formula (1), the oligomer plasticizer acts to more enhance the function of the sterol derivative as the Re increasing agent and/or agent for controlling wavelength dispersion. Preferred examples of the oligomer plasticizer include polycondensation esters of a diol component and a dicarboxylic acid compound and derivatives thereof (hereinafter also referred to as “polycondensation ester based plasticizer”); and oligomers of methyl acrylate (MA) and derivatives thereof (hereinafter also referred to as “MA oligomer plasticizer”).

The polycondensation ester is a polycondensation ester of a dicarboxylic acid ingredient and a diol ingredient. The dicarboxylic acid ingredient may consist of one dicarboxylic acid or any mixture of two or more dicarboxylic acids. Among these, the dicarboxylic acid ingredient containing at least one aromatic dicarboxylic acid and at least one aliphatic dicarboxylic acid is preferable. As well as the dicarboxylic acid ingredient, the diol ingredient may consist of one diol or any mixture of two or more diols. Among these, as the diol ingredient, ethylene glycol and/or aliphatic diol having the averaged number of carbon atoms of more than 2 and not more than 3.0 is preferable.

Regarding the ratio of the aromatic dicarboxylic acid to the aliphatic dicarboxylic acid contained in the dicarboxylic acid ingredient, the ratio of the aromatic dicarboxylic acid is preferably from 5 to 70 mol %. In the case that the ratio falls within the range, it is possible to reduce the environmental humidity-dependence and to prevent the bleeding-out from generating in the film formation process. The ratio of the aromatic dicarboxylic acid in the dicarboxylic acid ingredient is more preferably from 10 to 60 mol %, and even more preferably from 20 to 50 mol %.

Examples of the aromatic dicarboxylic acid include phthalic acid, terephthalic acid, isophthalic acid, 1,5-naphthalenedicarboxylic acid, 1,4-naphthalenedicarboxylic acid, 1,8-naphthalenedicarboxylic acid, 2,8-naphthalenedicarboxylic acid, 2,6-naphthalenedicarboxylic acid and the like are preferably used, and phthalic acid and terephthalic acid are more preferred. Examples of the aliphatic dicarboxylic acid that is preferably used in the present invention include oxalic acid, malonic acid, succinic acid, maleic acid, fumaric acid, glutaric acid, adipic acid, pimelic acid, suberic acid, azelaic acid, sebacic acid, dodecanedicarboxylic acid and 1,4-cyclohexanedicarboxylic acid, with succinic acid and adipic acid being preferred.

The diol ingredient is preferably ethylene glycol and/or aliphatic diol having the averaged number of carbon atoms of more than 2 and not more than 3.0. the ratio of ethylene glycol in the diol ingredient is preferably equal to or more than 50 mol %, or more preferably equal to or more than 75 mol %. The aliphatic diol includes alkyl diols and alicyclic diols, and examples thereof include ethylene glycol, 1,2-propanediol, 1,3-propanediol, 1,2-butanediol, 1,3-butanediol, 2-methyl-1,3-propanediol, 1,4-butanediol, 1,5-pentanediol, 2,2-dimethyl-1,3-propanediol (neopentyl glycol), 2,2-diethyl-1,3-propanediol (3,3-dimethylolpentane), 2-n-butyl-2-ethyl-1,3-propanediol (3,3-dimethylolheptane), 3-methyl-1,5-pentanediol, 1,6-hexanediol, 2,2,4-trimethyl-1,3-pentanediol, 2-ethyl-1,3-hexanediol, 2-methyl-1,8-octanediol, 1,9-nonanediol, 1,10-decanediol, 1,12-octadecanediol and diethylene glycol. One kind of or a mixture of two or more kinds of these aliphatic diols is preferably used together with ethanediol.

Among these aliphatic diols, ethylene glycol, 1,2-propanediol and 1,3-propanediol are preferred, and ethylene glycol and 1,2-propanediol are more preferred.

As the polycondensed ester-type oligomer plasticizer, the polycondensed ester having the terminal OH forming esters with a monocarboxylic acid are preferable. Preferred examples of the monocarboxylic acid used for capping include acetic acid, propionic acid and butenoic acid. Among these, acetic acid and propionic acid are more preferred, and acetic acid is most preferred. Preferred examples of the monoalcohols used for capping include methanol, ethanol, propanol, isopropanol, butanol and isobutanol, with methanol being most preferred. When the carbon number of monocarboxylic acids used for the terminal end of the polycondensed ester is 3 or less, the loss on heating of the compound is not increased and no surface failure is caused. And any mixture of two or more types of monocarboxylic acids may be used for capping. The polycondensed esters having, at the both ends, the terminal OH forming ester with acetic acid or propionic acid are preferable; and the polycondensed esters having, at the both ends, the terminal OH forming ester with acetic acid are more preferable.

The number average molecular weight of the polycondensed ester is preferably from 700 to 2,000, more preferably from 800 to 1,500, still more preferably from 900 to 1,200. The number average molecular weight of the polycondensed ester for use in the present invention can be measured and evaluated by gel permeation chromatography.

Specific examples of the polycondensed ester for use in the present invention are set forth in Table 1, but the present invention is not limited thereto.

| | | | | Diol | | | | |
|---|---|---|---|---|---|---|---|---|
| | | | | | | Averaged | | |
| | | | | | | numbers | | |
| | Dicarboxylic acid | | | | | of carbon | | |
| | | | Ratio of | | Ratio of | atoms in | | Number- |
| | Aromatic | Aliphatic | dicarboxylic | | Aliphatic | Aliphatic | | averaged |
| | dicarboxylic | dicarboxylic | acid(s) | Aliphatic | diol(s) | diol(s) | Both | molecular |
| | acid | acid | (mol %) | diol(s) | (mol %) | (mol %) | terminals | weight |
| P-1 | PA | AA | 10/90 | Ethylene | 100 | 2.0 | acetyl ester | 1000 |
| | | | | glycol | | | residue | |
| P-2 | PA | AA | 25/75 | Ethylene | 100 | 2.0 | acetyl ester | 1000 |
| | | | | glycol | | | residue | |
| P-3 | PA | AA | 50/50 | Ethylene | 100 | 2.0 | acetyl ester | 1000 |
| | | | | glycol | | | residue | |
| P-4 | PA | SA | 5/95 | Ethylene | 100 | 2.0 | acetyl ester | 1000 |
| | | | | glycol | | | residue | |
| P-5 | PA | SA | 20/80 | Ethylene | 100 | 2.0 | acetyl ester | 1000 |
| | | | | glycol | | | residue | |
| P-6 | TPA | AA | 15/85 | Ethylene | 100 | 2.0 | acetyl ester | 1000 |
| | | | | glycol | | | residue | |
| P-7 | TPA | AA | 50/50 | Ethylene | 100 | 2.0 | acetyl ester | 1000 |
| | | | | glycol | | | residue | |
| P-8 | TPA | SA | 5/95 | Ethylene | 100 | 2.0 | acetyl ester | 1000 |
| | | | | glycol | | | residue | |
| P-9 | TPA | SA | 10/90 | Ethylene | 100 | 2.0 | acetyl ester | 1000 |
| | | | | glycol | | | residue | |
| P-10 | TPA | SA | 15/85 | Ethylene | 100 | 2.0 | acetyl ester | 1000 |
| | | | | glycol | | | residue | |
| P-11 | TPA | SA | 50/50 | Ethylene | 100 | 2.0 | acetyl ester | 1000 |
| | | | | glycol | | | residue | |
| P-12 | TPA | SA | 70/30 | Ethylene | 100 | 2.0 | acetyl ester | 1000 |
| | | | | glycol | | | residue | |
| P-13 | TPA/PA | AA | 10/10/80 | Ethylene | 100 | 2.0 | acetyl ester | 1000 |
| | | | | glycol | | | residue | |
| P-14 | TPA/PA | AA | 20/20/60 | Ethylene | 100 | 2.0 | acetyl ester | 1000 |
| | | | | glycol | | | residue | |
| P-15 | TPA/PA | AA/SA | 10/10/40/40 | Ethylene | 100 | 2.0 | acetyl ester | 1000 |
| | | | | glycol | | | residue | |
| P16 | TPA | AA/SA | 10/30/60 | Ethylene | 100 | 2.0 | acetyl ester | 1000 |
| | | | | glycol | | | residue | |
| P-17 | TPA | AA/SA | 10/30/60 | Ethylene | 50/50 | 2.5 | acetyl ester | 1000 |
| | | | | glycol/ | | | residue | |
| | | | | 1,2-propane | | | | |
| | | | | diol | | | | |
| P-18 | TPA | AA/SA | 10/30/60 | 1,2-propane | 100 | 3.0 | acetyl ester | 1000 |
| | | | | diol | | | residue | |
| P-19 | TPA | AA/SA | 10/30/60 | Ethylene | 100 | 2.0 | acetyl ester | 700 |
| | | | | glycol | | | residue | |
| P-20 | TPA | AA/SA | 10/30/60 | Ethylene | 100 | 2.0 | acetyl ester | 850 |
| | | | | glycol | | | residue | |
| P-21 | TPA | AA/SA | 10/30/60 | Ethylene | 100 | 2.0 | acetyl ester | 1200 |
| | | | | glycol | | | residue | |
| P-22 | TPA | AA/SA | 10/30/60 | Ethylene | 100 | 2.0 | acetyl ester | 1600 |
| | | | | glycol | | | residue | |
| P-23 | TPA | AA/SA | 10/30/60 | Ethylene | 100 | 2.0 | acetyl ester | 2000 |
| | | | | glycol | | | residue | |
| P-24 | TPA | AA/SA | 10/30/60 | Ethylene | 100 | 2.0 | propionyl | 1000 |
| | | | | glycol | | | ester residue | |
| P-25 | TPA | AA/SA | 10/30/60 | Ethylene | 100 | 2.0 | butanoyl ester | 1000 |
| | | | | glycol | | | residue | |
| P-26 | TPA | AA/SA | 10/30/60 | Ethylene | 100 | 2.0 | benzoyl ester | 1000 |
| | | | | glycol | | | residue | |
| P-27 | TPA | AA/SA | 20/40/40 | Ethylene | 100 | 2.0 | acetyl ester | 1000 |
| | | | | glycol | | | residue | |
| P-28 | 2,6-NPA | AA/SA | 20/40/40 | Ethylene | 100 | 2.0 | acetyl ester | 1200 |
| | | | | glycol | | | residue | |
| P-29 | 1,5-NPA | AA/SA | 20/40/40 | Ethylene | 100 | 2.0 | acetyl ester | 1200 |
| | | | | glycol | | | residue | |
| P-30 | 1,4-NPA | AA/SA | 20/40/40 | Ethylene | 100 | 2.0 | acetyl ester | 1200 |
| | | | | glycol | | | residue | |
| P-31 | 1,8-NPA- | AA/SA | 20/40/40 | Ethylene | 100 | 2.0 | acetyl ester | 1200 |
| | | | | glycol | | | residue | |
| P-32 | 2,8-NPA | AA/SA | 20/40/40 | Ethylene | 100 | 2.0 | acetyl ester | 1200 |
| | | | | glycol | | | residue | |

In Table, PA means phthalic acid;
TPA means terephthalic acid;
IPA means isophthalic acid;
AA means adipic acid;
SA means succinic acid;
2,6-NPA means 2,6-naphthalene dicarboxylic acid;
2,8-NPA means 2,8-naphthalene dicarboxylic acid.
1,5-NPA means 1,5-naphthalene dicarboxylic acid;
1,4-NPA means 1,4-naphthalene dicarboxylic acid; and
1,8-NPA means 1,8-naphthalene dicarboxylic acid.

As to the synthesis of the polycondensed ester for use in the present invention, the polycondensed ester can be easily synthesized in a usual manner either by a heat-melting condensation method using a polyesterification or transesterification reaction of the dicarboxylic acid, the diol and, if desired, a monocarboxylic acid or monoalcohol for end capping or by an interfacial condensation reaction of acid chlorides of these acids with glycols. Details of these polyester-based plasticizers are described in Koichi Murai (compiler), Kaso-zai Sono Riron to Oyo (Plasticizers, and Theory and Application Thereof) (Saiwai Shobo, 1st edition, published on Mar. 1, 1973). Furthermore, the materials described, for example, in JP-A-05-155809, JP-A-05-155810, JP-A-05-197073, JP-A-2006-259494, JP-A-07-330670, JP-A-2006-342227 and JP-A-2007-003679 can also be used.

The amount added of the polycondensed ester for use in the present invention is preferably from 0.1 to 25 mass %, more preferably from 1 to 20 mass %, and most preferably from 3 to 15 mass %, based on the amount of the cellulose acylate.

The content of the starting materials and the side products in the polycondensation-ester plasticizer, concretely aliphatic diols, dicarboxylates, diol esters and others, that may be in the film is preferably less than 1%, more preferably less than 0.5%. The dicarboxylate includes dimethyl phthalate, di(hydroxyethyl) phthalate, dimethyl terephthalate, di(hydroxyethyl) terephthalate, di(hydroxyethyl) adipate, di(hydroxyethyl) succinate, etc. The diol ester includes ethylene diacetate, propylene diacetate, etc.

As the plasticizer for the cellulose ester film of the invention, also preferred is a methyl methacrylate (MA) oligomer plasticizer. The MA oligomer plasticizer may be combined with the above-mentioned saccharide plasticizer for use herein. In the mode of combination use, the ratio by mass of the MA oligomer plasticizer to the saccharide plasticizer is preferably from 1/2 to 1/5, more preferably from 1/3 to 1/4. Examples of the MA-oligomer plasticizer include oligomers having a repeating unit shown below.

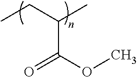

The weight-averaged molecular weight is preferably from about 500 to about 2000, more preferably from about 700 to about 1500; and more preferably from about 800 to about 1200.

Examples of the MA-oligomer plasticizer include both of oligomers of MA alone and oligomers having other repeating unit(s) along with the representing unit derived from MA. Examples of the other repeating unit(s) include any units derive from ethyl acrylate, i- or n-propyl acrylate, n-, s- or t-butyl acrylate, n-, i- or s-pentyl acrylate, n- or i-hexyl acrylate, n- or i-heptyl acrylate, n- or i-octyl acrylate, n- or i-nonyl acrylate, n- or i-myristyl acrylate, 2-ethylhexyl acrylate, ε-caprolactam acrylate, 2-hydroxyethyl acylate, 2-hydroxypropyl acrylate, 3-hydroxypropyl acrylate, 4-hydroxybutyl acrylate, 2-hydroxybutyl acrylate, 2-methoxyethyl acrylate, 2-ethoxyethyl acrylate and methacrylates formed by replacing acrylic acid in the acrylates with methacrylic acid. Monomers having an aromatic ring(s) such as styrene, methyl styrene and hydroxy styrene may be used. As the other monomer(s), acrylate monomer(s) or methacrylate monomer(s), having no aromatic ring, are preferable.

The MA-oligomer plasticizer, having two or more repeating units derived from X which is a monomer having a hydrophilic group(s) and from Y which is a monomer having no hydrophilic group, may be used. Among such oligomers, those having a molar ratio of X to Y, X/Y, of from 1/1 to 1/99 are preferable.

The MA-oligomer may be prepared in reference to the method described in JP-A No. 2003-12859.

### 1-(4) Cellulose Acylate:

The film of the invention contains at least one cellulose acylate as a main component.

The “cellulose acylate” as referred to in the invention means, for example, a compound having cellulose as a basic structure, examples of which include compounds having a cellulose skeleton obtained by biologically or chemically introducing a functional group into cellulose as a raw material. In the invention, a mixture of two or more different kinds of cellulose acylates may be used.

The cellulose acylate is a cellulose derivative obtained by substituting a hydrogen atom of a hydroxyl group in the cellulose skeleton with an acyl group, and examples thereof include cellulose triacetate and cellulose acetate propionate.

Examples of the cellulose which is used as the raw material of the cellulose acylate include cotton linter and wood pulps (for example, hardwood pulps and soft wood pulps), and cellulose acylates obtained from any of these raw material celluloses can be used. If desired, a mixture thereof may be used. These raw material celluloses are described in detail in, for example, Course of Plastic Materials (17): Cellulose Resins (written by Marusawa and Uda and published by The Nikkan Kogyo Shimbun, Ltd. (1970)); and Journal of Technical Disclosure, No. 2001-1745 (pages 7 to 8) by Japan Institute of Invention and Innovation. But, it should be construed that the cellulose acylate film of the invention is not particularly limited thereto.

The acyl group of the cellulose acylate in the invention is not particularly limited. For example, an acetyl group, a propionyl group, a butyryl group or a benzoyl group is preferable, but it should not be construed that the invention is limited thereto. A degree of substitution of total acyl groups is preferably from 2.0 to 3.0, and more preferably from 2.2 to 2.95. The acyl group is most preferably an acetyl group, and in the case of using cellulose acetate having an acetyl group as the acyl group, a degree of acylation (total degree of substitution of the acyl group) is preferably from 2.00 to 2.98, and more preferably from 2.10 to 2.97.

A glucose unit having a β-1,4-bond constituting cellulose has free hydroxyl groups at the 2-, 3- and 6-positions. The cellulose acylate is a polymer obtained by esterifying a part or all of these hydroxyl groups by an acyl group. The degree of acryl substitution means a proportion at which cellulose is esterified at each of the 2-, 3- and 6-positions, and when all of the hydrogen atoms are substituted, the degree of substitution is then 3.

In the invention, it is preferable to use, as a main component, each of cellulose acylates of first and second examples satisfying the following conditions.

### First Example

A cellulose acylate in which hydrogen atoms of hydroxyl groups of the cellulose skeleton are substituted substantially only with an acetyl group, and a total degree of substitution thereof is from 2.00 to 3.00 (the total degree of substitution is more preferably from 2.10 to 2.97).

### Second Example

A cellulose acylate in which hydrogen atoms of hydroxyl groups of the cellulose skeleton are substituted substantially with at least two kinds selected from the group consisting of an acetyl group, a propionyl group and a butanoyl group, and a total degree of substitution thereof is from 2.00 to 3.00 (the total degree of substitution is more preferably from 2.20 to 2.95).

In this connection, the term “substantially” as referred to herein means that a degree of substitution of other kind than the foregoing substituents is not more than 0.01.

The cellulose acylate which is used in the invention preferably has a mass average degree of polymerization of from 350 to 800 and more preferably has a mass average degree of polymerization of from 370 to 600. Also, the cellulose acylate which is used in the invention preferably has a number average molecular weight of from 70,000 to 230,000, more preferably has a number average molecular weight of from 75,000 to 230,000 and still more preferably has a number average molecular weight of from 78,000 to 120,000.

The cellulose acylate can be synthesized using, as an acylating agent, an acid anhydride or an acid chloride. The most industrially general synthesis method is as follows. The desired cellulose acylate can be synthesized by esterifying cellulose obtained from cotton linter, wood pulp or the like with a mixed organic acid component containing an organic acid (for example, acetic acid, propionic acid or butyric acid) or an acid anhydride thereof (for example, acetic anhydride, propionic anhydride or butyric anhydride), which is corresponding to an acetyl group, a propionyl group and/or a butyryl group. Also, with respect to the raw material cotton of the cellulose acylate and the synthesis method thereof, for example, those described in Journal of Technical Disclosure, No. 2001-1745, pages 7 to 12, issued on Mar. 15, 2001 by Japan Institute of Invention and Innovation can be preferably adopted.

### 1-(5) Other Additives:

For achieving any purpose, the cellulose acylate film of the invention may contain at least one additive along with the sterol derivative represented by formula (1), and the saccharide derivative and/or the oligomer plasticizer. The additive may be added to a cellulose acylate dope, if the cellulose acylate is prepared according to a solution film forming method. The timing of the addition is not limited. The additive may be selected from the materials compatible with the cellulose acylate to be used as a main ingredient. Furthermore, according to the solution film forming method, the additive may be selected from the materials which are dissolved into the dope. The additive may be added for controlling the optical properties or the like of the cellulose acylate film.

Examples of the additive which can be used in the invention will be described in detail below, but are not limited to the following examples. In general, an amount of other additive to be used along with the compound represented by formula (1) is preferably from about 0 to about 50% by mass, but is not limited to the range.

### (Other Additive for Controlling Optical Properties)

The cellulose acylate film may contain other additive for controlling optical properties along with the sterol derivative represented by formula (1). Examples of such an additive include agents capable of increasing Re as well as the sterol derivative represented by formula (1) and agents capable of increasing Rth. And other additives capable of controlling wavelength-dispersion characteristics may be also used.

One example is a low-molecular weight compound (A) having a structure represented by formula (a).

### Low-Molecular Weigh Compound (A):

The low-molecular weight compound (A) which can be used in the invention is a compound having a structure represented by formula (a) in its skeleton.

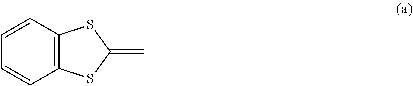

The low-molecular weigh compound (A) is preferably a compound represented by formula (A-1). The compound represented by formula (A-1) is described below.

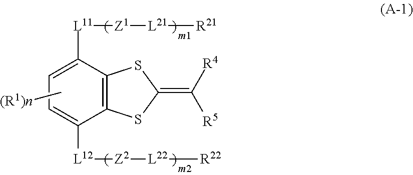

### <R¹>

In formula (A-I), R¹ represents a substituent. When there are two or more R¹, they may be same or different from each other, or form a ring. R¹ is preferably a halogen atom, an alkyl group, an alkenyl group, an aryl group, a heterocyclic group, hydroxyl group, a carboxyl group, an alkoxy group, an aryloxy group, an acyloxy group, cyano group or an amino group; more preferably a halogen atom, an alkyl group having 1 to 8 carbon atoms, cyano group or an alkoxy group having 1 to 8 carbon atoms; further preferably chlorine atom, a methyl group, a t-butyl group, cyano group or a methoxy group; and most preferably a methyl group or a t-butyl group.

n is an integer from 0 to 2, and preferably 0 or 1.

### <R⁴, R⁵>

R⁴ and R⁵ each independently is a substituent. R⁴ and R⁵ each are preferably an electron-attractive substituent having Hammett's substituent constant σₚ value of preferably more than 0, more preferably 0.2 or more, further preferably 0.35 or more, and most preferably 0.35 to 1.5.

Herein, the Hammett's substituent constant σₚ values are described. The Hammett rule is an empirical rule proposed by L. P. Hammett in 1935 to discuss quantitatively the influence of substituents on the reaction or equilibrium of benzene derivatives, and its validity is approved widely nowadays. The substituent constant determined with the Hammett rule includes σₚ value and σₘ value, and these values can be found in many general literatures. For example, such values are described in detail in e.g. “Lange's Handbook of Chemistry”, 12th edition, (1979), edited by J. A. Dean (McGraw-Hill), “Kagaku No Ryoiki” (Region of Chemistry), extra edition, No. 122, pp. 96-103, (1979) (Nankodo), “Chemical Reviews”, Vol. 91, pp. 165-195, (1991), “Hammett Rule-Structure and Reactivity-” by Naoki Inamoto (Maruzen), “New Chemical Experiments, Vol. 14, Synthesis and Reaction of Organic Compounds, V”, page 2605, edited by the Chemical Society of Japan (Maruzen), and “Theoretical Organic Chemistry”, page 217, by Tadao Nakatani (Tokyo Kagaku Dojin).

Examples of the substituent having a Hammett's substituent constant σₚ value of equal to or more than 0 include a trifluoromethyl group, a cyano group, a nitro group, a carbonyl group and a carbamoyl group. Among these, preferred examples thereof include a cyano group (0.66), a carboxyl group (—COOH: 0.45), an alkoxycarbonyl group (e.g., —COOMe: 0.45), an aryloxycarbonyl group (e.g., —COOPh: 0.44), a carbamoyl group (—CONH₂: 0.36), an alkylcarbonyl group (e.g., —COMe: 0.50), an arylcarbonyl group (e.g., —COPh: 0.43), an alkylsulfonyl group (e.g., —SO₂Me: 0.72) and an arylsulfonyl group (e.g., —SO₂Ph: 0.68). Herein, “Me” represents a methyl group, and “Ph” represents a phenyl group. The values in the parentheses are σₚ values of typical substituents which are excerpted from Chem. Rev., 91, pp. 165 to 195, (1991).

At least one of R⁴ and R⁵ is preferably a substituent having a Hammett's substituent constant σₚ value of 0 or more; and both R⁴ and R⁵ each are particularly preferably a substituent having a Hammett's substituent constant σₚ value of 0 or more.

At least one of R⁴ and R⁵ is preferably a cyano group, an alkylcarbonyl group, an arylcarbonyl group, an alkyloxycarbonyl group, an aryloxycarbonyl group, a carbamoyl group or a sulfonyl; more preferably a cyano group, an alkylcarbonyl group, an alkyloxycarbonyl group or a carbamoyl group; further preferably a cyano group, an alkylcarbonyl group, an alkyloxycarbonyl group or a carbamoyl group, each having 10 or less carbon atoms; and most preferably a cyano group.

Both R⁴ and R⁵ each are preferably any one of a cyano group, an alkylcarbonyl group, an arylcarbonyl group, an alkyloxycarbonyl group, an aryloxycarbonyl group, a carbamoyl group and a sulfonyl; and more preferably a cyano group, an alkylcarbonyl group, an alkyloxycarbonyl group and a carbamoyl group.

R⁴ and R⁵ may be bonded with each other to form a ring. The formed ring may be a saturated or unsaturated, hydrocarbon ring or heterocyclic ring. Examples of the ring formed by R⁴ and R⁵ include a cyclopropane ring, a cyclobutane ring, a cyclopentane ring, a cyclohexane ring, a cycloheptane ring, a pyrrolidine ring, a tetrahydrofuran ring, a tetrahydrothiophene ring, an oxazoline ring, a thiazoline ring, a pyrroline ring, a pyrazolidine ring, a pyrazoline ring, an imidazolidine ring, an imidazoline ring, a piperidine ring, a piperadine ring, and a pyran ring. These rings may have a substituent at any position on the ring.

Next, the group represented by -L be described in detail.

### <L¹¹, L¹², L²¹, L²²>

L¹¹, L¹², L²¹, and L²² each independently represents a single bond, or a divalent linking group selected from the group consisting of —O—, —S—, —S(═O)₂—, —CO—, —NR^{A}— (R^{A} represents an alkyl group having 1 to 7 carbon atoms, or a hydrogen atom), —CH₂— and combination of these (divalent linking group formed by bonding of two or more of the above linking groups).

Example of the divalent linking group formed by bonding of two or more of the above linking groups include —C(═O)O—, —OC(═O)—, —OC(═O)O—, —C(═O)NH—, —NHC(═O)—, —OC(═O)NH—, —NHC(═O)O—, —NHC(═O)NH—, and —O—CH₂—.

L¹¹ and L¹² each are preferably a single bond, —O—*, —C(═O)—O—*, —O—C(═O)—*, —O—CO—O—*, or —OCH₂—*; more preferably —O—*, —O—C(═O)—*, —O—CO—O—*, or —OCH₂—* (in which the symbol “*” means the site to be bonded with Z¹).

L²¹ and L²² each are preferably a single bond, *—O—, *—C(═O)—, *—C(═O)—O—, *—O—C(═O)—, *—O—CO—O—, *—CH₂— or *—CH₂O—; more preferably a single bond, *—O—, *—C(═O)—, *—C(═O)—O— or *—O—C(═O) (in which the symbol “*” means the site to be bonded with Z¹).

### <Z¹, Z²>

Z¹ and Z² each independently represent a divalent 5- or 6-membered cyclic linking group. As the ring contained in the divalent cyclic linking group, aromatic rings, aliphatic rings and heterocycles can be used. The ring may be a single ring or a condensed ring, and also may be substituted.

Examples of the aromatic ring include a benzene ring, a naphthalene ring, an anthracene ring and a phenanthrene ring, each having 6 to 30 carbon atoms. The cyclic group having the benzene ring is preferably a 1,4-phenylene group or a 1,3-phenylene group. The cyclic group having the naphthalene ring is preferably a naphthalene-1,4-diyl group, a naphthalene-1,5-diyl group, a naphthalene-1,6-diyl group, a naphthalene-2,5-diyl group, a naphthalene-2,6-diyl group or a naphthalene-2,7-diyl group.

Among these, particularly preferred ones as the divalent cyclic linking group formed from an aromatic ring are a 1,4-phenylene group, a 1,3-phenylene group and a naphthalene-2,6-diyl group, which may be unsubstituted or substituted, and an unsubstituted or substituted 1,4-phenylene group is most preferred.

Examples of the aliphatic ring include a cyclopentyl ring and a cyclohexane ring, each having 3 to 20 carbon atoms. The cyclic group having the cyclohexane ring is preferably a 1,4-cyclohexylene group. The cyclohexane ring has stereoisomers, namely, a cis-form and a trans-form, but there is no limitation to its isomeric form in the present invention, and a mixture of the two isomeric forms may be used. However, preferred is a trans-cyclohexane ring, and therefore, preferred one as a divalent cyclic linking group formed from an aliphatic ring is a trans-1,4-cyclohexylene group.

Examples of the heterocyclic linking group includes five- or six-membered substituted or unsubstituted aromatic or non-aromatic heterocyclic linking group. Examples of hetero atoms contained in the heterocyclic linking group include N (nitrogen atom), O (oxygen atom), S (sulfur atom) and B (boron atom), but the present invention is not limited thereto. The heterocyclic linking group may preferably contain two or more hetero atoms. The heterocyclic linking group may be monocyclic or may be condensed with other rings, and may have a substituent. Examples of the heterocyclic linking group includes a pyridine ring linking group, a piperidine ring linking group, a piperazine ring linking group, a pyrazine ring linking group, a furan ring linking group, a dioxane ring linking group, a benzimidazole ring linking group, an imidazole ring linking group, a thiophene ring linking group, and a pyrrole ring linking group.

### <R²¹, R²²>

R²¹ and R²² each independently represent a hydrogen atom or a substituted or unsubstituted alkyl group.

R²¹ and R²² each are preferably a substituted or unsubstituted alkyl group having 20 or less carbon atoms; more preferably an unsubstituted alkyl group having 14 or less carbon atoms.

m1 and m2 each represent an integer of 0 to 2, preferably 0 or 1.

When m1 is 2, L²¹ and Z¹ which are present in pluralities, may be identical or different. Similarly, when m2 is 2, L²² and Z² which are present in pluralities, may be identical or different. Furthermore, the group represented by -L¹¹-(Z¹-L²¹)ₘ₁-R²¹ and the group represented by -L¹²-(Z²-L²²)ₘ₂-R²² may be identical or different. From the viewpoint of synthesis, it is preferable that the two groups are identical, but the present invention is not intended to be limited thereto.

Structures that are preferred as the groups represented by -L¹¹-(Z¹-L²¹)ₘ₁-R²¹ and -L¹²-(Z²-L²²)ₘ₂-R²² as discussed above in detail are presented in formula (L1), and particularly preferred structures are presented by formula (L2). The group of -L¹²-(Z²-L²²)ₘ₂-R²² is presented as a group obtained by converting L²² to L²¹, R²² to R²¹, Z² to Z¹, and L¹² to L¹¹. These groups respectively have the same meanings.

<Preferred Examples of the Structure Represented by -L¹¹-(Z¹-L²¹)ₘ₁-R²¹ or the Like>

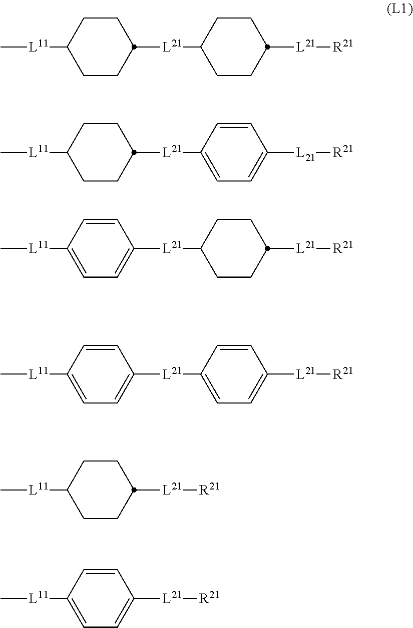

<Preferred Examples of the Structure Represented by -L¹¹-(Z¹-L²¹)ₘ₁-R²¹ or the Like>

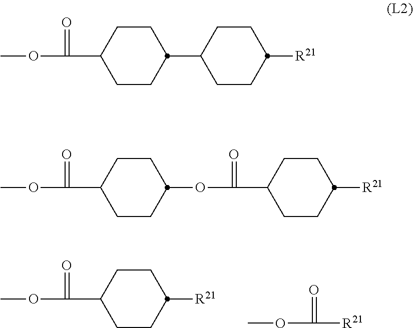

### <Preferred Examples of the Compound Represented by Formula (A-1)>

A preferred example of the compound represented by formula (A-1) of the present invention is such that:

n is 0 or 1; when n is 1, R¹ is a chlorine atom, a methyl group, a t-butyl group or a methoxy group;

R⁴ and R⁵ are each independently a cyano group, an alkylcarbonyl group, an alkyloxycarbonyl group or a carbamoyl group, each having 10 or less carbon atoms;

L¹¹ and L¹² are each a single bond, —O—, —C(═O)—, —C(═O)—O—, —O—C(═O)—, —O—CO—O— or —OCH₂—, and more preferably —O—, —O—C(═O)—, —O—CO—O— or —OCH₂—;

L²¹ and L²² are each a single bond, —O—, —C(═O)—, —O—CO—O—, —OCH₂— or —CH₂O—, and more preferably a single bond, —O—, —C(═O)—, —C(═O)—O— or —O—C(═O)—;

Z¹ and Z² are each an unsubstituted or substituted 1,4-phenylene group or 1,4-cyclohexylene group;

R²¹ and R²² are each independently an unsubstituted alkyl group; and

m1 and m2 are each independently an integer from 0 to 2.

In the present invention, molecular weight of the compound represented by formula (A) is preferably 100 to 3,000, more preferably 200 to 2,000, and most preferably 300 to 1,500.

A compound having than the molecular weight larger than the above-described range is likely to undergo bleed-out, and is not preferable.

In the present invention, content of the low molecular weight compound (A) is preferably 0.1 to 50 mass parts, more preferably 0.2 to 20 mass parts, further preferably 0.2 to 10 mass parts, and most preferably 0.25 to 5 mass parts, with respect to 100 mass parts of the cellulose compound.

The low molecular weight compound (A) and is preferred to express a liquid crystal phase within a temperature range of 100 degrees Celsius to 300 degrees Celsius, more preferably 120 degrees Celsius to 200 degrees Celsius. With regard to the liquid crystal phase of the low molecular weight compound (A), it is preferred to be a columnar phase, a nematic phase or a smectic phase; more preferred a nematic phase or a smectic phase.

### <Specific Examples of the Compound Represented by Formula (A-1)>

Hereinafter, specific examples of the compound represented by formula (A-1) will be shown, but the present invention is not limited thereto. The following compounds are, unless stated otherwise, presented as exemplified compounds (X) with the number in the parentheses. In the following formulae, n represents an integer of 1 to 8; preferably an integer of 2, 3, 4, 5 or 6. (That is, “1-n” represents eight kinds of compounds such as 1-1, 1-2, 1-3, 1-4, 1-5, 1-6, 1-7 and 1-8, depending on “n” representing the number of carbon atoms.) In the following formulae, m represents an integer of 1 to 14; preferably an integer of 4 to 14.

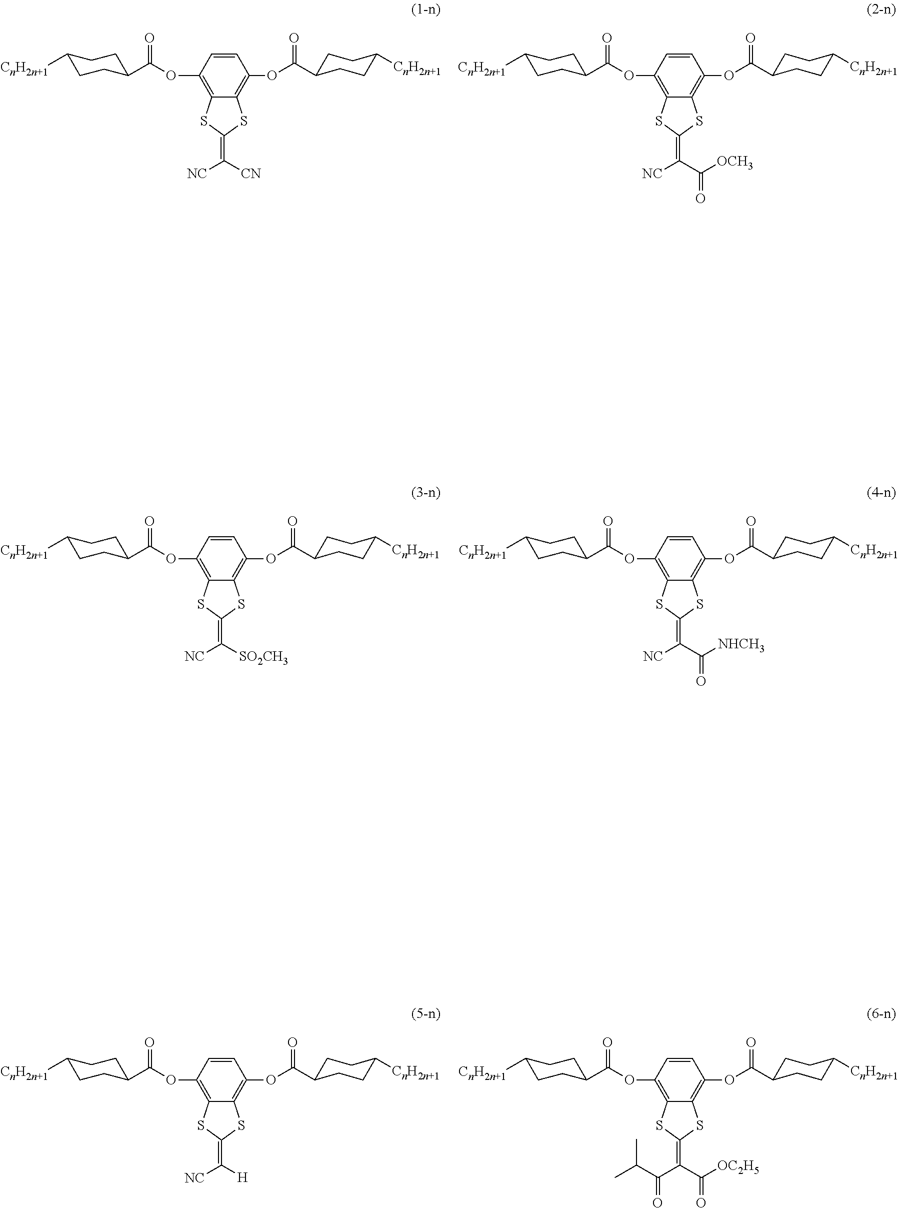

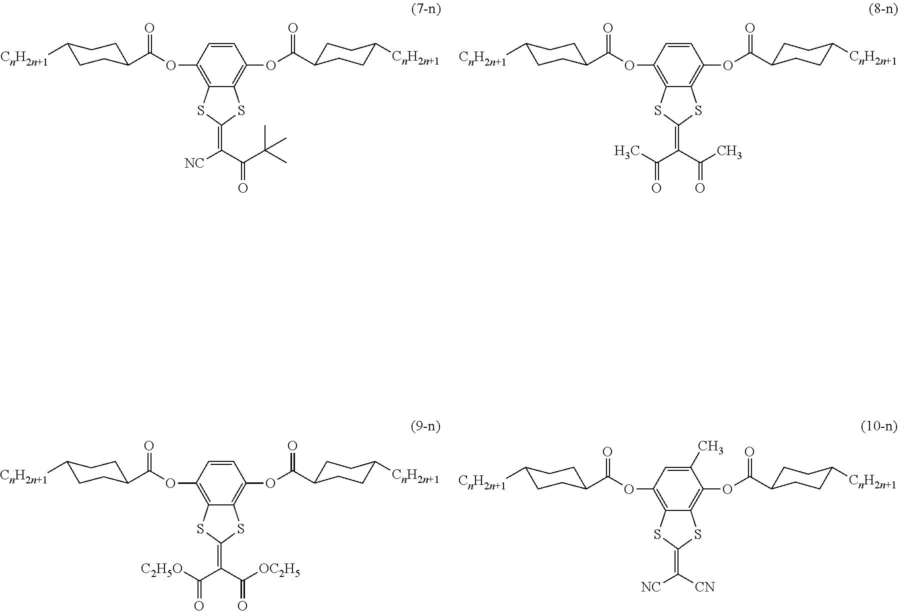

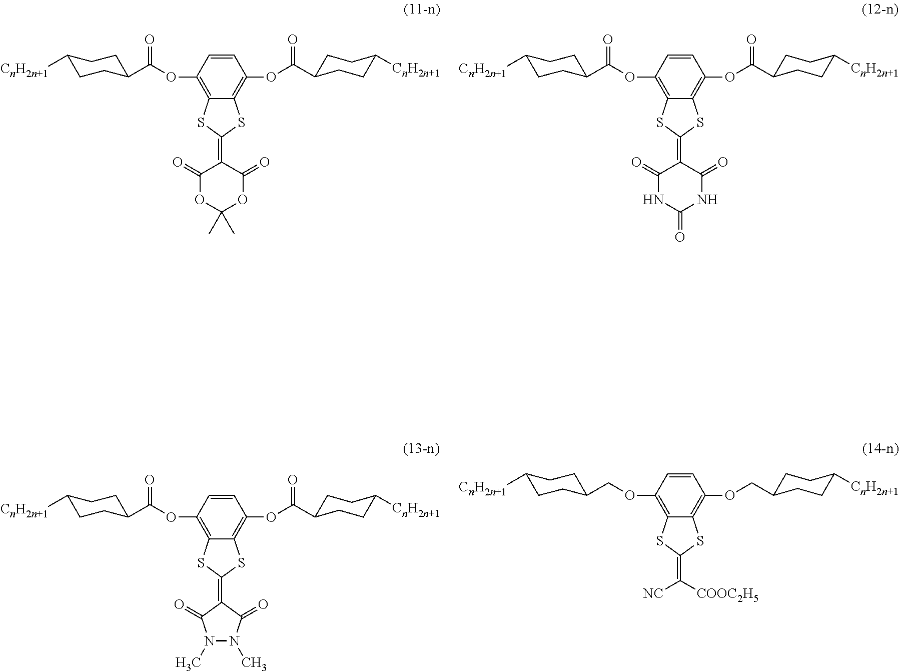

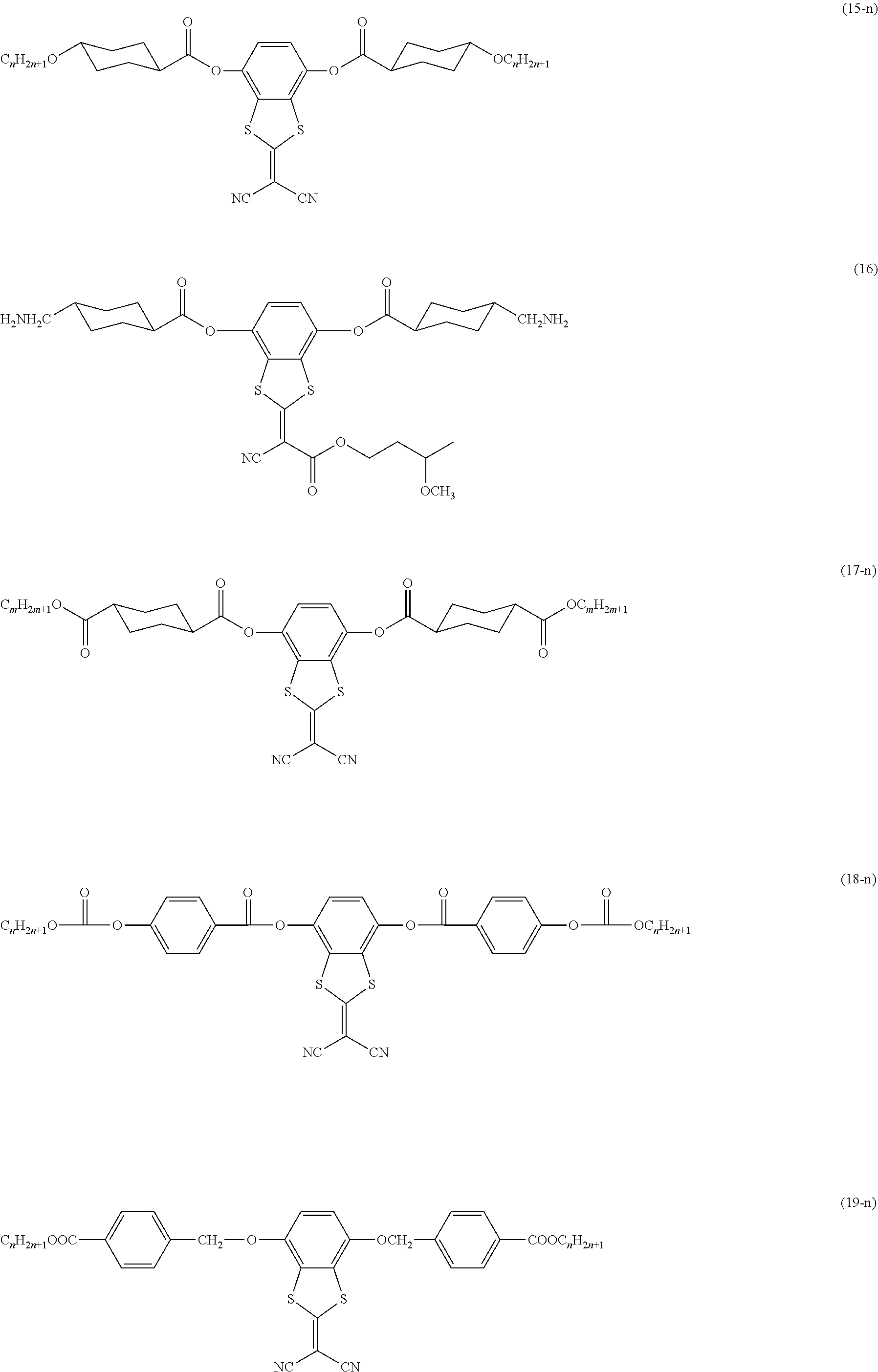

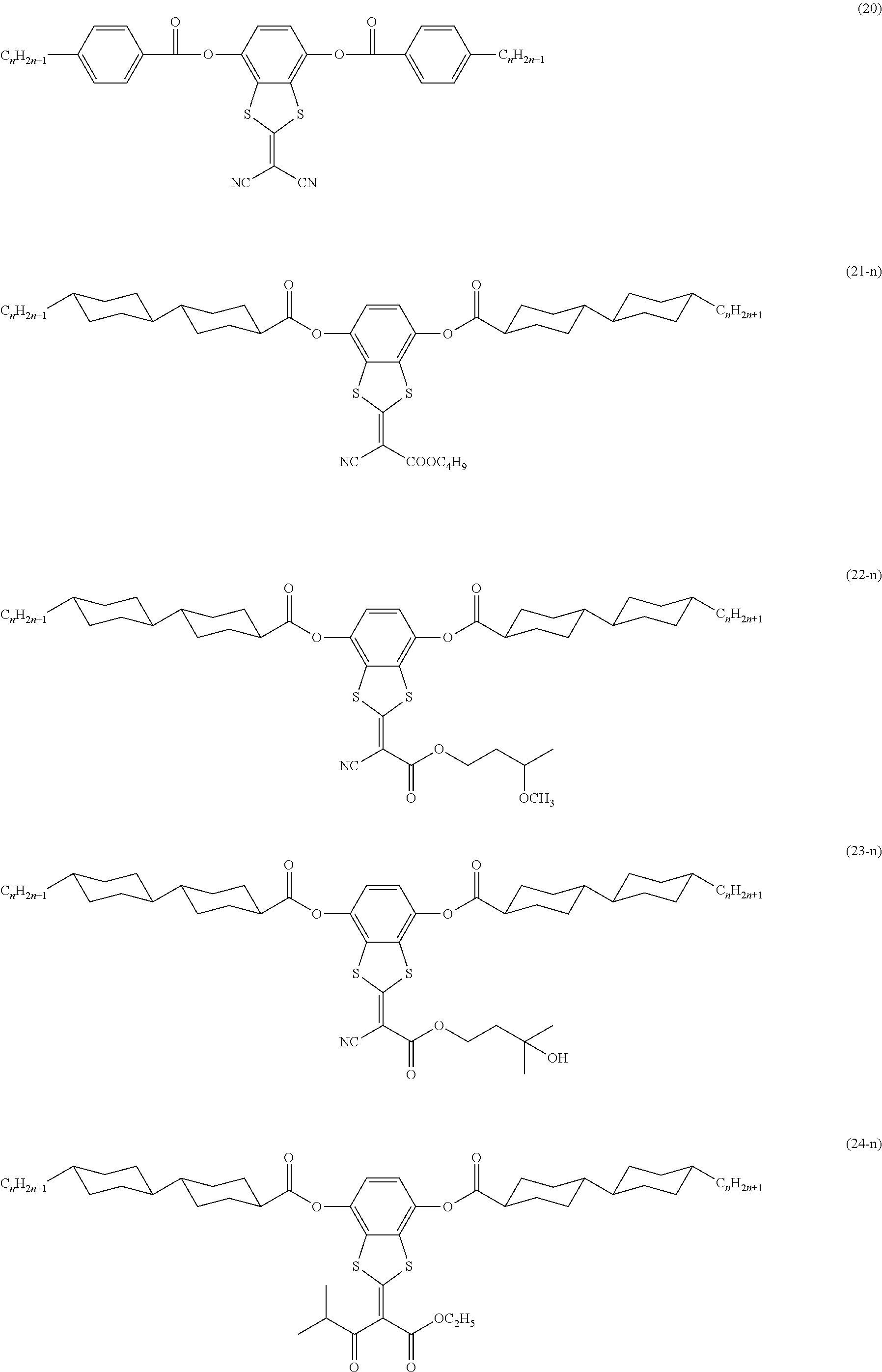

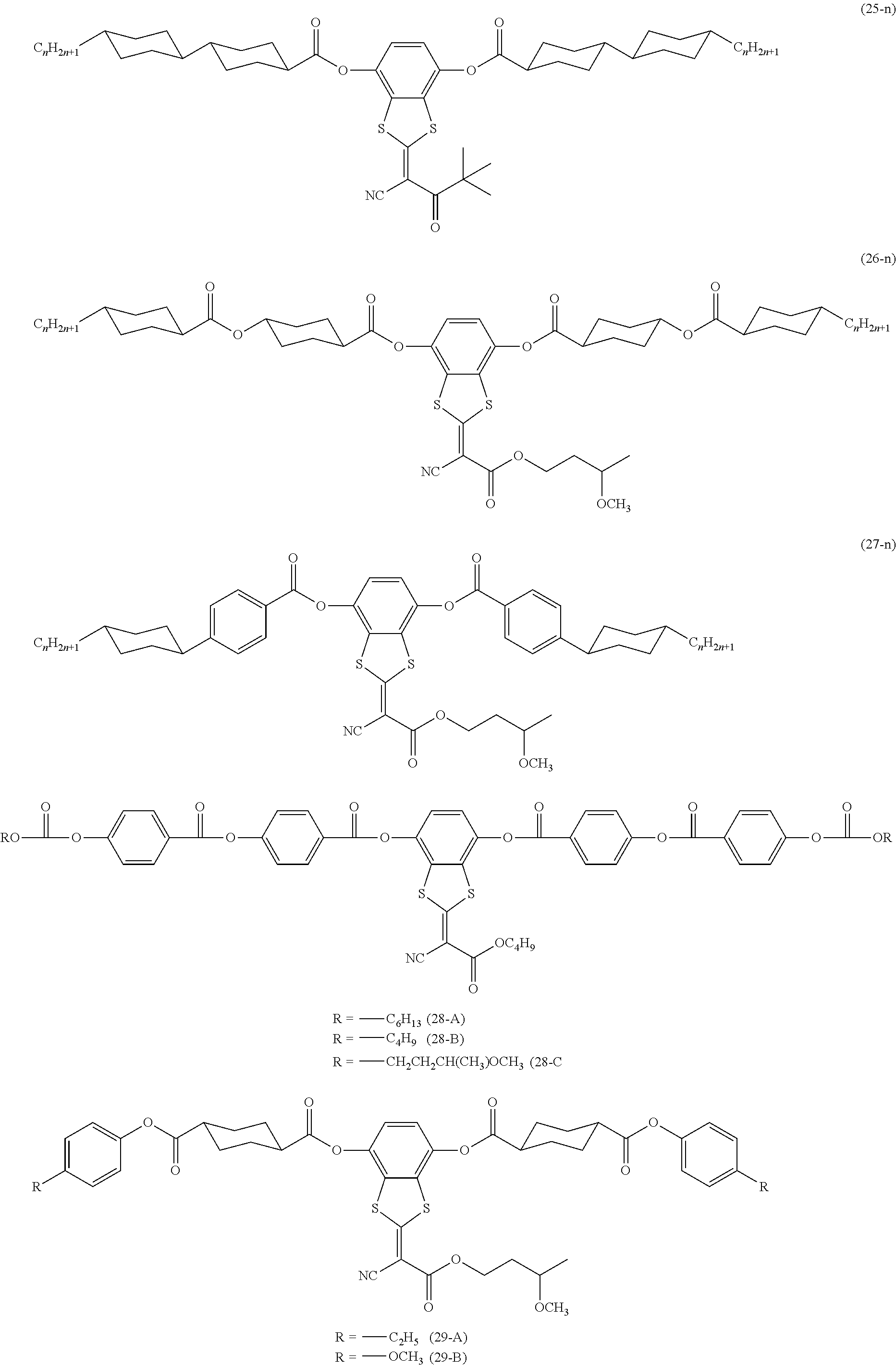

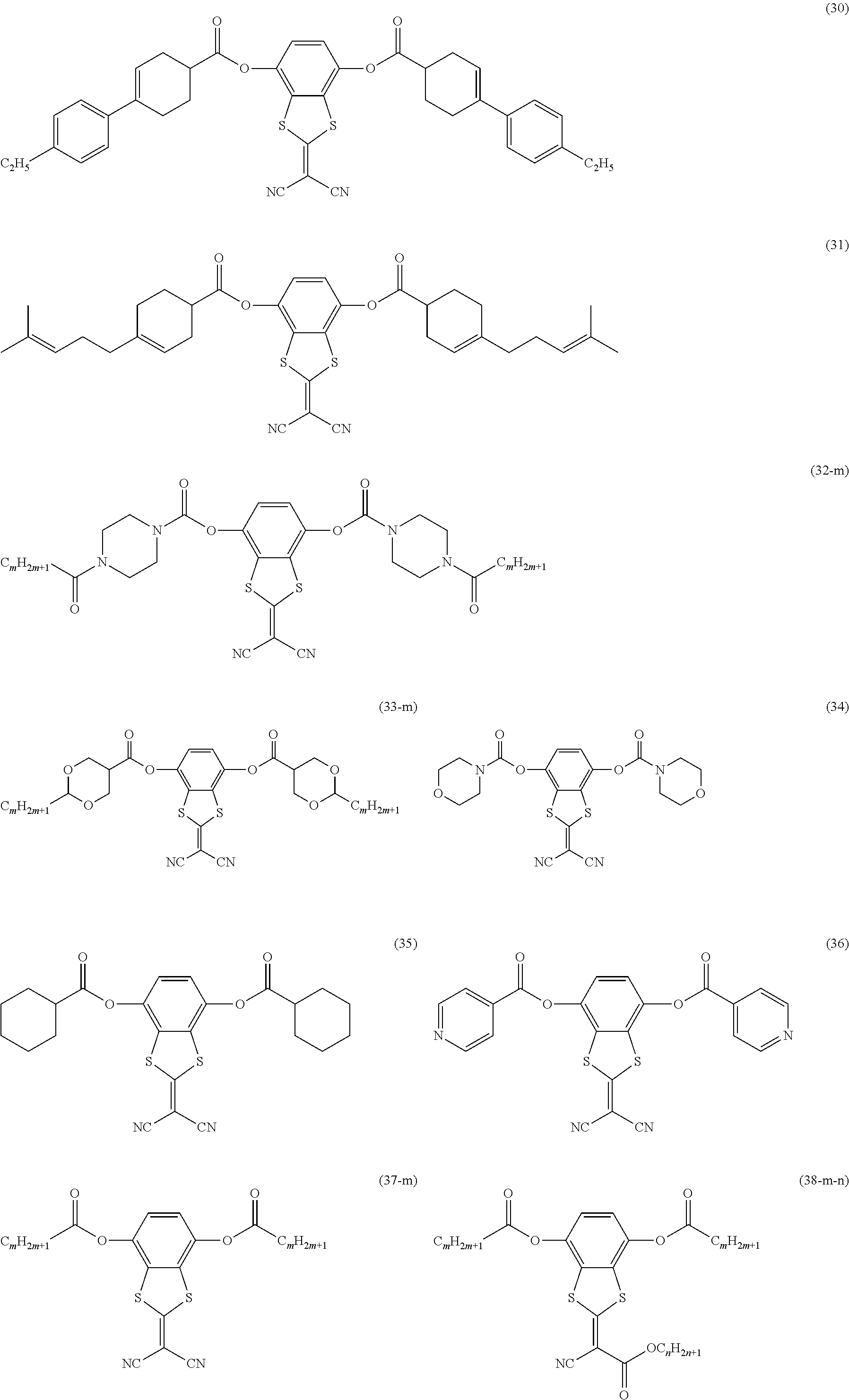

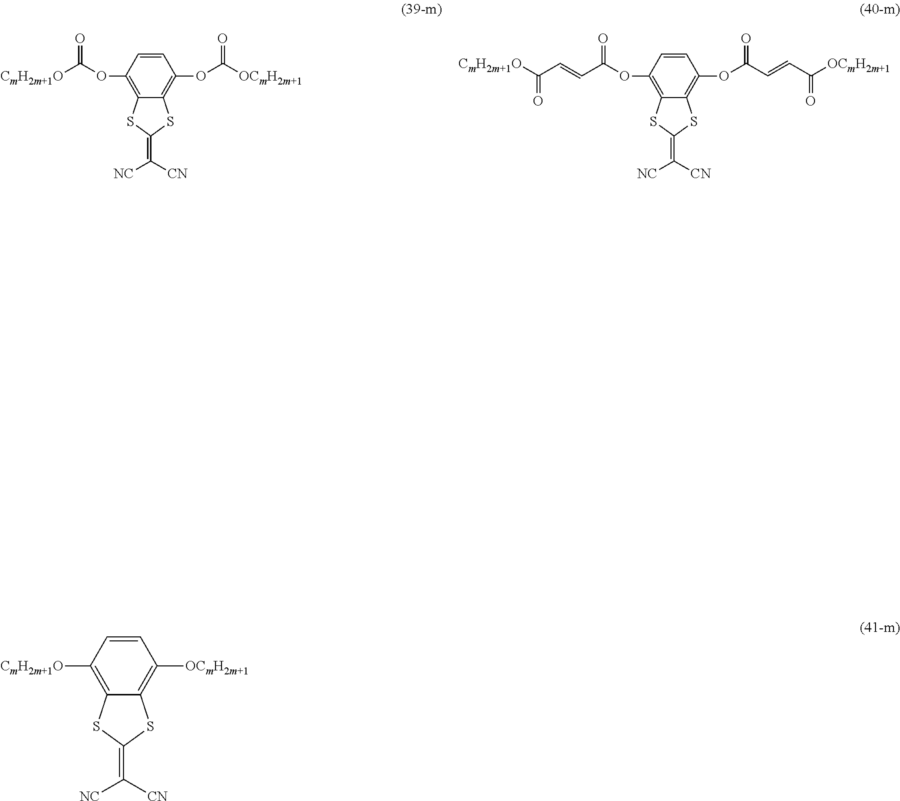

The synthesis of the compound represented by formula (A-1) can be performed by referring to a known method. For example, the compound represented by formula (A-1) can be synthesized referring to the methods described in, for example, paragraph Nos. [0066] to [0067] and [0136] to [0176] in JP-A-2008-107767. Further, intermediates of the compound represented by formula (A-1) can be synthesized referring to the methods described in, for example, J. Org. Chem., 29, p. 660-665 (1964); J. Org. Chem., 69, p. 2164-2177 (2004); Justus Liebigs Annalen der Chemie, 726, p. 103-109 (1969); and Journal of Chemical Crystallography (1997), 27(9), p. 515-526. For example, the following compound can be synthesized according to the following synthesis scheme.

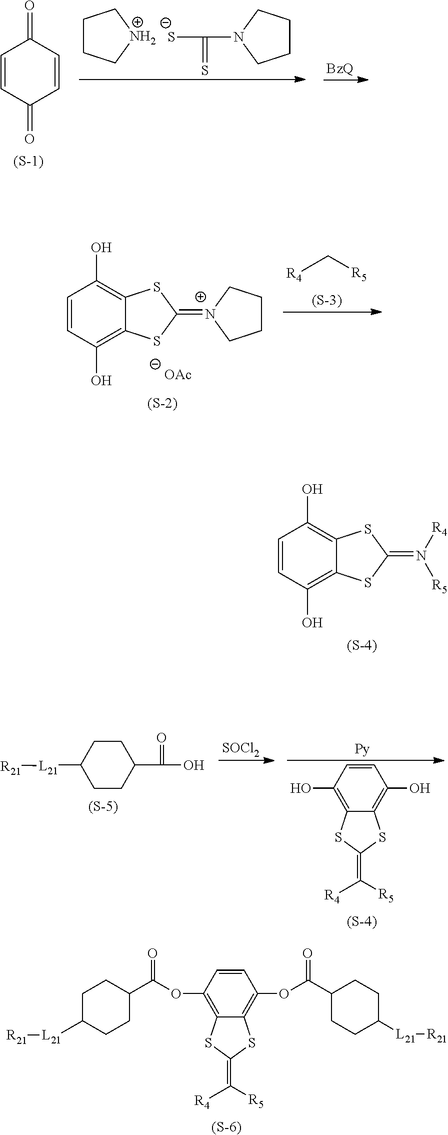

The compounds (S-1) to (S-4) can be synthesized referring to the methods described in, for example, Journal of Chemical Crystallography (1997); 27(9); p. 515-526.

Furthermore, as shown in the scheme, the compound (S-6) included in formula (A-1) can be obtained by adding N,N-dimethylformamide to a toluene solution of the compound (S-5), adding thionyl chloride, heating the mixture under stirring to thereby generate an acid chloride, subsequently adding this acid chloride dropwise to a tetrahydrofuran solution of the compound (S-4), and then adding pyridine under stirring.

Syntheses of other compounds having different substituents or linking groups for formula (A-1) can be carried out based on the method described above, by changing the compound to be used or the reaction to be carried out.

### (Ultraviolet Absorbent)

Any kind of ultraviolet absorbent can be selected according to the purpose of use, and examples of the UV absorbent that can be used include those of salicylate-series, benzophenone-series, benzotriazole-series, benzoate-series, cyanoacrylate-series, and nickel complex-series absorbents; and a benzophenone-series, benzotriazole-series, or salicylate-series UV absorbent is preferable.

It is preferable to use two or more kinds of ultraviolet absorbents having different absorption wavelength in combination, because great shielding ability can be obtained in a wide wavelength range. As the ultraviolet absorbent for liquid crystal, preferable one is a ultraviolet absorbent which is excellent in absorption ability for ultraviolet ray of wavelength 370 nm or lower, from the viewpoint of prevention of degradation of the liquid crystal, and which has less absorption of visible light of wavelength 400 nm or higher, from the viewpoint of displaying ability of the liquid crystal. Examples of the particularly preferable ultraviolet absorbent include the aforementioned benzotriazole-series compounds, benzophenone-series compounds, and salicylate-series compounds. Among these, benzotriazole-series compounds are especially preferable, because of little coloration which is unnecessary against cellulose ester.

Further, as the UV absorbent, use can also be made of any of the compounds described in JP-A-60-235852, JP-A-3-199201, JP-A-5-1907073, JP-A-5-194789, JP-A-5-271471, JP-A-6-107854, JP-A-6-118233, JP-A-6-148430, JP-A-7-11056, JP-A-7-11055, JP-A-7-11056, JP-A-8-29619, JP-A-8-239509, and JP-A-2000-204173.

The amount of the ultraviolet absorbent to be added is preferably 0.001 to 5 mass %, more preferably 0.01 to 1 mass %, to the cellulose acylate. When the amount to be added is not less than 0.001 mass %, the addition effect can be sufficiently exhibited, which is preferable, and when the amount to be added is not more than 5 mass %, the ultraviolet absorbent can be prohibited from being bleed out on the film surface, which is preferable.

### (Deterioration Preventing Agent)

The deterioration preventing agent may be added to prevent cellulose triacetate etc. from its degradation and decomposition. As the deterioration preventing agent, butyl amine, hindered amine compounds (JP-A-8-325537), guanidine compounds (JP-A-5-271471), benzotriazole-series UV absorbents (JP-A-6-235819), benzophenone-series UV absorbents (JP-A-6-118233), or the like can be used.

### (Other Plasticizer)

One or more other additives are preferably selected from phosphates, carboxylates, and fatty acid esters of polyhydric alcohol. Preferred examples of the phosphate-series plasticizer include triphenyl phosphate (TPP), tricresyl phosphate (TCP), cresyl diphenyl phosphate, octyl diphenyl phosphate, biphenyl diphenyl phosphate (BDP), trioctyl phosphate, and tributyl phosphate. Preferred examples of the carboxylate-series plasticizer include dimethyl phthalate (DMP), diethyl phthalate (DEP), dibutyl phthalate (DBP), dioctyl phthalate (DOP), diphenyl phthalate (DPP), diethyl hexyl phthalate (DEHP), triethyl O-acetylcitrate (OACTE), tributyl O-acetylcitrate (OACTB), triethyl acetyl citrate, tributyl acetyl citrate, butyl oleate, methyl acetyl ricinoleate, dibutyl sebacate, triacetin, tributyrin, butyl-phthalyl-butyl glycolate, ethyl phthalyl ethyl glycolate, methyl phthalyl ethyl glycolate, and butyl-phthalyl-butyl glycolate.

And preferred examples of the fatty acid esters of polyhydric alcohol include (di)pentaerythritol esters, glycerol esters, and diglycerol esters. Preferred examples of the carbohydrate-series plasticizer include xylose tetraacetate, glucose pentaacetate, fructose pentaacetate, mannose pentaacetate, galactose pentaacetate, maltose octaacetate, cellobiose octaacetate, sucrose octaacetate, xylitol pentaacetate, sorbitol hexaacetate, xylose tetrapropionate, glucose pentapropionate, fructose pentapropionate, mannose pentapropionate, galactose pentapropionate, maltose octapropionate, cellobiose octapropionate, sucrose octapropionate, xylitol pentapropionate, and sorbitol hexapropionate.

### (Polymer Plasticizer)

The cellulose acylate film of the invention may contain at least one polymer plasticizer along with the sterol derivative represented by formula (1), and the saccharide derivative and/or the oligomer plasticizer. Examples of the polymer plasticizer include polyester polyurethane series plasticizers, vinyl series polymers such as aliphatic hydrocarbon series polymers, alicyclic hydrocarbon series polymers, polyvinyl isobutyl ether, and poly N-vinylpyrrolidone; styrene series polymers such as polystyrene and poly 4-hydroxystyrene; polyethers such as polyethylene oxide and polypropylene oxide; polyamide, polyurethane, polyurea, phenol-formamide condensate, urea-formamide condensate and vinyl acetate.

### (Peeling Accelerator)

Examples of the peeling accelerator include ethyl esters of citric acid.

### (Infrared Absorbent)

Preferred examples of the infrared absorbent include those described in, for example, JP-A-2001-194522.

### (Dye)

In the present invention, a dye may be added, to adjust the hue of the resultant film. The amount to be added of the dye is preferably 10 to 1,000 ppm, more preferably 50 to 500 ppm, in terms of ratio by mass to the cellulose acylate. The dyes described in, for example, JP-A-5-34858 may also be used.

### (Matting Agent Fine-Particles)

It is also acceptable to add fine particles as a matting agent to the cellulose acylate solution, and to incorporate them the cellulose acylate film of the present invention. Examples of the fine particles that can be used in the present invention include silicon dioxide, titanium dioxide, aluminum oxide, zirconium oxide, calcium carbonate, talc, clay, calcined kaolin, calcined calcium silicate, hydrated calcium silicate, aluminum silicate, magnesium silicate, and calcium phosphate. The fine particles are preferably those containing silicon, from the viewpoint of obtaining low turbidity, and particularly silicon dioxide is preferable.

As the fine particles of silicon dioxide, for example, commercially available products under such trade names as Aerosil R972, R972V, R974, R812, 200, 200V, 300, R202, OX50, TT600 (manufactured by Nippon Aerosil Co., Ltd.) may be used. The fine particles of zirconium oxide are commercially available, for example, under such trade names as Aerosil R976 and R811 (manufactured by Nippon Aerosil Co., Ltd.), which may be used in the present invention.

In order to obtain a cellulose acylate film containing particles having a small secondary average particle diameter, dispersion liquid of particles may be used. various methods may be proposed to prepare a dispersion of particles. For example, a method may be employed which comprises previously preparing a particulate dispersion of particles in a solvent, stirring the particulate dispersion with a small amount of a cellulose acylate solution which has been separately prepared to make a solution, and then mixing the solution with a main cellulose acylate dope solution. This preparation method is desirable because the particulate silicon dioxide can be fairly dispersed and thus can be difficultly re-agglomerated. Besides this method, a method may be employed which comprises stirring a solution with a small amount of cellulose ester to make a solution, dispersing the solution with a particulate material using a dispersing machine to make a solution having particles incorporated therein, and then thoroughly mixing the solution having particles incorporated therein with a dope solution using an in-line mixer.

Preferred examples of the solvent which is a lower alcohol include methyl alcohol, ethyl alcohol, propyl alcohol, isopropyl alcohol, and butyl alcohol. The solvent other than lower alcohol is not specifically limited, but solvents which are used during the preparation of cellulose ester are preferably used.

### (Ratios of Compounds to be Added)

In the film obtained by using the cellulose acylate solution of the present invention, the total amount of compounds having a molecular weight of 3,000 or less is preferably 5 to 45 mass %, more preferably 10 to 40 mass %, and further preferably 15 to 30 mass %, to the mass of the cellulose acylate. These compounds include, as mentioned above, the optical-characteristic controlling agent such as compounds lowering optical anisotropy, agents for controlling wavelength dispersion, ultraviolet absorbents, plasticizers, deterioration preventing agents, peeling accelerators, dyes, matting agent fine particles, and infrared absorbents. Further, it is preferable that the total amount of compounds having molecular weights of 2,000 or less be in the above ranges. By adjusting the total amount of the compounds to 5 mass % or more, it becomes difficult to expose the nature of cellulose acylate as a single substance. For instance, the optical characteristics or physical strength of the film are hardly varied due to the change of temperature and humidity. In addition, it is preferable to adjust the total amount of those compounds to 45 mass % or less, because the amount of the compounds does not exceed the limit in which the compounds are compatible in the cellulose acylate film, and as a result, the film is prevented from being whitened or whitely turbid by precipitation of the compounds on the surface of the film (flow or bleed out from a film).

### 1-(6) Producing Method of Film:

The cellulose acylate film of the invention may be a film manufactured utilizing solution casting film formation, or may be a film manufactured utilizing solution extrusion film formation. An example of producing the cellulose acylate film utilizing solution casting film formation is hereunder described, but it should not be construed that the invention is limited thereto.

In the solution casting film formation, the film is formed by casting a solution which is prepared by dissolving the cellulose acylate, the sterol derivative represented by the foregoing formula (1) and the saccharide derivative and/or the oligomer plasticizer in an organic solvent (the thus prepared solution may also be referred to as a “dope”) on the surface of a support such as a belt and a roll, followed by drying. The film formation can be achieved utilizing a general solution casting method.

### (Preparation of Dope)

The organic solvent which is preferably used as a prime solvent to be used for the formation of a dope is preferably a solvent selected among esters, ketones and ethers each having from 3 to 12 carbon atoms and halogenated hydrocarbons having from 1 to 7 carbon atoms. The ester, ketone or ether may have a cyclic structure. Compounds having two or more of functional groups of an ester, a ketone or an ether (namely, —O—, —CO— or —COO—) can also be used as the prime solvent, and the compounds may have other functional group, for example, an alcoholic hydroxyl group. In the case of a prime solvent having two or more kinds of functional groups, its carbon atom number may fall within the specified range of the compound having any one of the functional groups.

Also, a chlorine based halogenated hydrocarbon may be used as the prime solvent, or as described in, for example, Journal of Technical Disclosure, No. 2001-1745, pages 12 to 16, 2001 by Japan Institute of Invention and Innovation, non-chlorine based solvent may be used as the prime solvent.

In addition, with respect to the preparation of the cellulose acylate solution, the solvent to be used therefor, the dissolution method thereof and so on, those disclosed in the following patent documents can be exemplified as preferred embodiments. Those patent documents include JP-A-2000-95876, JP-A-12-95877, JP-A-10-324774, JP-A-8-152514, JP-A-10-330538, JP-A-9-95538, JP-A-9-95557, JP-A-10-235664, JP-A-12-63534, JP-A-11-21379, JP-A-10-182853, JP-A-10-278056, JP-A-10-279702, JP-A-10-323853, JP-A-10-237186, JP-A-11-60807, JP-A-11-152342, JP-A-11-292988, JP-A-11-60752 and JP-A-11-60752.

Those patent documents describe not only solvents which are preferable in the invention but their solution physical properties and coexistent materials to be made to coexist, and those are also preferred embodiments in the invention.

The preparation of the cellulose acylate solution (dope) is not particularly limited with respect to its dissolution method, and it is carried out at room temperature or by means of cooling dissolution or high-temperature dissolution or a combination thereof. With respect to the preparation of the cellulose acylate solution in the invention and respective processes following the dissolution process, such as solution concentration and filtration, the producing processes described in detail in Journal of Technical Disclosure, No. 2001-1745, pages 22 to 25, issued on Mar. 15, 2001 by Japan Institute of Invention and Innovation are preferably adopted.

A degree of clearness of the dope is preferably 85% or more, more preferably 88% or more, and still more preferably 90% or more. In the invention, it was confirmed that various additives were thoroughly dissolved in the cellulose acylate dope solution. As a specific calculation method of a degree of clearness of the dope, the dope solution is injected into a glass cell of 1 cm in square, and its absorbance at 550 nm is measured by a spectrophotometer (a trade name: UV-3150, manufactured by Shimadzu Corporation). An absorbance of only the solvent is measured in advance as a blank, and the degree of clearness of the cellulose acylate solution is calculated from a ratio to the absorbance of the blank.

### (Casting, Drying and Winding Processes)

A dope (cellulose acylate solution) prepared in a dissolution machine (pot) is once stored in a storage pot, and after defoaming of bubbles contained in the dope, the dope is subjected to final preparation. Then, the dope is discharged from a dope exhaust and fed into a pressure die via, for example, a pressure constant-rate gear pump capable of feeding the dope at a constant flow rate at a high accuracy depending upon a rotational rate; the dope is uniformly cast from a nozzle (slit) of the pressure die onto a metallic support continuously running in an endless manner in the casting section; and at the peeling point where the metallic support has substantially rounded in one cycle, the half-dried dope film (also called a web) is peeled away from the metallic support. The obtained web is clipped at both ends and dried by conveying with a tenter while keeping a width. Subsequently, the obtained film is mechanically conveyed with a group of rolls in a dryer to terminate the drying and then wound in a roll form with a winder in a prescribed length. A combination of the tenter and the dryer of a group of rolls varies depending upon the purpose.

In the solution casting film formation for the film formation of a functional protective film that is an optical member for liquid crystal display device, or a film to be used for silver halide photographic material, both of which are a main application of the film of the invention, in addition to a solution casting film forming apparatus, a coating apparatus is often added for the purpose of subjecting a coating layer such as a subbing layer, an antistatic layer, an anti-halation layer and a protective layer to coating and formation (coating processing) on the surface of the film. These are described in detail in Journal of Technical Disclosure, No. 2001-1745, pages 25 to 30, issued on Mar. 15, 2001 by Japan Institute of Invention and Innovation and are classified into casting (including co-casting), metallic support, drying, releasing (peeling) and so on. Those can be preferably adopted in the invention.

### (Stretching Treatment and Contraction Treatment)

In order to allow the film having been subjected to film formation to develop desired optical characteristics, a stretching treatment and/or a contraction treatment may be carried out. In particular, in the case of allowing the cellulose acylate film to have a high retardation in-plane value, the film is positively stretched in a width direction, and it is preferable to carry out a stretching method described in, for example, JP-A-62-115035, JP-A-4-152125, JP-A-4-284211, JP-A-4-298310 and JP-A-11-48271. Stretching of the film is carried out under an ordinary temperature or heating condition. It is preferable to carry out stretching at a temperature of a glass transition temperature of the film or higher and not more than 40 degrees Celsius higher than the glass transition temperature of the film. In the case of a dry film, the stretching temperature is preferably 130 degrees Celsius or higher and not more than 200 degrees Celsius. Also, when after casting, stretching is carried out in a state where the dope solvent remains, it becomes possible to undergo stretching at a temperature lower than that in the dry film, and in that case, the stretching temperature is preferably 100 degrees Celsius or higher and not higher than 170 degrees Celsius.

Stretching of the film may be carried out by means of uniaxial stretching only in a longitudinal or lateral direction or by means of simultaneous or sequential biaxial stretching. The film is stretched in a ratio of preferably from 1 to 200%, more preferably from 1 to 100%, and still more preferably from 1 to 50%.

Also, similar to the stretching treatment, a thermal contraction treatment is useful for attaining desired optical characteristics. In particular, the thermal contraction treatment is useful for producing a high-retardation film. With respect to the thermal contraction treatment, methods described in, for example, JP-A-2006-215142, JP-A-2007-261189 and Japanese Patent No. 4228703 can be made herein by reference.

A thickness of the film of the invention after thorough drying is not particularly limited, and its preferred range varies depending upon the use purpose.

In general, the thickness of the film is preferably in the range of from about 5 to 500 μm, more preferably from 20 to 300 μm, and still more preferably from 30 to 150 μm. Also, in the case of using the film of the invention for an optical application, in particular a VA liquid crystal display device, the thickness of the film is preferably from 40 to 110 μm. With respect to the adjustment of the film thickness, a concentration of solids contained in the dope, a slit space of a nozzle of the die, an extrusion pressure from the die, a rate of the metallic support and so on may be adjusted so as to obtain desired thickness.

### (Surface Treatment)

If desired, the cellulose acylate film of the invention may be subjected to a surface treatment. By undergoing the surface treatment, an enhancement of adhesion of the cellulose acylate film to each of the functional layers (for example, an undercoat layer and a backing layer) can be achieved. For example, a glow discharge treatment, an ultraviolet ray irradiation treatment, a corona treatment, a flame treatment or an acid or alkali treatment can be adopted. Here, the glow discharge treatment may be carried out using a low-temperature plasma generated under a low-pressure gas of from 10⁻³ to 20 Torr (from 0.133 Pa to 2.67 kPa), and a plasma treatment at atmospheric pressure is also preferable. A plasma exciting gas means a gas which is subjected to plasma excitation under the foregoing condition, and examples thereof include argon, helium, neon, krypton, xenon, nitrogen, carbon dioxide, fluorocarbon such as tetrafluoromethane and mixtures thereof. Those are described in detail in Journal of Technical Disclosure, No. 2001-1745, pages 30 to 32, issued on Mar. 15, 2001 by Japan Institute of Invention and Innovation and can be preferably adopted in the invention.

### (Addition of Functional Layer)

Various functional layers may be given to the cellulose acylate film of the invention depending upon the application. Examples thereof include an antistatic layer, a curing resin layer (transparent hard coat layer), an anti-reflection layer, an easily adhesive layer, an antiglare layer, an optically compensatory layer, an alignment layer and a liquid crystal layer. Examples of materials of those functional layers which can be used in the invention include a surfactant, a lubricant and a matting agent. However, it should not be construed that the invention is limited thereto. Details are described in Journal of Technical Disclosure, No. 2001-1745, pages 32 to 45, issued on Mar. 15, 2001 by Japan Institute of Invention and Innovation and can be made herein by reference.

### 1-(7) Characteristics of Film:

An example of the cellulose acylate film of the invention is a film satisfying the following expressions (1) to (3).

Δn(550 nm)>0 (1)

1>|Δn(450 nm)/Δn(550 nm)| (2)

1<|Δn(630 nm)/Δn(550 nm)| (3)

Here, Δn is a value resulting from subtraction of a refractive index in a direction (hereinafter referred to as “MD direction”) orthogonal to an alignment direction (hereinafter referred to as “TD direction”) from a refractive index in the alignment direction. Therefore, when the wavelength dispersibility of the refractive index in the MD direction steadily diminishes (an inclination of Δn when the left is defined as the short wavelength side, and the right is defined as the long wavelength side) as compared with the wavelength dispersibility of the refractive index in the TD direction, its subtraction value satisfies the foregoing expressions (2) and (3).

When the cellulose acylate film containing at least one sterol derivative represented by the foregoing formula (1) is subjected to an alignment treatment such as a stretching treatment and a thermal contraction treatment, it becomes a film satisfying the foregoing expressions (1) to (3).

An is described in detail in, for example, Ekisho Benran (Liquid Crystal Handbook) (2000, published by Maruzen Co., Ltd.), page 201. In general, this Δn exhibits the temperature dependency. In the invention, though the measurement temperature of Δn is arbitrary, Δn in the film state is preferably measured at a fixed temperature in the range of from −20 degrees Celsius to 120 degrees Celsius.

### (Measurement of Re or Rth)

In this description, Re(λ) and Rth(λ) are retardation (nm) in plane and retardation (nm) along the thickness direction, respectively, at a wavelength of λ. Re(π) is measured by applying light having a wavelength of λ nm to a film in the normal direction of the film, using KOBRA 21ADH or WR (by Oji Scientific Instruments).

When a film to be analyzed is expressed by a monoaxial or biaxial index ellipsoid, Rth(λ) of the film is calculated as follows.

Rth(λ) is calculated by KOBRA 21ADH or WR based on six Re(λ) values which are measured for incoming light of a wavelength λ nm in six directions which are decided by a 10° step rotation from 0° to 50° with respect to the normal direction of a sample film using an in-plane slow axis, which is decided by KOBRA 21ADH, as an inclination axis (a rotation axis; defined in an arbitrary in-plane direction if the film has no slow axis in plane); a value of hypothetical mean refractive index; and a value entered as a thickness value of the film.

In the above, when the film to be analyzed has a direction in which the retardation value is zero at a certain inclination angle, around the in-plane slow axis from the normal direction as the rotation axis, then the retardation value at the inclination angle larger than the inclination angle to give a zero retardation is changed to negative data, and then the Rth(λ) of the film is calculated by KOBRA 21ADH or WR.

Around the slow axis as the inclination angle (rotation angle) of the film (when the film does not have a slow axis, then its rotation axis may be in any in-plane direction of the film), the retardation values are measured in any desired inclined two directions, and based on the data, and the estimated value of the mean refractive index and the inputted film thickness value, Rth may be calculated according to formulae (21) and (22):

$$\begin{matrix}Re ( θ ) = [ nx - \frac{ny \times nz}{\sqrt{{\{ ny sin ( {sin}^{- 1} ( \frac{sin ( - θ )}{nx} ) ) \}}^{2} + {\{ nz cos ( {sin}^{- 1} ( \frac{sin ( - θ )}{nx} ) ) \}}^{2}}} ] \times \frac{d}{cos \{ {sin}^{- 1} ( \frac{sin ( - θ )}{nx} ) \}} & ( 21 ) \\ Rth = ( \frac{nx + ny}{2} - nz ) \times d & ( 22 )\end{matrix}$$

Re(θ) represents a retardation value in the direction inclined by an angle θ from the normal direction; nx represents a refractive index in the in-plane slow axis direction; ny represents a refractive index in the in-plane direction perpendicular to nx; and nz represents a refractive index in the direction perpendicular to nx and ny. And “d” is a thickness of the film.

When the film to be analyzed is not expressed by a monoaxial or biaxial index ellipsoid, or that is, when the film does not have an optical axis, then Rth(λ) of the film may be calculated as follows:

Re(λ) of the film is measured around the slow axis (judged by KOBRA 21ADH or WR) as the in-plane inclination axis (rotation axis), relative to the normal direction of the film from −50 degrees up to +50 degrees at intervals of 10 degrees, in 11 points in all with a light having a wavelength of λ nm applied in the inclined direction; and based on the thus-measured retardation values, the estimated value of the mean refractive index and the inputted film thickness value, Rth(λ) of the film may be calculated by KOBRA 21ADH or WR.

In the above-described measurement, the hypothetical value of mean refractive index is available from values listed in catalogues of various optical films in Polymer Handbook (John Wiley & Sons, Inc.). Those having the mean refractive indices unknown can be measured using an Abbe refract meter. Mean refractive indices of some main optical films are listed below:

cellulose acylate (1.48), cycloolefin polymer (1.52), polycarbonate (1.59), polymethylmethacrylate (1.49) and polystyrene (1.59).

KOBRA 21ADH or WR calculates nx, ny and nz, upon enter of the hypothetical values of these mean refractive indices and the film thickness. On the basis of thus-calculated nx, ny and nz, Nz=(nx-nz)/(nx-ny) is further calculated.

In the description, the measurement wavelength for Re or Rth is λ=550 nm in the visible light region, unless otherwise specifically noted. And in the description, the numerical data, the numerical range and the qualitative expression (for example, “equivalent”, “same”, etc.) indicating the optical characteristics should be so interpreted as to indicate the numerical data, the numerical range and the qualitative expression that include the error range generally acceptable for liquid-crystal display devices and their component parts.

What an Re (λ) value and an Rth (λ) value satisfy the following numerical expressions (5) and (6), respectively is preferable for the purpose of widening a viewing angle of a liquid crystal display device, especially a VA mode or OCB mode liquid crystal display device. Also, in particular, such is preferable in the case where the cellulose acylate film is used as a protective film on the side of a liquid crystal cell of polarizing plate.

0 nm≦Re(590)≦200 nm (5)

0 nm≦Rth(590)≦400 nm (6)

In the foregoing numerical expressions, each of Re (590) and Rth (590) is a value (unit: nm) at a wavelength λ of 590 nm.

It is more preferable that the following numerical expressions (5-1) and (6-1) are satisfied.

30 nm≦Re(590)≦150 nm (5-1)

30 nm≦Rth(590)≦300 nm (6-1)

In the foregoing numerical expressions, Re (590) and Rth (590) are synonymous with those in the numerical expressions (5) and (6), respectively.

In the case of using the cellulose acylate film of the invention for a VA mode or an OCB mode, there are included two ways of a form in which one sheet is used on each side of the cell, namely two sheets are used (two-sheet type); and a form in which one sheet is used on either one side of the top or bottom of the cell (one-sheet type).

In the case of a two-type type, the Re (590) is preferably from 20 to 100 nm, and more preferably from 30 to 70 nm; and the Rth (590) is preferably from 70 to 300 nm, and more preferably from 100 to 200 nm.

In the case of a one-sheet type, the Re (590) is preferably from 30 to 150 nm, and more preferably from 40 to 100 nm; and the Rth (590) is preferably from 100 to 300 nm, and more preferably from 150 to 250 nm.

### (Moisture Permeability of Film)

A moisture permeability of the cellulose acylate film of the invention is preferably 400 to 2,000 g/m²·24 h, more preferably from 500 to 1,800 g/m²·24 h, and especially preferably from 600 to 1,600 g/m²·24 h as converted into a film thickness of 80 μm upon being measured under a condition at a temperature of 60 degrees Celsius and a humidity of 95% RH (relative humidity) according to JIS Z0208 of the JIS standards.

With respect to the measurement method of the moisture permeability, a method described in Physical Properties II of Polymers (Course 4 of Polymer Experiments), published by Kyoritsu Shuppan Co., Ltd., pages 285 to 294, “Measurement of Vapor Permeation Amount (Mass Method, Thermometer Method, Vapor Pressure Method and Adsorption Amount Method)” can be applied. A sample (70 mmφ) of the cellulose acylate film of the invention is humidified at 25 degrees Celsius and 90% RH and at 60 degrees Celsius and 95% RH, respectively for 24 hours, and a water content per unit area (g/m²) is calculated using a moisture permeability tester (a trade name: KK-709007, manufactured by Toyo Seiki Seisaku-sho, Ltd.) according to JIS Z0208. The moisture permeability is determined according to the following expression.

(Moisture permeability)=(Mass after humidification)−(Mass before humidification)

### (Residual Solvent Amount of Film)

In the invention, it is preferable to perform drying under a condition at which a residual solvent amount in the cellulose acylate film falls within the range of from 0.01 to 1.5% by mass. The residual solvent amount in the cellulose acylate film is more preferably from 0.01 to 1.0% by mass. In the case of using the cellulose acylate film of the invention for a support, by allowing the residual solvent amount to fall within the foregoing ranges, curl can be more inhibited. It may be considered that it is a major factor of the effect that the free volume becomes small by decreasing the residual solvent amount at the time of film formation by means of the foregoing solvent casting method.

### (Coefficient of Hygroscopic Swelling of Film)

A coefficient of hygroscopic swelling of the cellulose acylate film of the invention is preferably not more than 30×10⁻⁵% RH, more preferably not more than 15×10⁻⁵% RH, and still more preferably not more than 10×10⁻⁵% RH. Also, though a lower limit value thereof is not particularly specified, and there is a tendency that a small coefficient of hygroscopic swelling of the cellulose acylate film of the invention is preferable, the coefficient of hygroscopic swelling is more preferably a value of 1.0×10⁻⁵% RH or more. The coefficient of hygroscopic swelling means an amount of change in length of a sample at the time of changing the relative humidity at a fixed temperature. By adjusting this coefficient of hygroscopic swelling, when the cellulose acylate film of the invention is used for an optically compensatory film support, a frame-shaped increase in the transmittance, namely light leakage due to a strain can be prevented while keeping the optically compensatory function of the optically compensatory film.

### 2. Application of Cellulose Acylate Film of the Invention:

The cellulose acylate film of the invention can be used for various applications. The cellulose acylate film of the invention can be utilized for, for example, a retardation film (hereinafter also referred to as an “optically compensatory film” or a “retarder”) of liquid crystal display device or a protective film of polarizing plate.

### 2-(1) Retardation Film:

The cellulose acylate film of the invention can be used as a retardation film. In this connection, the “retardation film” or “optically compensatory film” as referred to herein means an optical material which is in general used for display devices such as liquid crystal display devices and which has optical anisotropy, and it is synonymous with an optically compensatory sheet or the like. In the liquid crystal display device, the optically compensatory film is used for the purpose of enhancing the contrast of display screen or improving a viewing angle characteristic or tint.

Also, the cellulose acylate film of the invention can be used as an optically compensatory film by laminating a plurality of the cellulose acylate films of the invention, or laminating the cellulose acylate film of the invention with a film falling outside the scope of the invention, thereby properly adjusting the Re or Rth. The lamination of films can be carried out using a binder or an adhesive.

### 2-(2) Polarizing Plate:

The cellulose acylate film of the invention can be used as a protective film of polarizing plate (the polarizing plate of the invention). An example of the polarizing plate of the invention is composed of a polarizing film and two polarizing plate protective films (transparent films), each of which protects each surface of the polarizing film, and includes the cellulose acylate film of the invention as at least one of the polarizing plate protective films.

With respect to an embodiment in which the cellulose acylate film of the invention is utilized as a support, and an optically anisotropic layer composed of a liquid crystal composition is provided on the surface thereof, in the case of utilizing the cellulose acrylate film of the invention as the protective film of the polarizing plate, it is preferable that the back surface (the surface on the side on which the optically anisotropic layer is not formed) of the cellulose acylate film of the invention that is the support is stuck on the surface of the polarizing film.

In the case of using the cellulose acylate film of the invention as the protective film of the polarizing plate, it is preferable to previously hydrophilize the cellulose acylate film of the invention upon being subjected to the foregoing surface treatment (also described in JP-A-6-94915 and JP-A-6-118232). It is preferable to apply, for example, a glow discharge treatment, a corona discharge treatment or an alkali saponification treatment. In particular, when the cellulose acylate constituting the cellulose acylate film of the invention is a cellulose acylate, the alkali saponification treatment is most preferably adopted as the surface treatment.

Also, for example, a film obtained by dipping a polyvinyl alcohol film in an iodine solution and stretching it or the like can be used as the polarizing film. In the case of using the polarizing film obtained by dipping a polyvinyl alcohol film in an iodine solution and stretching it, the surface-treated surface of the transparent cellulose acylate film of the invention can be stuck directly onto the both surfaces of the polarizing film using an adhesive. It is preferable that the cellulose acylate film is stuck directly onto the polarizing film. An aqueous solution of polyvinyl alcohol or a polyvinyl acetal (for example, polyvinyl butyral) or a latex of a vinyl based polymer (for example, polybutyl acrylate) can be used as the adhesive. The adhesive is especially preferably an aqueous solution of fully saponified polyvinyl alcohol.

In general, a liquid crystal display device has four polarizing protective films because a liquid crystal cell is provided between two polarizing plates. Though the cellulose acylate film of the invention may be used for any of the four polarizing plate protective films, the cellulose acylate film of the invention is especially useful as a protective film which is disposed between a polarizing film and a liquid crystal layer (liquid crystal cell) in the liquid crystal display device. Also, the protective film to be disposed on the opposite side of the cellulose acylate film of the invention sandwiching the polarizing film can be provided with a transparent hard coat layer, an antiglare layer, an anti-reflection layer or the like, and in particular, it is preferably used as a protective film of a polarizing plate on the outermost surface on the display side of the liquid crystal display device.

### 2-(3) Hard Coat Film, Antiglare Film and Anti-Reflection Film:

The cellulose acylate film of the invention may be applied to a hard coat film, an antiglare film or an anti-reflection film. For the purpose of enhancing the visibility of a flat panel display of LCD, PDP, CRT, EL or the like, the transparent cellulose acylate film of the invention can be used as the functional film upon being given with any one or all of a hard coat layer, an antiglare layer and an anti-reflection layer on one or both surfaces thereof. Desirable embodiments as such an antiglare film or antireflection film are described in detail in Journal of Technical Disclosure, No. 2001-1745, pages 54 to 57, issued on Mar. 15, 2001 by Japan Institute of Invention and Innovation, and those can be preferably adopted in the cellulose acylate film of the invention.

### 3. Liquid Crystal Display Device:

The invention is also concerned with a cellulose acylate film of the invention, an optically compensatory film or a liquid crystal display device having a polarizing plate, each of which utilizes the cellulose acylate film of the invention. The cellulose acylate film of the invention or the like can be used for liquid crystal display devices of various display modes, and specifically, it can be used for liquid crystal displays of TN (twisted nematic), IPS (in-plane switching), FLC (ferroelectric liquid crystal), AFLC (anti-ferroelectric liquid crystal), OCB (optically compensatory bend), STN (super twisted nematic), ECB (electrically controlled birefringence), VA (vertically aligned) and HAN (hybrid aligned nematic) modes and so on. Among those modes, the cellulose acylate film of the invention and the optically compensatory film and polarizing plate each utilizing the same are especially preferably used for liquid crystal display devices of a VA mode. Such a liquid crystal display device may be any of a transmission type, a reflection type or a semi-transmission type.

### EXAMPLES

The present invention will be explained to further detail, referring to Examples. Note that the materials, reagents, amounts and ratios of substances, operations and so forth explained in Examples below may appropriately be modified without departing from the spirit of the present invention. The scope of the present invention is, therefore, not limited to the specific examples described below.

### 1. Preparation of Sterol Derivative Represented by the Formula (1)

### Synthesis Example 1

### Synthesis Example of Illustrative Compound B-C4

A 100-mL three-necked flask was charged with toluene (20 mL), pyridine (0.8 mL, 9.88 mmoles) and butanol (0.82 mL, 8.9 mmoles), and the mixture was stirred at room temperature for 10 minutes. Thereafter, the reaction solution was decreased to 0 degree Celsius, and a toluene solution (10 mL) of cholesterol chloroformate (4 g, 8.9 mmoles) was added dropwise thereto over 5 minutes. After stirring the mixture for one hour, hexane and water were added dropwise thereto to terminate the reaction. After removing a water phase by a dropping funnel, an organic phase was concentrated and recrystallized from methanol to obtain 3.91 g (96%) of Illustrative Compound B-C4.

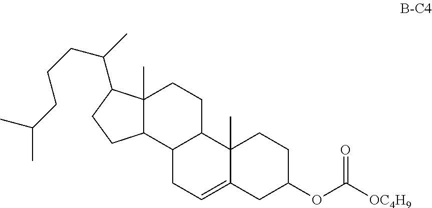

The obtained compound was identified by means of ¹H NMR. The results are shown below.

¹H NMR (300 MHz, CDCl₃) (96%): 5.40 (d, 1H), 4.57 to 4.52 (m, 1H), 4.12 (t, 2H), 2.47 to 2.3 (m, 2H), 2.05 to 0.85 (45H), 0.68 (s, 3H)

### Synthesis Example 2

### Synthesis Example of Illustrative Compound B-C3

Illustrative Compound B-C3 was synthesized by allowing the reaction to proceed in the same manner as in the foregoing Synthesis Example 1, except for changing the butanol to propanol. A yield was 92%.

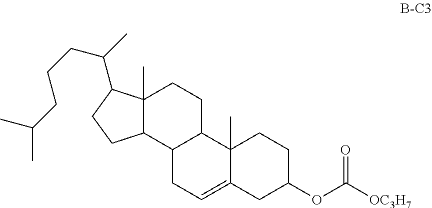

The obtained compound was identified by means of ¹H NMR. The results are shown below.

¹H NMR (300 MHz, CDCl₃) (92%): 5.40 (d, 1H), 4.57 to 4.52 (m, 1H), 4.12 (t, 2H), 2.47 to 2.3 (m, 2H), 2.05 to 0.85 (43H), 0.68 (s, 3H)

### Synthesis Example 3

### Synthesis Example of Illustrative Compound B-C7

Illustrative Compound B-C7 was synthesized by allowing the reaction to proceed in the same manner as in the foregoing Synthesis Example 1, except for changing the butanol to heptanol. A yield was 95%.

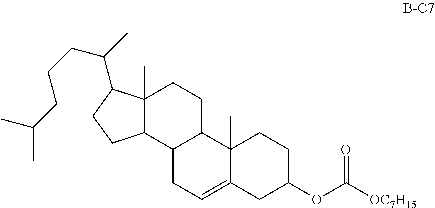

The obtained compound was identified by means of ¹H NMR. The results are shown below.

¹H NMR (300 MHz, CDCl₃): 5.40 (d, 1H), 4.57 to 4.52 (m, 1H), 4.12 (t, 2H), 2.47 to 2.3 (m, 2H), 2.05 to 0.85 (44H), 0.68 (s, 3H)

### Synthesis Example 4

### Synthesis Example of Illustrative Compound B-2

Illustrative Compound B-2 was synthesized by allowing the reaction to proceed in the same manner as in the foregoing Synthesis Example 1, except for changing the butanol to 2-ethoxyethanol. A yield was 94%.

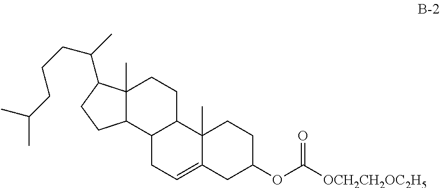

The obtained compound was identified by means of ¹H NMR. The results are shown below.

¹H NMR (300 MHz, CDCl₃): 5.39 (d, 1H), 4.53 to 4.43 (m, 1H), 4.28 to 4.25 (m, 2H), 3.67 to 3.65 (m, 1H), 3.53 (q, 2H), 3.32 (s, 3H), 2.45 to 2.3 (3H), 2.05 to 0.85 (m, 38H), 0.68 (s, 3H)

### Synthesis Example 5

### Synthesis Example of Illustrative Compound B-1

Illustrative Compound B-1 was synthesized by allowing the reaction to proceed in the same manner as in the foregoing Synthesis Example 1, except for changing the butanol to 1,2-ethanediol. A yield was 92%.

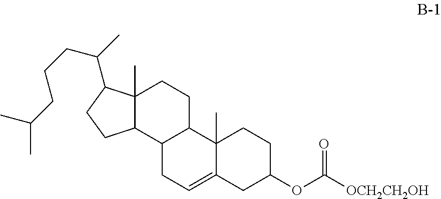

The obtained compound was identified by means of ¹H NMR. The results are shown below.

¹H NMR (300 MHz, CDCl₃): 7.99 to 7.95 (m, 1H), 7.9 to 7.86 (m, 1H), 7.75 (d, 1H), 7.56 to 7.44 (m, 3H), 7.37 to 7.34 (m, 1H), 5.42 (d, 1H), 4.68 to 4.57 (m, 1H), 2.6 to 2.5 (m, 3H), 2.05 to 0.85 (m, 37H), 0.68 (s, 3H)

With respect to the following Illustrative Compounds A-C8 and A-Ph, commercially available products (manufactured by Tokyo Chemical Industry Co., Ltd.) were used.

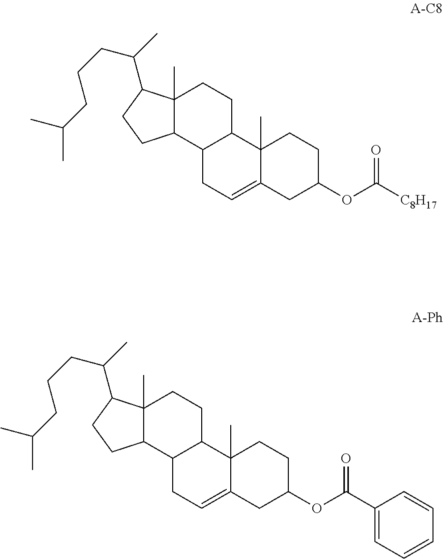

### Synthesis Example 6

### Synthesis Example of Illustrative Compound A-C3

A 100-mL three-necked flask was charged with a tetrahydrofuran solution (20 mL), cholesterol (4 g, 10.3 mmoles) and pyridine (1.0 mL, 12.4 mmoles), and the mixture was stirred at room temperature for 10 minutes. The reaction solution was decreased to 0 degree Celsius, and butyrl chloride (1.28 mL, 12.4 mmoles) was added dropwise thereto over 5 minutes. The temperature was increased to room temperature, and stirring was carried out for one hour. Thereafter, hexane and water were added dropwise thereto to terminate the reaction. After removing a water phase by a dropping funnel, an organic phase was concentrated and recrystallized from methanol to obtain 4.24 g (96%) of Illustrative Compound A-C3.

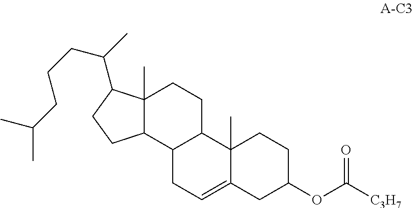

The obtained compound was identified by means of ¹H NMR. The results are shown below.

¹H NMR (300 MHz, CDCl₃): 5.40 (d, 1H), 4.57 to 4.52 (m, 1H), 4.12 (t, 2H), 2.47 to 2.3 (m, 2H), 2.04 to 0.85 (m, 48H), 0.68 (s, 3H)

### Synthesis Example 7

### Synthesis Example of Illustrative Compound A-C7

Illustrative Compound A-C7 was synthesized by allowing the reaction to proceed in the same manner as in the foregoing Synthesis Example 6, except for changing the butyrl chloride to octanoyl chloride. A yield was 95%.

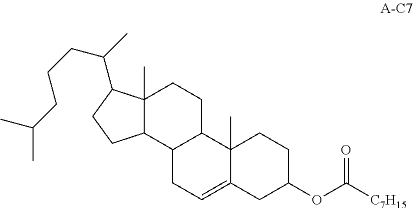

The obtained compound was identified by means of ¹H NMR. The results are shown below.

¹H NMR (300 MHz, CDCl₃): 5.40 (d, 1H), 4.57 to 4.52 (m, 1H), 4.12 (t, 2H), 2.47 to 2.3 (m, 2H), 2.05 to 0.85 (51H), 0.68 (s, 3H)

### Synthesis Example 8

### Synthesis Example of Illustrative Compound B-3

Illustrative Compound B-3 was synthesized by allowing the reaction to proceed in the same manner as in the foregoing Synthesis Example 1, except for changing the butanol to p-methoxyphenol. A yield was 90%.

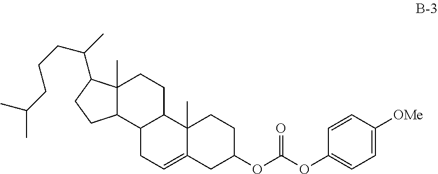

The obtained compound was identified by means of ¹H NMR. The results are shown below.

¹H NMR (300 MHz, CDCl₃): 8.0 (d, 2H), 6.88 (d, 2H), 5.40 (d, 1H), 4.9 to 4.75 (m, 1H), 3.85 (s, 3H), 2.5 to 2.4 (m, 2H), 2.05 to 0.85 (38H), 0.68 (s, 3H)

### Synthesis Example 9

### Synthesis Example of Illustrative Compound A-4

Illustrative Compound A-4 was synthesized by allowing the reaction to proceed in the same manner as in the foregoing Synthesis Example 1, except for changing the butanol to p-cyanobenzoic acid. A yield was 89%.

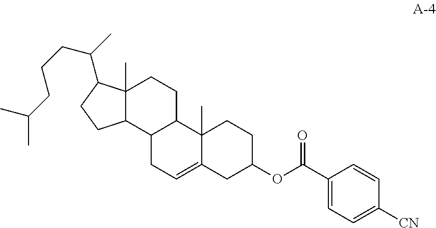

The obtained compound was identified by means of ¹H NMR. The results are shown below.

¹H NMR (300 MHz, CDCl₃): 8.1 (d, 2H), 7.7 (d, 2H), 5.42 (d, 1H), 4.9 to 4.75 (m, 1H), 2.45 (d, 2H), 2.05 to 0.85 (38H), 0.68 (s, 3H)

### Synthesis Example 10

### Synthesis Example of Illustrative Compound A-7

Illustrative Compound A-7 was synthesized by allowing the reaction to proceed in the same manner as in the foregoing Synthesis Example 6, except for changing the butyrl chloride to 1-naphthoyl chloride. A yield was 90%.

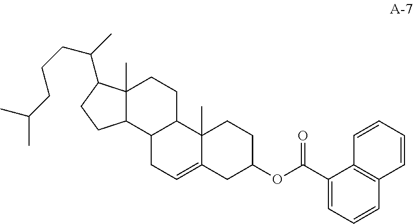

The obtained compound was identified by means of ¹H NMR. The results are shown below.

¹H NMR (300 MHz, CDCl₃): 8.9 (d, 1H), 8.15 (d, 1H), 8.0 (d, 1H), 7.85 (d, 1H), 7.62 to 7.45 (m, 3H), 5.47 (d, 1H), 5.02 to 4.92 (m, 1H), 2.6 to 2.5 (m, 2H), 2.1 to 0.85 (38H), 0.68 (s, 3H)

### Synthesis Example 11

### Synthesis Example of Illustrative Compound A-9

Illustrative Compound A-9 was synthesized by allowing the reaction to proceed in the same manner as in the foregoing Synthesis Example 6, except for changing the butyrl chloride to 2-naphthoyl chloride. A yield was 89%.

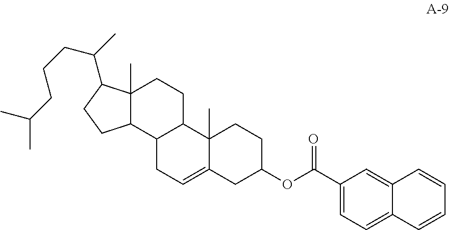

The obtained compound was identified by means of ¹H NMR. The results are shown below.

¹H NMR (300 MHz, CDCl₃): 8.6 (d, 1H), 8.1 to 7.87 (m, 4H), 7.62 to 7.5 (m, 2H), 5.45 (d, 1H), 5.02 to 4.88 (m, 1H), 2.6 to 2.5 (m, 2H), 2.1 to 0.85 (28H), 0.68 (s, 3H)

### Synthesis Example 12

### Synthesis Example of Illustrative Compound A-8

Illustrative Compound A-8 was synthesized by allowing the reaction to proceed in the same manner as in the foregoing Synthesis Example 6, except for changing the butyrl chloride to 3,4,5-trimethoxybenzoyl chloride. A yield was 94%.

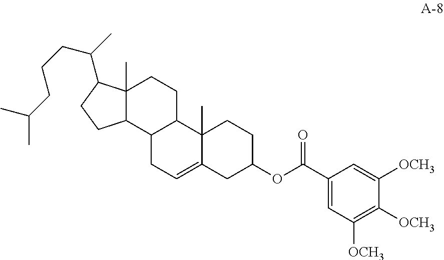

The obtained compound was identified by means of ¹H NMR. The results are shown below.

¹H NMR (300 MHz, CDCl₃): 7.28 (d, 2H), 5.45 (d, 1H), 4.88 to 4.79 (m, 1H), 3.89 (d, 9H), 2.5 to 2.46 (m, 2H), 2.05 to 0.85 (38H), 0.68 (s, 3H)

### Synthesis Example 13

### Synthesis Example of Illustrative Compound A-6

Illustrative Compound A-6 was synthesized by allowing the reaction to proceed in the same manner as in the foregoing Synthesis Example 6, except for changing the butyrl chloride to isonicotinoyl chloride. A yield was 90%.

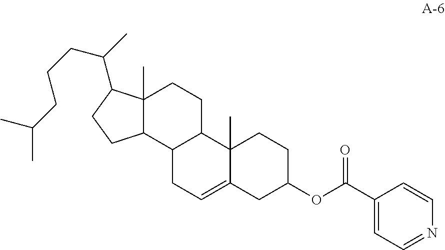

The obtained compound was identified by means of ¹H NMR. The results are shown below.

¹H NMR (300 MHz, CDCl₃): 8.74 (d, 2H), 7.81 (d, 2H), 5.45 (d, 1H), 2.5 to 2.46 (m, 2H), 2.05 to 0.85 (39H), 0.68 (s, 3H)

### Synthesis Example 14

### Synthesis Example of Illustrative Compound C-Ph1

A 100-mL three-necked flask was charged with a toluene solution (20 mL), 2-methoxy-5-nitroaniline (1.646 g, 9.8 mmoles) and pyridine (0.8 mL, 9.9 mmoles), and the mixture was stirred at room temperature for 10 minutes. The reaction solution was decreased to 0 degree Celsius, and cholesterol chloroformate (4 g, 8.9 mmoles) was added dropwise thereto over 5 minutes. The temperature was increased to room temperature, and stirring was carried out for one hour, followed by decantation. The obtained solid was washed with water and methanol and then dissolved in methylene chloride. Methanol was added dropwise to this solution to deposit a crystal, thereby obtaining 4.4 g (90%) of Illustrative Compound C-Ph1.

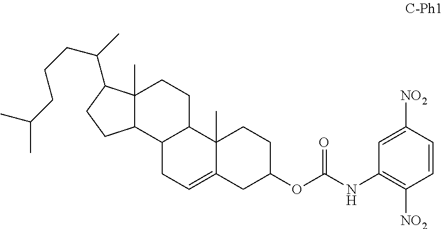

The obtained compound was identified by means of ¹H NMR. The results are shown below.

¹H NMR (300 MHz, CDCl₃): 9.0 (1H), 7.94 (d, 1H), 7.27 (d, 1H), 6.89 (d, 1H), 5.42 (d, 1H), 4.72 to 4.57 (m, 1H), 4.12 (s, 3H), 2.47 to 2.3 (m, 2H), 2.05 to 0.85 (38H), 0.68 (s, 3H)

### Synthesis Example 15

### Synthesis Example of Illustrative Compound C-Ph2

Illustrative Compound C-Ph2 was synthesized by allowing the reaction to proceed in the same manner as in the foregoing Synthesis Example 14, except for changing the 2-methoxy-5-nitroaniline to p-methoxyaniline. A yield was 89%.

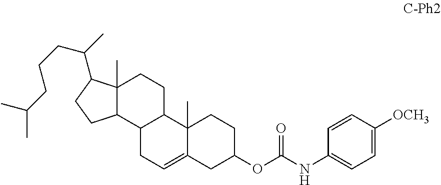

The obtained compound was identified by means of ¹H NMR. The results are shown below.

¹H NMR (300 MHz, CDCl₃): 7.3 to 7.2 (m, 2H), 6.88 to 6.8 (2H), 6.6 to 6.5 (d, 1H), 5.38 (d, 1H), 4.72 to 4.57 (m, 1H), 3.78 (s, 3H), 2.47 to 2.3 (m, 2H), 2.05 to 0.85 (38H), 0.68 (s, 3H)

### Synthesis Example 16

### Synthesis Example of Illustrative Compound C-Ph

Illustrative Compound C-Ph was synthesized by allowing the reaction to proceed in the same manner as in the foregoing Synthesis Example 14, except for changing the 2-methoxy-5-nitroaniline to aniline. A yield was 91%.

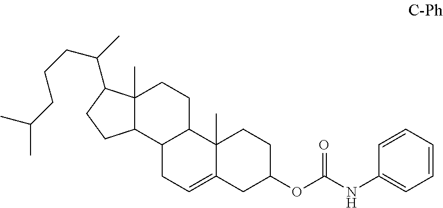

The obtained compound was identified by means of ¹H NMR. The results are shown below.

¹H NMR (300 MHz, CDCl₃): 7.4 to 7.2 (m, 4H), 7.0 (t, 2H), 6.55 (s, 1H), 5.42 to 5.35 (1H), 4.64 to 4.48 (m, 1H), 3.78 (s, 3H), 2.47 to 2.3 (m, 2H), 2.05 to 0.85 (34H), 0.68 (s, 3H)

### 2. Fabrication and Evaluation of Cellulose Acylate Film

Cellulose acylate films were fabricated and evaluated by methods as described later.

Structures of used plasticizers and additives are shown below.

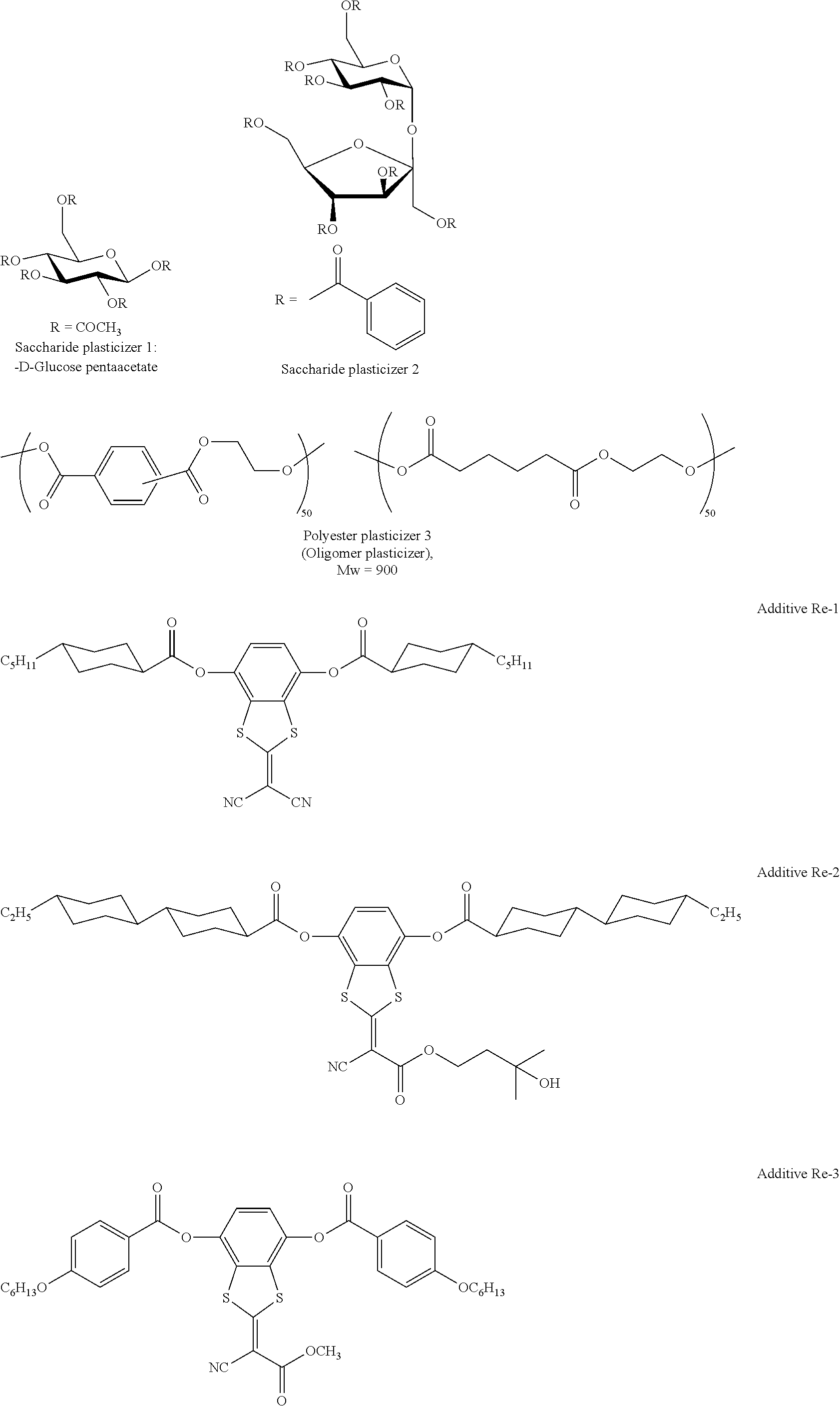

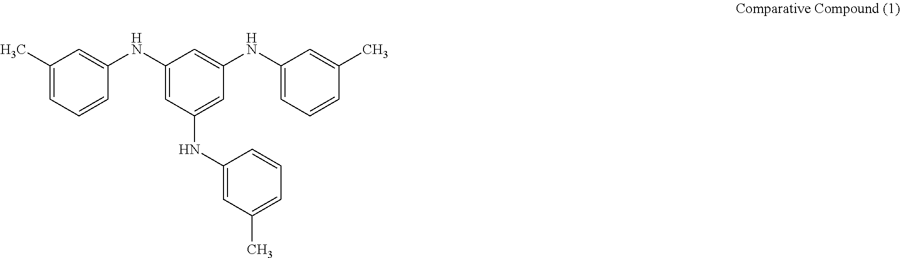

Also, the following cellulose acylates were used as the cellulose acylate.

| | Degree of | Total Degree of |
|---|---|---|
| Cellulose Acylate | Acyl-Substitution | Substitution |
| C-1 | Acetyl: 2.92 | 2.92 |
| C-2 | Acetyl: 2.77 | 2.77 |
| C-3 | Acetyl: 2.41 | 2.41 |
| C-4 | Acetyl: 2.0 | 2.6 |
| | Propionyl: 0.6 | |
| C-5 | Acetyl: 2.0 | 2.7 |
| | Propionyl: 0.7 | |

### (Measurement of Re and Rth)

With respect to all of the fabricated cellulose acylate films, Re values at wavelengths of 450 nm, 550 nm and 630 nm were measured by making light having each of the wavelengths incident in the film normal direction using KOBRA 21ADH (a trade name, manufactured by Oji Scientific Instruments). In the table, the Re and Rth values are a value (nm) at a wavelength of 550 nm. Also, as the wavelength dispersibility of Re, ΔRe is shown, wherein ΔRe=Re (630)−Re (450). The larger the ARe value, the stronger the reversed wavelength dispersibility is.

### 2-(1): Example 1

### Fabrication of Cellulose Acylate Film No. 101

Dope Preparation:

Respective components of the following composition were charged in a mixing tank, and the mixture was stirred while heating to dissolve the respective components, thereby preparing a cellulose acylate solution.

### (Cellulose Acylate Solution)

| | |
|---|---|
| Cellulose acylate (C-1) having a total degree | 100 parts by mass |
| of substitution of 2.92: | |
| Saccharide derivative 1 (plasticizer): | 3.6 parts by mass |
| Methylene chloride (first solvent): | 414 parts by mass |
| Methanol (second solvent): | 62 parts by mass |

Respective components of the following composition were charged in a separate mixing tank, and the mixture was stirred while heating to dissolve the respective components, thereby preparing a retardation increasing agent solution.

### (Retardation Increasing Agent Solution)

| | |
|---|---|
| Sterol derivative represented by formula | 12.0 parts by mass |
| (1) (shown in the table): | |
| Methylene chloride: | 87 parts by mass |
| Methanol: | 13 parts by mass |

100 parts by mass of the foregoing cellulose acylate solution was mixed with the retardation increasing agent solution in an amount of 1 part by mass in terms of the illustrative compound represented by formula (1) based on 100 parts by mass of the cellulose acylate, thereby preparing a dope for film formation.

Casting:

The foregoing dope was cast using a glass plate casting apparatus. Drying was carried out for 6 minutes with hot air at an air supply temperature of 70 degrees Celsius, and a film peeled off from the glass plate was fixed in a frame and dried for 10 minutes with hot air at an air supply temperature of 100 degrees Celsius and then for 20 minutes with hot air at an air supply temperature of 140 degrees Celsius, thereby producing a cellulose acylate film having a film thickness of 60 μm.

Subsequently, the obtained film was laterally stretched at a stretching rate of 30% per minute under a condition at 175 degrees Celsius until a stretch ratio reached 20%. The resulting cellulose acylate film had a film thickness of 52 μm. This film was designated as Film No. 101.

### Fabrication of Film Nos. 102 to 103

The kind of the cellulose and the kind and addition amount of the compound were adjusted such that the retardation increasing agent solution of Film No. 101 had a composition shown in the following table, and the film formation and stretching were carried out in the same manner as in Film No. 101, thereby fabricating Film Nos. 102 to 103. Also, the addition amount (part by mass) in the following table is a value based on 100 parts by mass of the cellulose acylate.

With respect to each of the fabricated films, Re and Rth were measured, and the results are shown in the following table. The values shown in the following table are a value as converted into a film thickness of 50 μm.

In this connection, in the “Re increase” column, “A” means that the Re is more than 10 nm; “B” means that the Re is from 6 to 10 nm; “C” means that the Re is from 1 to 5 nm; and “D” means that the Re is not more than 0.

| | | | Parts | | Parts | Additive 1 | Parts | Stretch- | | | Re |
|---|---|---|---|---|---|---|---|---|---|---|---|
| | Film | Cellulose | by | | by | Compound | by | ing | Re(550) | Rth(550) | in- |
| | No. | Acylate | mass | Plasticizer | mass | of (I) | mass | ratio | nm | nm | crease |
| Example | 101 | C-1 | 100 | Saccharlde | 3.6 | A-Ph | 1 | 20% | 12 | 13 | A |
| | | | | Plasticizer | | | | | | | |
| | | | | 1 | | | | | | | |
| Example | 102 | C-1 | 100 | Saccharide | 3.6 | A-10 | 1 | 20% | 8 | 3 | B |
| | | | | Plasticizer | | | | | | | |
| | | | | 1 | | | | | | | |
| Comparative | 103 | C-1 | 100 | Plasticize | 6/6 | A-10 | 1 | 20% | 5 | 2 | C |
| Example | | | | A/ | | | | | | | |
| | | | | plasticizer | | | | | | | |
| | | | | B | | | | | | | |

Plasticizer A: Ditrimethylolpropane tetraacetate,
Plasticizer B: Triphenyl phosphate

Film No. 103 is a film fabricated using the cholesterol derivative and the plasticizer, which are used for the fabrication of Sample 1-17 described in Example 1 of JP-A-2002-322294.

It can be understood from the results shown in the foregoing table that in Film No. 103, the increase of Re is insufficient, whereas in Film No. 102 using the saccharide plasticizer 1, the increase of Re is improved. The plasticizer contained in Film No. 102 is hydrophilic, compared with that contained in Film No. 103, which may contribute to improving the ability of the sterol derivative for increasing the optical properties. Also, the sterol derivative in Film No. 101 achieved the remarkable increase of Re.

### 2-(2): Example 2

### Fabrication of Cellulose Acylate Films

A dope solution was prepared in the same manner as in Example 1 and then subjected to film formation and stretching as in Film No. 101, thereby fabricating Film Nos. 200 to 212. The kind and addition amount of the used additive are shown in the following table.

With respect to each of the fabricated films, Re and Rth were measured, and the results are shown in the following table. The values shown in the following table are a value as converted into a film thickness of 50 μm.

The increase of Re was evaluated from a difference in Re of each of Film Nos. 100 and 200 in which the additive is not added according to the following criteria. It is meant that the increase of Re is excellent in the order of C→B→A.

### Increase of Re:

A: Exceeding 10 nm

B: From 5 to 10 nm

C: Less than 5 nm corresponding to the development with an additive

Also, with respect to the evaluation of the reversed dispersibility of Re, a value of {Re (630)−(450)} was evaluated according to the following criteria. It is meant that the reversed dispersibility of Re is excellent in the order of C→B→A.

### Re Versed Dispersibility of Re:

A: The value of {Re (630)−Re (450)} is large as compared with that of Film No. 200.

B: The value of {Re (630)−Re (450)} is small as compared with that of Film No. 200 (the difference is from 0 to 3 nm).

C: The value of {Re (630)−Re (450)} is smaller by less than 3 nm as compared with that of Film No. 200.

| | | Cellu- | Parts | | Parts | Additive 1 | Parts | Re | Δ Re | Rth | Re | Rth |
|---|---|---|---|---|---|---|---|---|---|---|---|---|
| | Film | lose | by | | by | Compound | by | (550) | (630-450) | (550) | in- | in- |
| | No. | acylate | mass | Plasticizer | mass | of (I) | mass | nm | nm | nm | crease | crease |
| — | 200 | C-2 | 100 | Saccharide Plasticizer 1 | 3.6 | — | — | 5 | 5.8 | 54 | — | — |
| Example | 201 | C-2 | 100 | Saccharide Plasticizer 1 | 3.6 | A-Ph | 0.25 | 6 | 5.8 | 55 | C | B |
| Example | 202 | C-2 | 100 | Saccharide Plasticizer 1 | 3.6 | A-Ph | 1.5 | 16 | 5.2 | 63 | A | B |
| Example | 203 | C-2 | 100 | Saccharide Plasticizer 1 | 3.6 | A-Ph | 5 | Not available due to blanching | | | | |
| Example | 204 | C-2 | 100 | Saccharide Plasticizer 1 | 3.6 | B-C7 | 1.5 | 12 | 5.6 | 57 | B | B |
| Example | 205 | C-2 | 100 | Saccharide Plasticizer 1 | 3.6 | B-Ph | 1.5 | 15 | 5.0 | 62 | A | B |
| Example | 206 | C-2 | 100 | Saccharide Plasticizer 1 | 3.6 | A-6 | 1.5 | 13 | 4.7 | 60 | B | B |
| Example | 207 | C-2 | 100 | Saccharide Plasticizer 1 | 3.6 | B-3 | 1.5 | 17 | 5.2 | 63 | A | B |
| Example | 208 | C-2 | 100 | Saccharide Plasticizer 1 | 3.6 | C-Ph | 1.5 | 11 | 4.9 | 60 | B | B |
| Example | 209 | C-2 | 100 | Saccharide Plasticizer 1 | 3.6 | A-3 | 0.75 | 16 | 4.4 | 63 | A | B |
| Example | 210 | C-2 | 100 | Saccharide Plasticizer 1 | 3.6 | A-4 | 0.75 | 11 | 5.4 | 58 | B | B |
| Comparative | 211 | C-2 | 100 | Plasticize B/ | 7.8/ | A-Ph | 1.5 | 8 | 5.7 | 56 | C | B |
| Example | | | | plasticizer C | 3.9 | | | | | | | |
| Comparative | 212 | C-2 | 100 | Saccharide Plasticizer 1 | 3.6 | Comparative | 1.5 | 16 | 3.3 | 83 | A | C |
| Example | | | | | | Compound (1) | | | | | | |

Plasticizer B: Triphenyl phosphate,
Plasticizer C: Phenyldiphenyl phosphate

Comparison between Film Nos. 202 and 211 reveals that nevertheless the same sterol derivative A-Ph is contained, Film No. 202 containing the saccharide plasticizer is enhanced in the increase of Re as compared with Film No. 211 containing the phosphorus based plasticizers.

Also, though all of Film Nos. 201, 202 and 203 contain the same sterol derivative A-Ph, Film No. 202 was especially excellent in the increase of Re because the addition amount of the sterol derivative falls with the preferred range. Film No. 201 was slightly inferior in the increase of Re because the addition amount of the sterol derivative is less than the preferred range, whereas Film No. 203 caused whitening under the same producing condition because the addition amount of the sterol derivative is in excess. However, by adjusting the producing condition, Film Nos. 201 and 203 will also become a film with preferred characteristics.

Also, as compared with Film No. 211 containing known Comparative Compound (1) in place of the sterol derivative, the films containing the sterol derivative are large in the value of {(Re (630)−Re (450)) and favorable in the reversed dispersibility of Re.

### 2-(3): Example 3

### Fabrication of Cellulose Acylate Films

A dope solution was prepared in the same manner as in Example 1 and then subjected to film formation and stretching in the same manners as in Film No. 101, thereby fabricating Film Nos. 220 to 226. The kind and addition amount of the used additive are shown in the following table.

With respect to each of the fabricated films, Re and Rth were measured, and the results are shown in the following table. The values shown in the following table are a value as converted into a film thickness of 50 μm.

The increase of Re and the reversed dispersibility of Re were evaluated in the same manner as described above.

| | | Cellu- | Parts | | Parts | Com- | Parts | Re | Δ Re'630- | Rth | Re | Rth | Liquid |
|---|---|---|---|---|---|---|---|---|---|---|---|---|---|
| | Film | lose | by | | by | pound | by | (550) | 450) | (550) | in- | in- | Crystal- |
| | No. | acylate | mass | Plasticizer | mass | of (I) | mass | nm | nm | nm | crease | crease | linity |
| — | 220 | C-1 | 100 | Saccharide Plasticizer 1 | 3.6 | — | −12 | 6.6 | −2 | — | — | — | — |
| Example | 221 | C-1 | 100 | Saccharide Plasticizer 1 | 3.6 | A-Ph | 1.5 | 21 | 4.2 | 26 | A | B | Yes |
| Example | 222 | C-1 | 100 | Saccharide Plasticizer 1 | 3.6 | A-C3 | 1.5 | 4 | 6.1 | 11 | A | B | Yes |
| Example | 223 | C-1 | 100 | Saccharide Plasticizer 1 | 3.6 | A-11 | 1.5 | -3 | 6.6 | 5 | B | B | Yes |
| Example | 224 | C-1 | 100 | Saccharide Plasticizer 1 | 3.6 | B-C7 | 1.5 | 3 | 6.3 | 12 | A | B | Yes |
| Example | 225 | C-1 | 100 | Saccharide Plasticizer 1 | 3.6 | B-C4 | 1.5 | 1 | 6.3 | 11 | A | B | Yes |
| Example | 226 | C-1 | 100 | Saccharide Plasticizer 1 | 3.6 | B-C3 | 1.5 | 2 | 6.1 | 11 | A | B | Yes |
| Example | 227 | C-1 | 100 | Saccharide Plasticizer 1 | 3.6 | D-2 | 1.5 | 8 | 6.6 | 2 | C | B | No |

Plasticizer B: Triphenyl phosphate,
Plasticizer C: Phenyldiphenyl phosphate

In the illustrative compounds of sterol derivative in the foregoing table, the molecular weight is 490.8 for A-Ph, 456.7 for A-C3 and 649.0 for A-11, respectively. It can be understood from comparison of Film Nos. 221, 222 and 223 that when each of A-Ph and A-C3 which are a sterol derivative having a molecular weight of not more than 600 is used, the increase of Re is excellent as compared with the example using A-11 having a molecular weight exceeding 600.

Also, as shown in the foregoing table, among the illustrative compounds of sterol derivative in the table, the sterol derivatives other than D-2 exhibited crystallinity in the temperature range of from 10 degrees Celsius to 300 degrees Celsius. It can be understood that when a sterol derivative having crystallinity in this temperature range is used, the remarkable increase of Re can be achieved as compared with the case of using a sterol derivative not having crystallinity in this temperature range.

### 2-(4): Example 4

### Preparation of Cellulose Acylate Film No. 301

Dope Preparation:

Respective components of the following cellulose acylate solution composition were mixed, and the mixture was stirred to dissolve the respective components, thereby preparing a dope for film formation.

### (Cellulose Acylate Solution)

| | |
|---|---|
| Cellulose acylate having a total degree of | 100 parts by mass |
| substitution of 2.41: | |
| Additive (shown in the following table): | Amount shown in the |
| | following table (unit: part |
| | by mass) |
| Methylene chloride (first solvent): | 396 parts by mass |
| Methanol (second solvent): | 59 parts by mass |

Casting:

The foregoing dope was cast using a glass plate casting apparatus. Drying was carried out for 6 minutes with hot air at an air supply temperature of 70 degrees Celsius, and a film peeled off from the glass plate was fixed in a frame and dried for 10 minutes with hot air at an air supply temperature of 100 degrees Celsius and then for 20 minutes with hot air at an air supply temperature of 140 degrees Celsius, thereby producing a cellulose acylate film having a film thickness of 60 μm.

Subsequently, the obtained film was laterally stretched under a condition at 200 degrees Celsius until a stretch ratio reached 30%. The resulting cellulose acylate film had a film thickness of 51 μm. This film was designated as Film No. 301.

### Fabrication of Film Nos. 300 and 302 to 305

Film formation and stretching were carried out in the same manners as in Film No. 301, thereby fabricating Film Nos. 300 and 302 to 305.

With respect to each of the fabricated films, Re and Rth were measured, and the results are shown in the following table. The values shown in the following table are a value as converted into a film thickness of 50 μm.

The increase of Re and the reversed dispersibility of Re were evaluated in the same manner as described above.

| | | Cellu- | Parts | | Parts | Additive 1 | Parts | Re | Rth |
|---|---|---|---|---|---|---|---|---|---|
| | Film | lose | by | | by | Compound | by | in- | in- |
| | No. | acylate | mass | Plasticizer | mass | of (I) | mass | crease | crease |
| — | 300 | C-3 | 100 | Polyester | 15 | — | — | — | — |
| | | | | Plasticizer 3 | | | | | |
| Comparative | 301 | C-3 | 100 | Polyester | 15 | Comparative | 1 | B | C |
| Example | | | | Plasticizer 3 | | Compound (1) | | | |
| Example | 302 | C-3 | 100 | Polyester | 15 | A-6 | 1 | A | B |
| | | | | Plasticizer 3 | | | | | |
| Example | 303 | C-3 | 100 | Polyester | 15 | B-1 | 1 | A | B |
| | | | | Plasticizer 3 | | | | | |
| Example | 304 | C-3 | 100 | Polyester | 15 | B-2 | 1 | B | B |
| | | | | Plasticizer 3 | | | | | |
| Example | 305 | C-3 | 100 | Polyester | 15 | D-1 | 1 | B | B |
| | | | | Plasticizer 3 | | | | | |

As is clear from the results shown in the foregoing table, all of Film Nos. 302 to 305 according to the working example of the invention, each of which contained a sterol derivative, had the increase of Re equal to or more than that of Film No. 301 according to the comparative example, which contained Comparative Compound (1) that is a conventionally known Re increasing agent, and was excellent in the reversed wavelength dispersibility of Re.

Also, films were fabricated in the same manner, except that in the fabrication of Film No. 302, the cholesterol derivative A-6 as the additive was replaced by each of the cholic acid derivatives CA-10 and CA-Ac-10, and then evaluated. In all of those films, though the Re increased as compared with Film No. 300 in which the additive was not added, the increase was slightly interior to Film Nos. 302 to 305 each using a cholesterol derivative.

### 2-(5): Example 5

### Fabrication of Cellulose Acylate Film No. 401

Dope Preparation:

Respective components of the following cellulose acetate propionate solution composition were mixed, and the mixture was stirred while heating to dissolve the respective components, thereby preparing a dope for film formation.

### (Cellulose Acetate Propionate Solution)

| | |
|---|---|
| Cellulose acetate propionate: | 100 parts by mass |
| Plasticizer (shown in the following table): | Amount shown in the |
| | following table (unit: part |
| | by mass) |
| Additive (shown in the following table): | Amount shown in the |
| | following table (unit: part |
| | by mass) |
| Methylene chloride (first solvent): | 316 parts by mass |
| Ethanol (second solvent): | 59 parts by mass |

Casting:

The foregoing dope was cast using a glass plate casting apparatus. Drying was carried out for 6 minutes with hot air at an air supply temperature of 70 degrees Celsius, and a film peeled off from the glass plate was fixed in a frame and dried for 10 minutes with hot air at an air supply temperature of 100 degrees Celsius and then for 20 minutes with hot air at an air supply temperature of 140 degrees Celsius, thereby producing a cellulose acylate film having a film thickness of 60 μm.

Subsequently, the obtained film was laterally stretched under a condition at 180 degrees Celsius until a stretch ratio reached 30%. The resulting cellulose acylate film had a film thickness of 50 μm. This film was designated as Film No. 401.

### Fabrication of Film Nos. 400 and 402 to 405

Film formation and stretching were carried out in the same manners as in Film No. 401, except for changing the kind and amount of the additive, thereby fabricating Film Nos. 400 and 402 to 405. In this connection, Film No. 400 is a film manufactured in the same manner, except that the additive was not added.

With respect to each of the fabricated films, Re and Rth were measured, and the results are shown in the following table. The values shown in the following table are a value as converted into a film thickness of 50 μm.

The increase of Re and the reversed dispersibility of Re were evaluated in the same manner as described above.

| | | Cellu- | Parts | | Parts | Additive 1 | Parts | Re | Rth |
|---|---|---|---|---|---|---|---|---|---|
| | Film | lose | by | | by | Compound | by | in- | in- |
| | No. | acylate | mass | Plasticizer | mass | of (I) | mass | crease | crease |
| — | 400 | C-4 | 100 | Saccharide | 7.5 | — | — | — | — |
| | | | | Plasticizer 2 | | | | | |
| Comparative | 401 | C-4 | 100 | Saccharide | 7.5 | Comparative | 1.5 | B | C |
| Example | | | | Plasticizer 2 | | Compound (1) | | | |
| Example | 402 | C-4 | 100 | Saccharide | 7.5 | A-Ph | 1.5 | A | B |
| | | | | Plasticizer 2 | | | | | |
| Example | 403 | C-4 | 100 | Saccharide | 7.5 | B-C12 | 1.5 | A | B |
| | | | | Plasticizer 2 | | | | | |
| Example | 404 | C-5 | 100 | Saccharide | 7.5 | B-3 | 1.5 | B | B |
| | | | | Plasticizer 2 | | | | | |
| Example | 405 | C-5 | 100 | Saccharide | 7.5 | C-4 | 1.5 | B | B |
| | | | | Plasticizer 2 | | | | | |

As is clear from the results shown in the foregoing table, all of Film Nos. 402 to 405 according to the working example of the invention, each of which contained a sterol derivative, had the increase of Re equal to or more than that of Film No. 401 according to the comparative example, which contained Comparative Compound (1) that is a conventionally known Re increasing agent, and was excellent in the reversed wavelength dispersibility of Re.

### 2-(6): Example 6

### Fabrication of Cellulose Acylate Film Nos. 501 to 514 and Nos. 521 to 524

A dope solution was prepared in the same manner as in Example 1, except for changing the kind and amount of the additive, and film formation and stretching were then carried out in the same manners as in Film No. 101, thereby fabricating Film Nos. 501 to 514 and Nos. 521 to 524. The kind and addition amount of the used additive are shown in the following tables.

With respect to each of the fabricated films, Re and Rth were measured, and the results are shown in the following tables. The values shown in the following tables are a value as converted into a film thickness of 50 μm.

The increase of Re and the reversed dispersibility of Re were evaluated in the same manner as described above.

| | | | Parts | | Parts | Additive 1 | Parts | | Parts |
|---|---|---|---|---|---|---|---|---|---|
| | Film | Cellulose | by | | by | Compound | by | Additive | by |
| | No. | acylate | mass | Plasticizer | mass | of (I) | mass | 2 | mass |
| — | 100 | C-1 | 100 | Saccharide Plasticizer 1 | 3.6 | — | — | — | — |
| Comparative | 501 | C-1 | 100 | Saccharide Plasticizer 1 | 3.6 | — | — | Re-1 | — |
| Example | | | | | | | | | |
| Example | 502 | C-1 | 100 | Saccharide Plasticizer 1 | 3.6 | A-Ph | 1.5 | Re-1 | 1.25 |
| Example | 503 | C-1 | 100 | Saccharide Plasticizer 1 | 3.6 | A-C6 | 1.5 | Re-1 | 1.25 |
| Example | 504 | C-1 | 100 | Saccharide Plasticizer 1 | 3.6 | A-C3 | 1.5 | Re-1 | 1.25 |
| Example | 505 | C-1 | 100 | Saccharide Plasticizer 1 | 7.5 | B-C3 | 1.5 | Re-1 | 1.25 |
| — | 506 | C-2 | 100 | Polyester Plasticizer 3 | 7.5 | — | 0.63 | Re-1 | 1.25 |
| Example | 507 | C-2 | 100 | Polyester Plasticizer 3 | 7.5 | A-Ph | 0.63 | Re-1 | 1.25 |
| Example | 508 | C-2 | 100 | Polyester Plasticizer 3 | 7.5 | A-C3 | 0.63 | Re-1 | 1.25 |
| Example | 509 | C-2 | 100 | Polyester Plasticizer 3 | 7.5 | A-C6 | 0.63 | Re-1 | 1.25 |
| Example | 510 | C-2 | 100 | Polyester Plasticizer 3 | 7.5 | A-C7 | 0.63 | Re-1 | 1.25 |
| Example | 511 | C-2 | 100 | Polyester Plasticizer 3 | 7.5 | A-Ph | 0.63 | Re-1 | 1.25 |
| Example | 512 | C-2 | 100 | Polyester Plasticizer 3 | 7.5 | A-Ph | 0.63 | Re-1 | 1.25 |
| Example | 513 | C-4 | 100 | Saccharide Plasticizer 2 | 7.5 | A-Ph | 0.63 | Re-1 | 1.25 |
| Example | 514 | C-4 | 100 | Saccharide Plasticizer 2 | 7.5 | A-C6 | 0.63 | Re-1 | 1.25 |

| | | Stretching | | | | | |
|---|---|---|---|---|---|---|---|
| | | Temp- | | Δ | | | |
| | Film | rature/ | Re(550) | Re(630-450) | Rth(550) | Re | Rth |
| | No. | ratio | nm | Nm | nm | increase | increase |
| — | 100 | 175° C./20% | −12 | 6.8 | −2 | — | — |
| Comparative | 501 | 175° C./20% | −4 | 10.9 | 9 | B | A |
| Example | | | | | | | |
| Example | 502 | 175° C./20% | 29 | 12.0 | 37 | A | A |
| Example | 503 | 175° C./20% | 15 | 12.9 | 34 | A | A |
| Example | 504 | 175° C./20% | 14 | 12.1 | 25 | A | A |
| Example | 505 | 175° C./20% | 11 | 11.6 | 24 | A | A |
| — | 506 | 180° C./20% | 20 | 2.4 | 98 | A | C |
| Example | 507 | 180° C./20% | 30 | 5.8 | 104 | A | B |
| Example | 508 | 180° C./20% | 28 | 5.3 | 103 | A | B |
| Example | 509 | 180° C./20% | 29 | 5.7 | 106 | A | B |
| Example | 510 | 180° C./20% | 27 | 6.3 | 105 | A | B |
| Example | 511 | 180° C./30% | 39 | 7.4 | 113 | A | A |
| Example | 512 | 180° C./30% | 47 | 7.8 | 127 | A | A |
| Example | 513 | 180° C./25% | 53 | 5.6 | 127 | A | B |
| Example | 514 | 180° C./25% | 57 | 5.8 | 132 | A | B |

| | | | | | | Additive 1 | | |
|---|---|---|---|---|---|---|---|---|
| | | | Parts | | Parts | compound | Parts | |
| | Film | Cellulose | by | | by | of | by | Additive |
| | No. | acylate | mass | Plasticizer | mass | (I) | mass | 2 |
| Example | 521 | C-1 | 100 | Saccharide Plasticizer 1 | 3.6 | A-Ph | 1 | Re-2 |
| Example | 522 | C-1 | 100 | Saccharide Plasticizer 1 | 3.6 | A-C7 | 1 | Re-2 |
| Example | 523 | C-1 | 100 | Saccharide Plasticizer 1 | 3.6 | A-Ph | 1 | Re-3 |
| Example | 524 | C-1 | 100 | Saccharide Plasticizer 1 | 3.6 | A-C3 | 1 | Re-3 |

| | | Parts | | |
|---|---|---|---|---|
| | Film | by | Re | Rth |
| | No. | mass | Increase | Increase |
| Example | 521 | 1 | A | A |
| Example | 522 | 1 | A | A |
| Example | 523 | 1 | A | A |
| Example | 524 | 1 | A | A |

It can be understood from the results shown in the foregoing tables that by using the low-molecular weight compound (A) (Additives Re-1 to Re-3) represented by the formula (A-1) together with the sterol derivative, the increase of Re and the reversed wavelength dispersibility of Re are more improved.

### 3. Fabrication and Evaluation of Polarizing Plate and Liquid Crystal Display Device:

### Fabrication of Polarizing Plate

Iodine was adsorbed onto a stretched polyvinyl alcohol film to fabricate a polarizing film.

Each of Cellulose Acylate Film Nos. 512 and 513 as fabricated above was stuck on one side of the polarizing film using a polyvinyl alcohol based adhesive. In this connection, a saponification treatment was carried out under the following condition.

1.5 moles/L of a sodium hydroxide aqueous solution was prepared and then kept at 55 degrees Celsius. 0.01 moles/L of a dilute sulfuric acid aqueous solution was prepared and then kept at 35 degrees Celsius. The fabricated cellulose acylate film was dipped in the foregoing sodium hydroxide aqueous solution for 2 minutes and then dipped in water, thereby thoroughly washing away the sodium hydroxide aqueous solution. Subsequently, the resulting cellulose acylate film was dipped in the foregoing dilute sulfuric acid aqueous solution for one minutes and then dipped in water, thereby thoroughly washing away the dilute sulfuric acid aqueous solution. Finally, the sample was thoroughly dried at 120 degrees Celsius.

A commercially available cellulose triacetate film (a trade name: FUJITAC TD80UF, manufactured by Fujifilm Corporation) was subjected to a saponification treatment, stuck on the opposite side of the polarizer using a polyvinyl alcohol based adhesive and then dried at 70 degrees Celsius for 10 minutes or more.

A transmission axis of the polarizing film and a slow axis of each of Cellulose Acylate Film Nos. 512 and 513 were disposed parallel to each other. A transmission axis of the polarizing film and a slow axis of the commercially available cellulose triacetate film were disposed orthogonal to each other.

In this way, a polarizing plate having each of Cellulose Acylate Film Nos. 512 and 513 as a protective film on one side of the polarizing plate was fabricated.

### Fabrication of Liquid Crystal Cell

A liquid crystal cell was fabricated so as to have a cell gap between the substrates of 3.6 μm, and a liquid crystal material with negative dielectric anisotropy (a trade name: MLC 6608, manufactured by Merck & Co., Inc.) was added dropwise to and injected between the substrates, followed by sealing to form a liquid crystal layer between the substrates. A retardation of the liquid crystal layer (namely, a product Δn·d of a thickness d (μm) of the liquid crystal layer and a refractive index anisotropy Δn) was adjusted to 300 nm. In this connection, the liquid crystal material was aligned in a vertical alignment manner.

For a polarizing plate on the upper side (observer side) and a polarizing plate on the lower side (backlight side) of a liquid crystal display device using the foregoing vertical alignment type liquid crystal cell, the same polarizing plates provided with each of Film Nos. 512 and 513 fabricated in the foregoing Example 6 were disposed in such a manner that the cellulose acylate film was located on the liquid crystal cell side. The upper-side polarizing plate and the lower-side polarizing plate were stuck to the liquid crystal cell via an adhesive. The resultant was made in the cross nicol disposition in such a manner that a transmission axis of the upper-side polarizing plate was disposed in an up-and-down direction, and a transmission axis of the lower-side polarizing plate was disposed in a left-and-right direction.

A square wave voltage of 55 Hz was impressed to the liquid crystal cell. A normally black mode with a white display of 5 V and a black display of 0 V was produced. Black display in a viewing angle in the direction with an azimuth angle of 45° and an polar angle of 60° on the black display and a color shift between the case with an azimuth angle of 45° and a polar angle of 60° and the case with an azimuth angle of 180° and a polar angle of 60° were observed.

As a result of observing the two liquid crystal display devices provided with the polarizing plate having each of Film Nos. 512 and 513, it could be confirmed that a neutral black display can be realized in all of the frontal direction and the viewing angle direction.

1. A cellulose acylate film comprising at least one cellulose acylate, at least one sterol derivative represented by formula (1), and at least one saccharide derivative and/or at least one oligomer plasticizer: 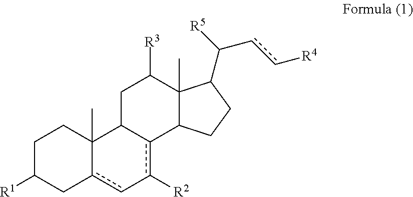
wherein
each of R¹, R² and R³ represents a hydrogen atom, a hydroxyl group or a substituent represented by -L-R*, provided that at least one of R¹, R² and R³ represents the substituent represented by -L-R*; L represents a single bond or a divalent connecting group selected from the group consisting of —O—, —CO—, —CONR⁶—, —CH₂— and a combination thereof, wherein R⁶ represents an alkyl group having from 1 to 7 carbon atoms or a hydrogen atom; R* represents a substituted or unsubstituted aromatic ring group, heterocyclic group or alkyl group, provided that in the alkyl group, one CH₂ or two or more CH₂'s which are not adjacent to each other may be substituted with an oxygen atom; R⁴ represents a carboxyl group or —CHR⁷—CH(CH₃)₂, wherein R⁷ represents an alkyl group having 1 or 2 carbon atoms or a hydrogen atom, and the carboxyl group represented by R⁴ may be substituted with -L-R*; R⁵ represents a hydrogen atom or a methyl group; and a combination of the broken line and the solid line in the formula may be any of a single bond or a double bond.

2. The cellulose acylate film of claim 1, wherein the at least one sterol derivative is a cholesterol derivative, a sitosterol derivative, a stigmasterol derivative, a campesterol derivative, a brassicasterol derivative, an ergosterol derivative, a cholic acid derivative, a deoxycholic acid derivative, a chenodeoxycholic acid derivative or a lithocholic acid derivative.

3. The cellulose acylate film of claim 1, wherein the at least one sterol derivative is a cholesterol derivative.

4. The cellulose acylate film of claim 1, wherein the at least one sterol derivative is a compound represented by formula (1a): 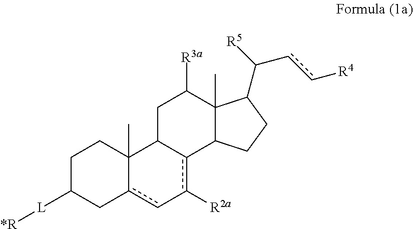
wherein
L, R*, R⁴ and R⁵ are synonymous with those in the formula (1), respectively; and each of R^{3a} and R^{2a} represents a hydrogen atom or a hydroxyl group.

5. The cellulose acylate film of claim 1, wherein the at least one sterol derivative is a compound represented by formula (1b): 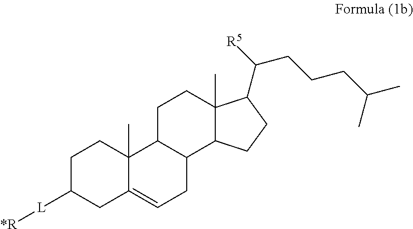
wherein
L, R* and R⁵ are synonymous with those in formula (1), respectively.

6. The cellulose acylate film of claim 1, wherein a molecular weight of the sterol derivative is equal to or smaller than 600.

7. The cellulose acylate film of claim 1, wherein the at least one sterol derivative takes a liquid crystal phase in any temperature range of from 10 degrees Celsius to 300 degrees Celsius.

8. The cellulose acylate film of claim 1, wherein an amount of the at least one sterol derivative is from 0.1 to 50% by mass on the basis of the total mass.

9. The cellulose acylate film of claim 1, satisfying following expressions (1) to (3).
Δn(550 nm)>0 (1)
1>|Δn(450 nm)/Δn(550 nm)| (2)
1<|Δn(630 nm)/Δn(550 nm)| (3)

10. The cellulose acylate film of claim 1, wherein the at least one cellulose acylate is a cellulose acylate in which hydrogen atoms of hydroxyl groups of the cellulose skeleton are substituted substantially only with an acetyl group, and a total degree of substitution thereof is from 2.00 to 3.00.

11. The cellulose acylate film of claim 1, wherein the at least one cellulose acylate is a cellulose acylate in which hydrogen atoms of hydroxyl groups of the cellulose skeleton are substituted substantially with at least two kinds selected from the group consisting of an acetyl group, a propionyl group and a butanoyl group, and a total degree of substitution thereof is from 2.00 to 3.00.

12. The cellulose acylate film of claim 1, which is one having been subjected to a stretching treatment and/or a contraction treatment.

13. A retarder comprising a cellulose acylate film of claim 1.

14. A polarizing plate comprising at least a cellulose acylate film of claim 1 and a polarizer.

15. A liquid crystal display device comprising a retarder of claim 13.

16. A liquid crystal display device comprising a polarizing plate of claim 14.

17. The liquid crystal display device of claim 15, employing a VA mode.
